(19) United States
(12) Patent Application Publication
(10) Pub. No.: US 2026/0309131 A1
(43) Pub. Date: Oct. 8, 2026

(54) METHODS OF GENERATING ELECTRIC POWER AND A DISTRIBUTED NETWORK OF A GENERATOR-TURBINE APPARATUS HAVING A SET OF ELECTRIC GENERATORS SIMULTANEOUSLY DRIVEN BY A GRAVITY-FORCE APPLIED AND MOMENT IMBALANCED TURBINE

(71) Applicant: Gyounghyun Bae, Annandale, VA (US)

(72) Inventor: Gyounghyun Bae, Annandale, VA (US)

(21) Appl. No.: 18/975,718

(22) Filed: Apr. 3, 2025

(51) Int. Cl. F03G 3/00; F01D 15/10; F03G 3/08; H02K 7/00; H02K 7/02; H02K 7/102; H02K 7/116; H02K 7/18; H02K 11/24; H02S 10/10; H02S 10/20

(52) U.S. Cl. CPC F03G 3/091; F01D 15/10; F03G 3/08; H02K 7/003; H02K 7/02; H02K 7/102; H02K 7/116; H02K 7/1823; H02K 11/24; H02S 10/10; H02S 10/20; F05B 2220/706; F05B 2220/708; F05B 2260/4031

(57) ABSTRACT

A set of 3-φ electric power generators (SEPG) radially mounted inside an electric generator mounting block and simultaneously driven by a gravity-force applied and moment imbalanced turbine (GFAMIT) has a plurality of variable, articulate or elastic twisting-moment-arms (VAETMA) fixed on a rotating shaft inside each housing. Each housing eccentrically contains the rotating shaft from the housing's geometric center. The radial arm length of each VAETMA continuously changes with respect to rotation angle. When the turbine rotates by gravity, the VAETMAs induce the inertial centrifugal force differences toward the longest arm direction and the twisting moment differences in both half planes creating resultant twisting moment (torsion) on the rotating shaft. The resultant twisting moment drives several of the driving wheels which simultaneously and frictionally rotate the set of 3-φ electric power generators. Four levels of AI control the optimal performance of a distributed electric power network.

### FIELD OF THE INVENTION

The present disclosure is in the field of an electric power generation apparatus and methods without burning any type of fuels to solve the environmental problems of the global increase of the electric power demand, and the set of driven shafts of a set of electric generators are only rotated by a drive shaft of a turbine having a plurality of variable, articulate, or elastic moment arms inducing a resultant centrifugal force and resultant twisting moment on the drive shaft by the plurality of variable, articulate, or elastic arms having a mass at each end of the plurality of variable, articulate, or elastic arms.

### PRIOR ART

No prior art search was conducted to avoid any prejudice, relationship with, or using a portion of the existing electric power generation systems.

### BACKGROUND OF THE INVENTION

Keeping phase with the progressive developments of various electronic/electric devices for communication systems, internet and web technology and artificial intelligence, the demand for electric power usage increases as time passes. To meet the increased demand for electric power, many electric power plants burning fossil fuels have created increase of the air temperature and consequently resulting in global catastrophic weather change sacrificing human lives, wealth and industrial infrastructure. Many nuclear fission power plants generate nuclear waste materials that contaminate the environment and three nuclear accidents, e.g., Three Mile Island nuclear power plant, Chernobyl nuclear power plant and Fukushima nuclear power plant occurred in the past and it is very time-consuming, difficult and expensive to find a site and build and operate a nuclear waste storage facility and nuclear power plant.

Burning fossil fuels such as coal, petroleum, natural gas and other gases increases CO2 gas in the atmosphere. Methane gas also increases the air temperature. Methane gas is produced from various sources such as farming, coal mines, oil fields and biomass. The increased methane content in the air absorbs more radiation energy from both Sun and Earth surface and contributes further to increase air temperatures and severe weather changes.

In the US last year 2023, the primary fuel type was natural gas, accounting for about 38.4% of total energy production nationwide. Coal was the second most common fuel type, accounting for 21.9% of electricity production. Nuclear was third at 18.9%. Renewable energy such as hydroelectric power, wind power and solar power takes approximately the rest 21% of the total electric power generation.

Nuclear fission electric power plants produce lots of nuclear waste which has a long time of half period of the intensity of nuclear radiation. Chernobyl nuclear power plant in Ukraine exploded in 1986 spreading nuclear ashes in large area of Europe. Fukushima nuclear power plant exploded in 2011, the Tokyo electric power company and Japanese government releases the nuclear-contaminated and radioactive tritium-water to the Pacific Ocean from last year contaminating the global ocean on the earth.

Regarding the nuclear fusion electric power plant project, ITER (International Thermonuclear Experimental Reactor) is an international nuclear fusion research and engineering megaproject aimed at generating energy through a fusion process similar to that of the Sun but, on Jul. 8, 2024, it was announced that “Full operation of the reactor has been delayed by four years, from 2035 to 2039, when it will use the heavy forms of hydrogen, deuterium and radioactive tritium, as fuel.”

VA state started a solar electric energy program for selected Virginians to encourage installing solar panels on their roof, giving tax benefits for a long period of time to make up the cost of solar panel installation. This program is to build a large distributed solar power generation system spread in large areas in Virginia and is very smart and may delay the construction of additional electric power plant burning fossil fuel, natural gas or nuclear fission material in accordance with the predicted power consumption increase. In the case of Virginia state, cited is internet Google search output about the increase of the predicted electric power demand in Virginia.

“The increase is driven almost exclusively by data center growth, according to reports from PJM Interconnection, which coordinates electricity transmission. Dominion spokesman Aaron Ruby confirmed that power demand in Virginia is expected to grow by about 85% over the next 15 years. Jun. 18, 2024”.

Another citation is in the following (This article was written in response to a seminar given by Katharine Bond, VP, Public Policy, State, and Local Affairs, Dominion Energy and G T Hollett, Director, Offshore Wind, Dominion Energy, in an EDGE Seminar at Duke University's Fuqua School of Business in Fall 2023. This article voices one student's perspective and does not necessarily represent the views of either Duke University or the seminar speakers. Data center growth threatens Virginia's clean energy future. It's not too late to fix it. By Adam Cowie-Haskell, MEM '25, Posted on Jan. 4, 2024 by EDGE)

“Indeed, northern Virginia is known as the data center capital of the world. Loudoun County, less than an hour from Washington DC, is referred to as “data center alley” and has more than 29 million square feet of data center space.2 Dominion cites that the load from data centers peaked at 2.8GWs in 2022; it is expected to surpass 7GWs by 2032, far more than any other region.3”

“Dominion's IRP suggests that the utility sees dispatchable gas as its best option to reliably meet growing energy demand from data centers. Dominion's IRP also includes building expensive and untested small modular nuclear reactors (SMRs) in four out of its five pathways.8 In either case, both types of plants would be hefty additions to the company's rate base, especially over time as these plants require ongoing operations and maintenance. Furthermore, the 1,447 MWs of natural gas would spew countless tons of new CO2 into the air. Contrast this with solar and storage, where the upfront costs are relatively inexpensive, after which the assets have little upkeep and turn a free and limitless fuel into clean energy. In other words, renewable resources do not return as much value to Dominion's shareholders as gas plants or SMRs.”

Land-surface installed wind power plants and offshore-ocean wind power plants generate renewable clean electric power replacing the environmentally harmful fossil fuel burning electric power plants. Due to stagnant or very low wind speed of ground air, the wind power plant must use a colossal height of the windmill tower. To increase the operational window of the wind power plant, wind blades have colossal arm length to get enough torsional moment to rotate the mechanical shaft of electric generator on top of the tower by the torsional moment by the aerodynamic lift forces at a very slow air speed. Erection of a steel column having very high height is very expensive to manufacture, install, operate and repair. The huge radial length of wind blades is also very expensive to manufacture, install, operate and repair. It is very difficult to increase the number of wind blades by more than three blades considering cost, operation and dynamics of the rotation of the blades and vibration of the windmill tower. The installation, repairment and handling of the related mechanical parts of the wind power system are very dangerous too.

Regarding the solar cell electric power plant, it needs a very large area such as ground surface, pond/river surface or offshore ocean surface to install many rows of solar panels. Electric power generation depends on weather conditions such as dust covering the top surface of the solar panels, clouds in the sky making shades on the solar panels, snow covered state on the surface of the solar panels and short duration of daylight time in wintertime. In addition, because of the large surface area of the solar panels, severe wind loading such as hurricanes may create large aerodynamic drag forces to destroy and blow away the deployed solar panels, giving huge damage to solar panel farm operators. After elapsing the lifetime of the solar panels, the disposal processes to dispose of the waste solar panels are costly and hazardous whereas the current invention does not produce much environmentally hazardous waste resulting in that the current invention is a more economic and environmentally safe electromechanical system.

Severely unpredictable and irregular weather patterns and hot weather make the water level of the river stream for hydroelectric power generation go down and the probability to stop hydro-electric power generation increases in recent years having long term droughts.

The nuclear fission based electric power plants use high-energy nuclear-fission materials and produce large amounts of hazardous nuclear waste such as radioactive tritium hydrogens, contaminated cooling waters, contaminated operational disposables such as gloves and radioactive radiation protection gears. In the case of nuclear power plants built long time ago, the maximal capacity of the nuclear waste storage containers is approaching, and it is very expensive to find a proper location and build a long tunnel and proper facility.

### SUMMARY OF THE INVENTION

According to a first aspect of the present invention, a distributed network of generator-turbine apparatus having a set of 3-φ (phase) electric power generators (SEPG) radially mounted inside an electric generator mounting block and simultaneously driven by a gravity-force applied and moment imbalanced turbine (GFAMIT) comprises
a plurality of electric generator mounting block 9210 having a concentrical inner-cylindrical-support 8100, a concentrical middle-cylindrical-support 8200 and a concentrical outer-cylindrical-support 8300 holding and supporting a pre-decided number L of 3-φ electric power generators 8000,
a photovoltaic (PV) panel 88091 or a capacitor bank 88092 providing a DC reactive excitation current to the stator excitation windings of each 3-φ electric power generator 8000 for inducing a current in the rotor electromagnet windings,
a fixed number K (K=1, 2, . . . , a fixed number) of the driving wheels 7000 rotating each pulley 8040 of the pre-decided number L of 3-φ electric power generators 8000,
a gearbox device 600 having a gearbox driving shaft 501 and the fixed number K of driving wheel driven-shafts 7001,
a torque measurement and transmission device 500 having a rotary torque sensor 505 measuring the torque of the torque coupling device shaft 401,
a torque coupling device 400 connecting a pair of mating mechanical shafts having a pair of mating male and female coupling ends 4001,
a flywheel and brake block 300 doing the braking action much faster than the frequency of manual braking actions, controlled by a computer 1000 having multicores,
a predefined number M of hollow housings 8 containing the hollow or solid rotating shaft 1 wherein the hollow or solid rotating shaft 1 comprises a limited number N of variable or articulate or elastic twisting-moment-arms and a spherical steel sphere connected to the distal ends of each variable or articulate or elastic twisting-moment-arm, and the hollow or solid rotating shaft 1 is eccentrically located within each hollow housing 8,
a centrifugal force supporting structure 200 for withstanding the induced resultant centrifugal force F,
a starter turbine 36000 for rotating the GFAMIT without attaching the pre-decided number L of 3-φ electric power generators 8000 to the fixed number K driving wheels 7000, and the hollow or solid rotating shaft 360 of the starter turbine 36000 is coaxially connected to the hollow or solid rotating shaft 1,
a 120° circular orbit-guide reinforcement 375 further supports a circular orbit-guide 374 against the summation of the centrifugal forces induced by the rubber coated steel spheres 373 and the limited number N of variable or articulate or elastic twisting-moment-arms,
the computer 1000 controlled by a server of a LAN or WAN computer network with an Internet connection, and the computer 1000 executing the general purpose computer operating system (OS) programs and hardware specific FPGA, VHDL, or Verilog program controlling the C3I (command control communications and information) functions of the pre-decided number L of 3-φ electric power generators (SEPG) 8000 radially mounted inside each electric generator mounting block 9210 and having multi-level artificial intelligence (AI) and controlling the optimal rotational speed of the turbine,
wherein all zero-degree single-phase stator output terminals, all 120-degree single-phase stator output terminals and all 240-degree single-phase stator output terminals of the pre-decided number L of 3-φ electric power generators 8000 are respectively summed to a first common joint bus of a first electric power interconnection and summing bus 8805 (1), a second electric power interconnection and summing bus 8805 (2) and a third electric power interconnection and summing bus 8805 (3) respectively for summing all electric current having same degree phase angle and a first single-phase (1-φ)-to-single-phase (1-φ) cycloconverter bank and phase-locked loop 8806 (1), a second single-phase (1-φ)-to-single-phase (1-φ) cycloconverter bank and phase-locked loop 8806 (2) and a third single-phase (1-φ)-to-single-phase (1-φ) cycloconverter bank and phase-locked loop 8806 (3) are respectively connected to the output bus terminal of the first electric power interconnection and summing bus 8805 (1), the second electric power interconnection and summing bus 8805 (2) and the third electric power interconnection and summing bus 8805 (3) for converting the high order frequencies created by mixing all electric currents from the pre-decided number L of 3-φ electric power generators 8000 to the 50 or 60 Hz electric current within an allowable convergence frequency error and tuning all initial phase angles within an allowable phase angle error and a 3-φ step-up transformer 880700 converting the voltage from 12 Vac to a desired high AC voltage, and
the initial position of the GFAMIT turbine system has a potential energy creating an initial twisting moment rotating both the hollow or solid rotating shaft 360 of the starter turbine 36000 and the hollow or solid rotating shaft 1, and a stopper or braking system is needed to keep the GFAMIT turbine system on hold when not in use.

According to a second aspect of the present invention, the structure of the variable, the structures of the predefined number M of hollow housings 8 are disclosed.

According to the third aspect of the invention, the structures of a limited number N of variable or articulate or elastic twisting-moment-arms and a spherical steel sphere connected to the distal ends of each variable or articulate, or elastic twisting-moment-arm are disclosed, and the locations of the rotation centers of the hollow or solid rotating shaft 1 are disclosed.

According to the fourth aspect of the invention, the structure of the starter turbine 36000 is disclosed.

According to the fifth aspect of the invention, a structure of a Gravity and Buoyance-Forces applied and Moment Imbalanced Turbine (GBFAMIT) driving a pre-decided number L of 3-φ electric power Generators having a closed loop flow consisting of an upward flow and a downward flow, wherein the upward flow of the rubber-coated solid masses 927 is opposite to the gravitational force acting on each rubber-coated solid mass 927 inside the columnar liquid container 900 and the downward flow of the rubber-coated solid masses 927 is along the gravitational force inside the limited number N of pivoting elongated buckets 911 is disclosed.

According to the sixth aspect of the invention, two methods of generating electric power from a set of 3-φ electric power generators (SEPG) radially mounted inside a concentric generator-mounting-block simultaneously driven by a gravity-force applied and moment imbalanced turbine (GFAMIT) are disclosed.

### BRIEF DESCRIPTION OF DRAWINGS

FIG. 1 discloses Cross-sectional view A-A of a gravity-force applied and moment imbalanced turbine (GFAMITA) driving a set of electric power generators.

FIG. 2 discloses Front view of a gravity-force applied and moment imbalanced turbine (GFAMITA) driving a set of electric power generators.

FIG. 3 discloses One of rotating link 2 and spring 15.

FIG. 4 discloses Angular velocity control with tachometer feedback.

FIG. 5 discloses Section D-D.

FIG. 6 discloses Flywheel and brake system.

FIG. 7A discloses Concentric generator-mounting-block (assembly) and

related devices.

FIG. 7B discloses View Z₁-Z₁.

FIG. 8 discloses Views AA-AA and BB-BB.

FIG. 9 discloses Generator mounting structure.

FIG. 10 discloses Pivoting generator holder and holder coupling.

FIG. 11 discloses Mechanical couplers and universal joints.

FIG. 12 discloses Various polygonal cylinders, channel and plate.

FIG. 13 discloses Control system with observed-state feedback.

FIG. 14 discloses Kalman filter data flow.

FIG. 15 discloses Semi-circular and semi-elliptic housing.

FIG. 16 discloses Spherical ball assembly.

FIG. 17 discloses Cam and Crank arm assembly of a pair of cylindrically telescoping arms.

FIG. 18 discloses Partial assembly of cam and crank assembly of a pair of cylindrically telescoping arms.

FIG. 19 discloses Elliptical orbit guide of steel sphere.

FIG. 20 discloses Exemplary contour of designed inner and outer ellipses.

FIG. 21 discloses Linkage structure (No crank).

FIG. 22 discloses Cam follower groove.

FIG. 23 discloses Circular cam groove and circular orbit-guide, A starter turbine.

FIG. 24 discloses stopper stud.

FIG. 25 discloses Rhombus linkage arms within an elliptical orbit-guide.

FIG. 26 discloses Rhombus linkage arms having a partial support rod and sliding rings.

FIG. 27 discloses Variable Spring Arm.

FIG. 28 discloses Rhombus linkage arms within circular orbit-guide.

FIG. 29 discloses Initial positions of eight foldable arms.

FIG. 30 discloses Top view of four pairs of articulated arms having 45° angular position.

FIG. 31 discloses Overlapped view of cross-sectional planes E₁-E₁, E₂-E₂, E₃-E₃, E₄-E₄.

FIG. 32 discloses the cross-sectional view E₁-E₁ of the fixed twisting-moment-arm, first link and second link.

FIG. 33 discloses Gravity and buoyance force assisted turbine.

FIG. 34 discloses a pivoting elongated bucket.

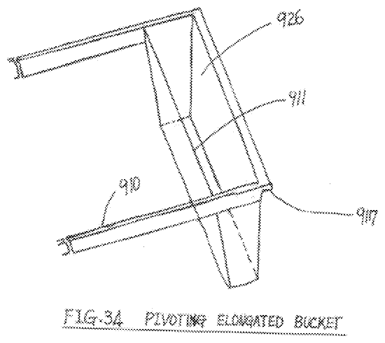

FIG. 35 discloses architecture of four levels of AI.

### DETAILED DESCRIPTION OF THE INVENTION

The present disclosure has many advantages as follows.

The current invention is a new type of clean energy system contributing to solving the global problem of climate change.

The current invention has the widest operational window being independent of external energy such as kinetic energy from water flow, kinetic energy from wind flow, solar energy from sunlight, and nuclear energy from high power material Uranium 238.

The current invention has the highest and proved technical maturity.

The current invention has the highest safety level, not having a colossal and high structure.

The current invention has the highest robustness of the system using market proved components.

The current invention is cost effective to the various and traditional electric power plants such as a fossil fuel electric power plant, a hydroelectric power system, a high-columnal wind power generation system, a solar-cell electric power plant, a nuclear power plant and a tidal hydroelectric power generation system.

One of the many advantages of the current invention is the opposite of the drawbacks of the fossil fuel electric power plant, without burning fossil fuels such as coal, oil or natural gas. The fossil fuel electric power plant generates environmentally harmful gases changing the climate of the Earth. The current invention does not burn any fossil fuel as an input energy source to be converted to electric energy without producing CO2 gases. The present disclosure uses only gravitational force to rotate the rotating shaft of a turbine and is robust being a distributed electric power generation system.

One of the many advantages of the current invention is the opposite of the drawbacks of the hydroelectric power system, without requiring high waterhead making a large volume of river water reservoir. A hydroelectric power plant stops operation when the waterhead decreases below the required minimal waterhead height during a drought season. The hydroelectric power generation needs effective waterhead height or water velocity and volume to rotate the impellors and blades of the water turbine. The current invention does not need any water as an input energy source to be converted to electric power. The present disclosure uses only gravitational force to rotate the rotating shaft of a turbine.

One of the many advantages of the current invention is the opposite of the drawbacks of the wind power generation system, i.e., instead of (1) a colossal column vertically high above the ground, the present disclosure needs a rotating shaft horizontally long and parallel to the ground and relatively very short height compared to the height of the wind mill tower, (2) the present disclosure has a set of variable and short radial length of torsional arms compared to the wind blades having a huge radius, and (3) unlike the wind power generation system requiring an operational range of wind velocity, the current invention does not require an operational range of wind velocity and operates even with stagnant wind of zero wind velocity.

One of the many advantages of the current invention is the opposite of the drawbacks of a solar-cell electric power plant not requiring sunlight, not available at night and a large land or water surface. The structure of the present invention is much stronger than the structure of the solar panel support frames because of sustaining the intrinsic dynamics of the rotation of radial arms (having weight material at the end of the twisting-moment-arms) inducing centrifugal forces and gravitational force acting on the mechanical parts of the present disclosure.

One of the many advantages of the current invention is the opposite of the drawbacks of the nuclear power plants without burning nuclear fission materials and without producing any nuclear waste materials. The present invention does not need nuclear fission high energy material (Uranium 238) and needs only gravitational force which is ubiquitous on the surface of the Earth. The current invention does not produce any nuclear waste materials to be buried deep under the ground forever.

One of the many advantages of the current invention is the opposite of the drawbacks of the tidal hydroelectric power generation system, without requiring high ocean water current flow or high ocean waterhead by making a dam. The tidal power plant stops operation when the ocean waterhead height decreases below the operational waterhead height during slack tide and flood current periods and huge cost to build the tidal hydroelectric power generation system. The current invention does not need any tidal water energy source to be converted to electric power. The present disclosure uses only gravitational force to rotate the rotating shaft of a turbine.

The present disclosure relates to an electric power generation system, in detail, a turbine having a fixed number of variable or articulate twisting-moment-arms wherein the radial arm lengths of the variable or articulate twisting-moment-arms are continuously changed between the left half plane of the rotation and right half plane of the rotation. The summation of the inertial centrifugal forces induced by rotating the limited number of variable or articulate twisting-moment-arms results in the resultant centrifugal force acting on the rotating shaft having the limited number of variable or articulate twisting-moment-arm.

The summation of the inertial twisting moments in the left and right half planes creates the resultant rotational torsion difference between the left and the right half planes by the gravity. The resultant rotational torsion difference drives a fixed number K (K=1, 2, . . . , a fixed number) of the driving wheels 7000. The fixed number K of driving wheels frictionally rotate each pulley of a pre-decided number L of 3-φ electric power generators attached to the fixed number of driving wheels.

Four major concepts have been conceived in the present invention as follows.

The first concept is for variable or articulate arm lengths of rotating twisting-moment-arms on the left and right half planes, i.e., short arm lengths in a half plane and longer arm lengths in the opposite half plane.

The second concept is for a housing or container urging the variable or articulate arm length to be changed between the half plane and the opposite half plane of the cross-sectional plane of the housing or container.

The third concept is for providing a supporting structure withstanding the resultant centrifugal force induced by rotation of the limited number of variable or articulate twisting-moment-arms.

The fourth concept is for creating a closed flow path of solid masses having an upward flow path against gravity and downward flow path along the gravity without applying any external energy or force.

Unlike a conventional turbine having an initial position of zero-energy-state without any rotational energy, the initial position of the GFAMIT turbine system has a potential energy creating an initial twisting moment which rotates the hollow cylindrical shaft 70, so that a stopper or braking system is needed to keep the GFAMIT turbine system on hold when not in use, and the hollow cylindrical shaft 70 must be in a stopped position applying brake force on the hollow cylindrical shaft 70.

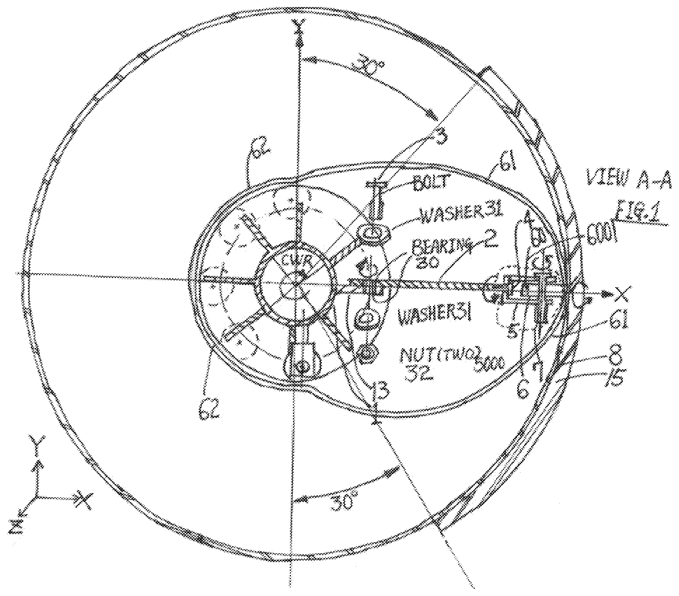

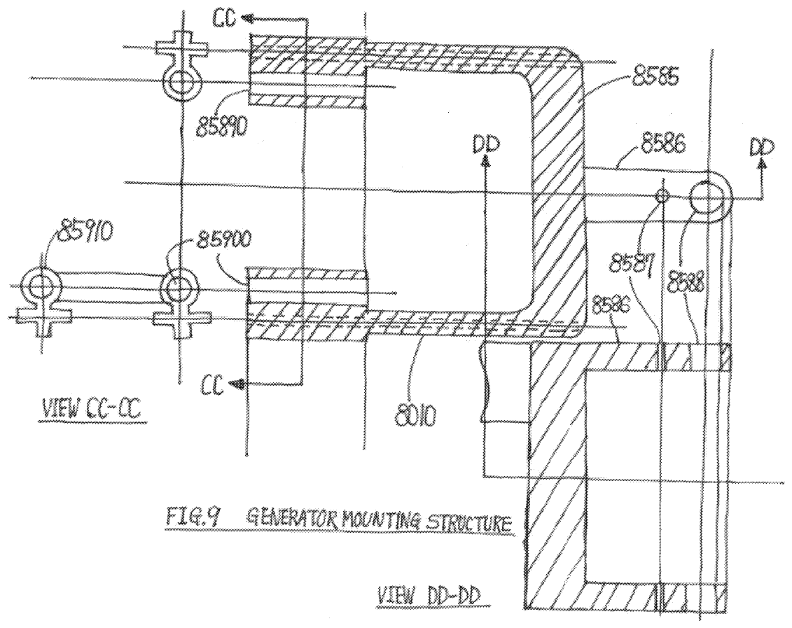

### First Embodiment (FIGS. 1-14)

In detail, the four major concepts are as follows.

Provide a rotating shaft comprising a plurality of variable or articulate twisting-moment-arms welded or fixed on the surface of the rotating shaft and a heavy mass is connected to each distal end of the plurality of variable or articulate twisting-moment-arms wherein the rotational radius of the heavy mass from the rotation axis of the rotating shaft to the radial end of the heavy mass connected to the variable or articulate twisting-moment-arm changes in the left and right half planes of rotation with respect to rotation-angle of the rotating shaft.

Insert a tubularly curved housing or orbit-guide along and around the rotating shaft wherein the rotating shaft is eccentrically centered at a rotation axis inside the tubularly curved housing or orbit-guide and the tubularly curved housing or orbit-guide urges the rotational radius of the heavy mass from the rotation axis of the rotating shaft to the radial end of the heavy mass connected to the variable or articulate twisting-moment-arm.

Provide an external supporting structure on the outer surface of the tubularly curved housing or orbit-guide along the direction of a resultant centrifugal force induced by rotating the plurality of variable or articulate twisting-moment-arms wherein the external supporting structure creates the reaction force against the resultant centrifugal force to withstand and cancel the resultant centrifugal force.

Create a closed flow path of solid masses having an upward flow path against the gravity force and downward flow path along the gravity force without applying any external power or action energy to the solid masses.

A distributed electric power generation system is a plurality of individual electric power generation system having an embodiment disclosed in the current application spread to different locations. An individual electric power generation system is placed in, for example, a room inside a house, shed near a house, local area, parking lot, farming field, factory site, land along a road/highway, township, county, state, country, or continent to generate electric power.

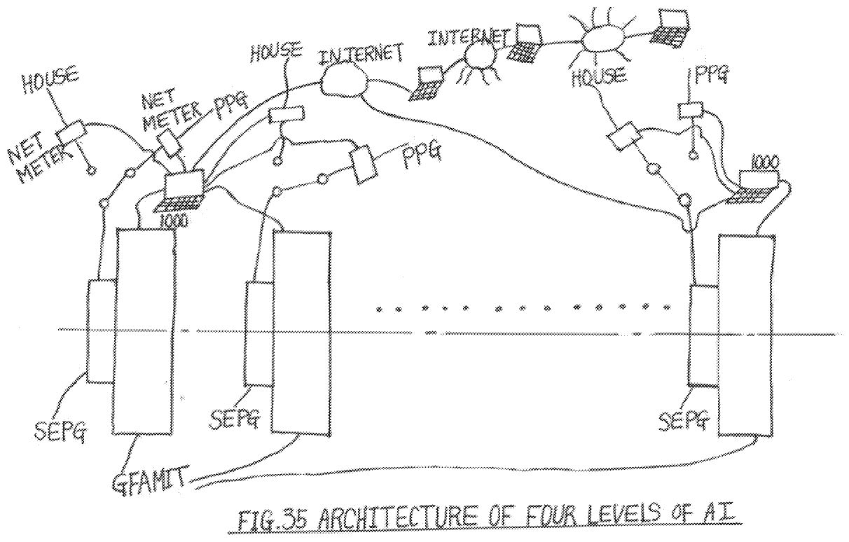

Each core of a computer 1000 in FIG. 35 having multicores has a local level artificial intelligence (AI) and a local level database on the computer 1000. The local level AI tracks the electric output power, performances of the electric devices, control devices and installed sensors. The local level AI makes periodic query to the local level database to get the system parametric values and generated electric output power as an input value set to the input nodes of a local level backpropagation model having a plurality of layers of nodes to compute the optimal rotational speed of the turbine and the optimal number of three-phase electric generators to be driven by the driving wheel 7000 moving forward the axially telescoping motion of the telescoping square-structural tubing 8580 and then the local level AI trains the local level backpropagation model to minimize the mechanical vibrations and noises. The local level AI stores all the collected and tracked data by each core to the local level database. The local level AI collects and stores the owner information and electric power consumption for each hour to the local level database.

The dynamic motion and sensor measurement data in the local database stored by each core of the CPU of the computer 1000 is used by a computer-level AI having a computer level backpropagation model. The computer-level AI makes queries about the dynamic motion and sensor measurement data in the local database stored by each core of the CPU of the computer 1000. The computer level backpropagation model takes dynamic motion and sensor values from the local database as input parametric values of the first layer nodes of the computer level backpropagation model. The computer level back propagation model is trained to minimize the impact on the required electric power generation and predict the mechanical part replacement time and shutdown time of each generator or each turbine minimizing the impacts on the required electric power generation. The computer level backpropagation model predicts when to start the reserved electric generators and turbines before turning down an electric generator or a turbine for repair and supervises mechanical and electrical part inventories and makes judgements for time dependent breakdown of mechanical parts wearing down by dynamic motions and sensor saturations and malfunctions. The computer-level AI creates the judgement report to the electric power operators with a combination of symbolic signs, buzzing or whistling alarms, text messages, LED lights, and security announcements with artificial voices or stored human voices. The computer-level AI stores all the collected and tracked data to the local database.

The computer-level AI is supervised by a distributed electric generator network (DEGN)-level AI controlling a limited number of computer level Als and has a DEGN-level backpropagation model and a DEGN database. The DEGN-level AI tracks open-source electric power demand, power factor of transmission lines of a PPU, and a power loss rate of transmission lines of the PPU with respect to time and stores the tracked data to the DEGN database. The DEGN-level backpropagation model takes the related parametric values in the DEGN database as input parameters to the nodes of the first layer of the DEGN-level backpropagation model and trains the DEGN-level backpropagation model to minimize the impact on the required electric power within +/−3% bounds of the required electric power and predicts the number of new generators and turbines adapting to the time dependent electric power demand. The DEGN-level AI stores all the collected and tracked data to a DEGN database.

The DEGN-level AI is supervised by public power utility (PPU)-level AI has a PPU-level backpropagation model. The PPU-level AI collects and keep track of the open-source electric power data of each PPU for overloaded power transmission line of the public power grid (PPG), severe weather changes related storms and high ambient air temperature, cyber security failures on the electric power systems, announcements and warnings from the North American Electric Reliability Corporation, time history of national peak electric power consumption and national electric power generation. The PPU-level AI stores the tracked data to a PPU-level database. The PPU-level AI takes related parametric values from the PPU-level database as input values to nodes of the first layer of the PPU-level backpropagation model, and after training, predicts the gap to reach electric power blackout in a region, expected price of hourly electric power with respect to time when the national peak electric power consumption approaches close to the national peak electric power generation capacity, and computes the buffer electric power in KWh and the required number of generators and turbines necessary to satisfy the buffer electric power and prevent the electric power blackout. The PPU-level AI stores all the collected and tracked data to a cloud database.

Each embodiment disclosed in this application is an electric power generation system of a large distributed electric power generation system controlled by a LAN or WAN computer network with an Internet connection. In the case of a plurality of electric power generation system placed in the same area, each core of a multicore CPU individually controls each electric power generation system of the large distributed electric power generation system. In the case of an electric power generation system placed in an area, the multicore CPU controls the electric power generation system and does the C3I functions.

Distributed electric power generation provides more robust operation of electric power generation systems. The physical size of an element of the electric power generation system is smaller than a concentrated electric power plant such as a coal/gas powered electric power plant, nuclear power plant, wind power plant, or ocean tide power plant. In general, a distributed system is easier and safer to replace/repair a malfunctioning part, more cost-effective and flexible to operate and has wider operational window.

Various exemplary embodiments disclosed in this application cover different shapes, dimensions, materials of the variable arm lengths of a variable or articulate twisting-moment-arm, and different shapes, dimensions, materials of the housing or container and different shapes, dimensions, materials of the supporting structure.

The conceived concept for a gravity-force applied and moment imbalanced turbine (GFAMIT) driving a set of 3-φ electric power generators (SEG) has been exemplary embodied as follows and graphically disclosed in the above figures.

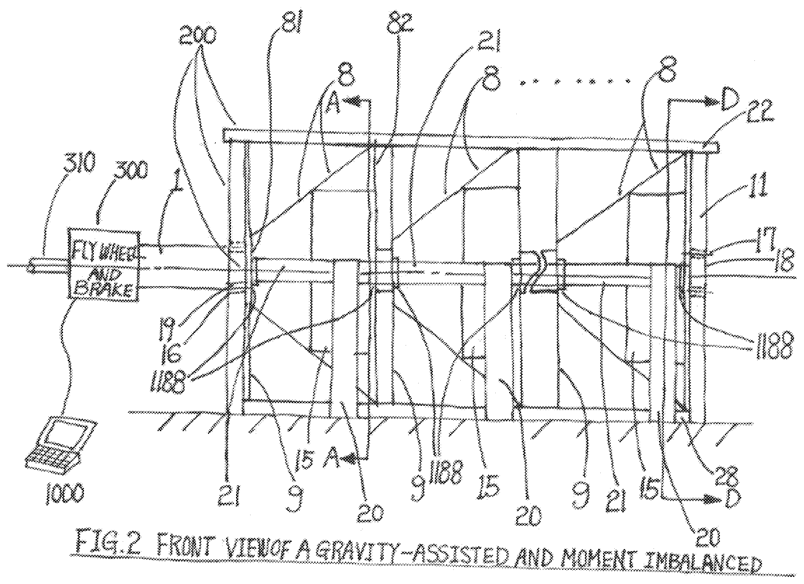

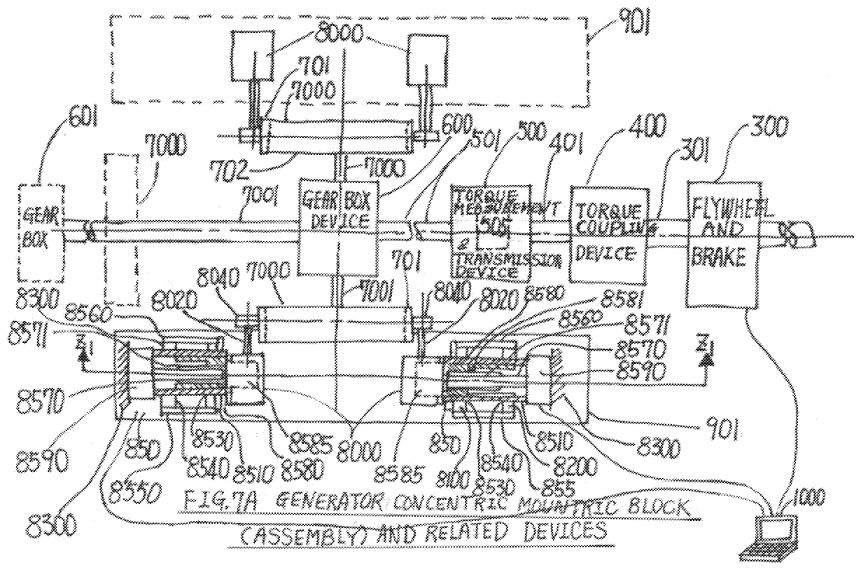

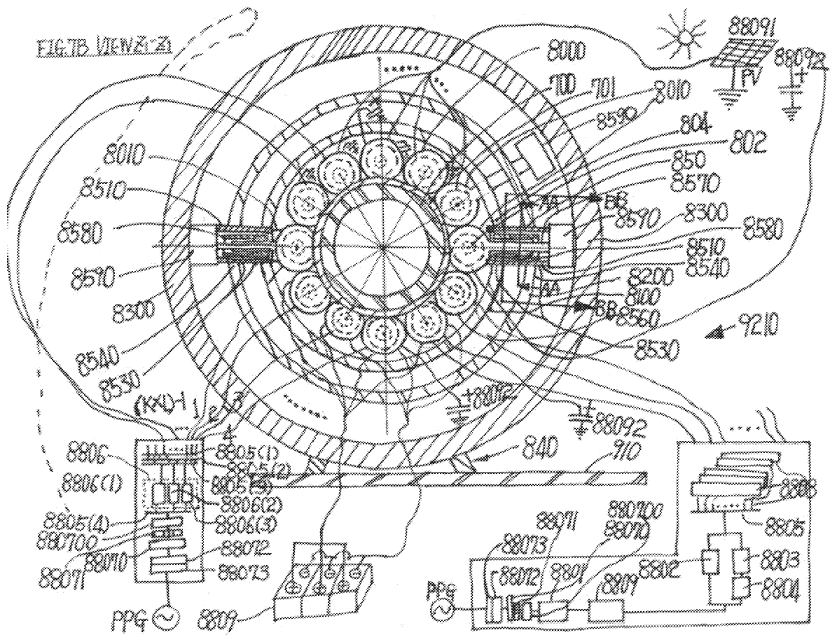

A gravity-force applied and moment imbalanced turbine (GFAMIT) driving a set of 3-φ electric power generators (SEPG) 8000 in FIGS. 7A-7B has been exemplary designed to generate clean energy without burning any fossil fuel and FIG. 1 is a cutaway view A-A of a turbine system in FIG. 2. The dimensions in FIG. 1 are not to be scaled being an explanatory and exemplary design. It is a conceptual drawing not a production drawing. The basic materials of each mechanical element and part are steel and/or corrosion-prevention-treated wood products unless specially specified. The steel is coated with polyurethane coating and the corrosion-prevention-treated wood is coated with wood stain and then sealer and finally after drying, then it is coated with polyurethane coating. The basic materials satisfy the required strength of materials of each mechanical element and part doing the required motions and functions. The steel and corrosion-prevention-treated wood products have enough structural strength to sustain the applied and induced forces such as centrifugal forces, bending moments and twisting moments. The coordinate axes X, Y, Z satisfies the right-hand rule in FIG. 1. Unless specially specified, a 3-φ electric power generator is a synchronous 3-φ electric power generator.

A hollow or solid rotating shaft 1 preferably is a hollow cylindrical body and both ends are closed. The hollow or solid rotating shaft 1 can be a solid shaft. The hollow or solid rotating shaft 1 has a predefined number M (M=1, 2, 3, . . . , a predefined number) of hollow frustoconical housings 8 in FIG. 2 and each hollow frustoconical housing of the predefined number M of hollow frustoconical housings 8 has a limited number N (N=1, 2, . . . , a limited number) of welded arms 13 axially spaced along the centerline of the hollow or solid rotating shaft 1 as shown in FIG. 1 and the limited number N of welded arms 13 are radially welded on the outer surface of the hollow or solid rotating shaft 1 and makes total (M×N) number of the welded arms welded on the hollow rotating arm 1 and makes clockwise rotation (CWR, rotation vector along the negative axis Z) holding the hollow rotating arm 1 with the right hand and aligning the thumb along the rotational axis of the hollow or solid rotating shaft 1. The limited number N of welded arms 13 are welded along a circular circumference on the hollow or solid rotating shaft 1 or along a spiral circumference on the hollow or solid rotating shaft 1. The hollow or solid rotating shaft 1 further comprises a limited number N (N=1, 2, 3, . . . , a limited number) of articulate twisting-moment-arms 2, 5, 6 and 7 to be connected and supported by the limited number N of welded arms 13 wherein the direct radial length of each articulate twisting-moment-arm from the origin of the rotation axis of the hollow or solid rotating shaft to the distal end of an articulate twisting-moment-arm is variable with respect to rotation angle and a heavy rolling wheel 6 or a spherical steel sphere 60000 is connected to the distal ends of each articulate twisting-moment-arm of the limited number N of articulate twisting-moment-arms 2, 5, 6 and 7 and the hollow or solid rotating shaft 1 eccentrically is located within each hollow housing 8 and the hollow or solid rotating shaft 1 is rotated by the limited number N of articulate twisting-moment-arms.

A pair of inner layer bearings 18 and 19 and a pair of outer layer bearings 16 and 17 are installed at both ends of the hollow or solid rotating shaft 1, and the pair of inner layer bearings 18 and 19 on both journals of the hollow or solid rotating shaft 1 are a pair of sliding ring-bearings 18 and 19 having a cylindrical shape. The sliding ring-bearings 18 and 19 have the large contact area for distributing and withstanding both of the large resultant centrifugal force F applied to the hollow or solid rotating shaft 1 and resulting in axial elongations of the hollow or solid rotating shaft 1, perpendicular deflections of the hollow or solid rotating shaft 1, and bending moments occurred on the hollow or solid rotating shaft 1, and the large contact area minimizes both mechanical vibration and noise caused by the elongation, deflection and bending of the hollow or solid rotating shaft 1 due to the large resultant centrifugal force F applied on the hollow or solid rotating shaft 1. The pair of outer layer bearings 16 and 17 are needle bearings 16 and 17 installed on each outer surface of the sliding bearings 18 and 19 for further minimizing the vibrations, noises and friction forces between the sliding ring-bearings 18 and 19 and the needle bearings 16 and 17.

An encoder or a tachometer is provided on one end of the two ends of the hollow or solid rotating shaft 1 which is a hollow cylindrical body with at least a closed end.

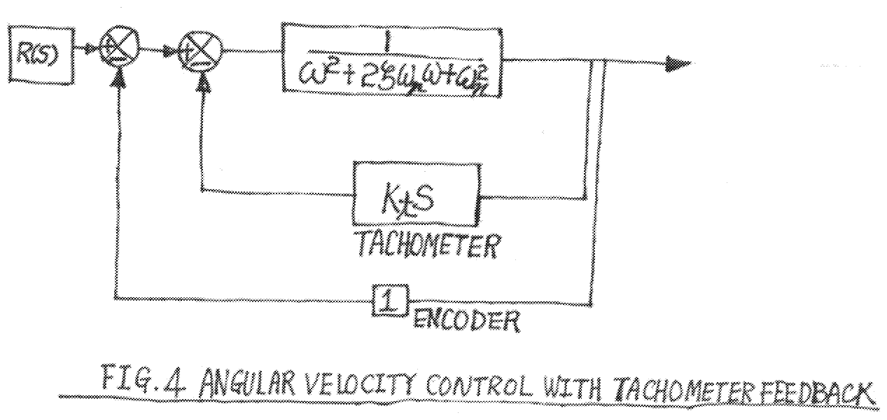

A pre-tested and measured strain gauge output with respect to the frequency (inverse of the angular velocity) of the angular velocity is prepared and used to select a reference angular speed. FIG. 4 discloses a block diagram of dual closed-loop feedback servo-controller using tachometer and encoder output signals as an output variable to be fed-back to the inner loop of the dual closed-loop feedback servo-controller.

The required (M×N) number of the welded arms 13 depends on the required total external torque of the electric power generators 8000 in FIG. 7A to be rotated and the total shaft torque of a fixed number K (K=1, 2, . . . , a fixed number, e.g., 3 in FIG. 7A) of the driving wheels 7000 wherein each driving wheel having a metal wheel body 702 covered with a rubber rim 701 and having friction between the outer surface of the rubber rim 701 and the outer surface of a pulley 8040. Each pulley 8040 connected to a pre-decided number L (L=1, 2, 3, . . . , a pre-decided number) of 3-φ (phase) electric power generators 8000 is squeezed to each rubber rim 701 on a driving wheel 7000 by forward advancing and backward retreating each of the pre-decided number L of 3-φ electric power generators 8000.

The generated 3-φ output power from the pre-decided number L of 3-φ electric power generators 8000 is to be interconnected to the public power grid (PPG) served by the public power utilities (PPU). The hollow or solid rotating shaft 1 simultaneously rotates the fixed number K of the driving wheels 7000.

Each single-phase output terminal from each stator output terminal of the 3-φ electric output power generated from each of 3-φ electric power generator of the number (K×L) of 3-φ electric power generators 8000 are summed to a common terminal, in detail, all 0-degree-φ (phase) terminals are summed as a first common joint bus on a first electric power interconnection and summing bus 8805 (1) in FIG. 7B. All 120-degree-φ terminals are summed as a second common joint bus on a second electric power interconnection and summing bus 8805 (2). Finally, all 240-degree-φ terminals are summed as a third common joint bus on a third electric power interconnection and summing bus 8805 (3). Because the initial phase angle of each of the pre-decided number L of 3-φ generators 8000 is not known and the diameters of the pulleys 8040 of the pre-decided number L of 3-φ generators 8000 are not exactly and absolutely same, the phase angle and frequency of each electric output power from each of the pre-decided number L of 3-φ electric power generators 8000 are different (without synchronization) from 0°, 120°, 240° and 60 Hz resulting in that the phase angles and frequencies of the summed electric current output in each (first, second, third) electric power interconnection and summing bus 8805 are different from the nominal three phase angles and frequency of 0°, 120°, 240° and 60 Hz. As shown in FIG. 7B, a single-phase (1-φ)-to-single-phase (1-φ) cycloconverter bank and phase-locked loop 8806 is to generate a 50 or 60 Hz sine wave from the single-phase (1-φ)-to-single-phase (1-φ) cycloconverter bank within an allowable convergence frequency error, i.e., within one of the bounds of +/−0.01 Hz, +/−0.02 Hz, . . . , +/−0.1 Hz, +/−0.2 Hz and tune the initial phase angles to a desired phase angle by the phase-locked loop built in the single-phase (1-φ)-to-single-phase (1-φ) cycloconverter bank and phase-locked loop 8806 within an allowable phase angle error, i.e., within one of the bounds of +/−0.010, +/−0.1°, . . . , +/−10, +/−10°. The phase-locked loop has a built-in oscillator generating a pure sine wave having 50/60 Hz frequency and zero-phase angle or receives the electric current from the public power grid to synchronize.

A first single-phase (1-φ)-to-single-phase (1-φ) cycloconverter bank and phase-locked loop 8806 (1) is connected to the output bus terminal of the first electric power interconnection and summing bus 8805 (1) for converting the high order frequencies created by mixing all electric currents from the pre-decided number L of 3-φ electric power generators 8000 to a 50 or 60 Hz electric current and tuning all initial phase angles around the 0° phase angle to the 0° phase angle, then
a second 1-φ-to-1-φ cycloconverter bank and phase-locked loop 8806 (2) is connected to the second output bus terminal of the electric power interconnection and summing bus 8805 (2) for converting the high order frequencies created by mixing all electric currents from the pre-decided number L of 3-φ electric power generators 8000 to the 50 or 60 Hz electric current and tuning all initial phase angles around the 120° phase angle to the 120° phase angle, and finally
a third 1-φ-to-1-φ cycloconverter bank and phase-locked loop 8806 (3) is connected to the third output bus terminal of the electric power interconnection and summing bus 8805 (3) for converting the high order frequencies created by mixing all electric currents from the pre-decided number L of 3-φ electric power generators 8000 to the 50 or 60 Hz electric current and tuning all initial phase angles around the 240° phase angle to the 240° phase angle.

The output terminal of the 1-φ-to-1-φ cycloconverter bank and phase-locked loop 8806 (1) is connected to the first input terminal of an electric power interconnection and summing bus 8805 (4) to produce a 50 or 60 HZ and 0° phase sine wave. The output terminal of the 1-φ-to-1-φ cycloconverter bank and phase-locked loop 8806 (2) is connected to the second input terminal of the electric power interconnection and summing bus 8805 (4) to produce a 50 or 60 HZ and 120° phase sine wave and finally the output terminal of the 1-φ-to-1-φ cycloconverter bank and phase-locked loop 8806 (3) is connected to the third input terminal of the electric power interconnection and summing bus 8805 (4) to produce a 50 or 60 HZ and 240° phase sine wave so that the output terminal of the electric power interconnection and summing bus 8805 (4) transmits 3-φ pure sine-wave electric power to a 3-φ step-up transformer 880700 converting the voltage from 12 Vac to 120 Vac, 240 Vac, 480 Vac, 960 Vac, 1,920 Vac, 3,840 Vac, 7,680 Vac, 15,360 Vac, 30,720 Vac, 61,440 Vac, or 122,880 Vac. The 3-φ step-up transformer 880700 is connected in series with a digital three-phase synchroscope 88070 for sensing, correcting, informing and displaying the instantaneous phase angle error and frequency error and for automatic switching of three-phase generators for parallel operation with the PPG or with other generators with rated frequency of 50 or 60 Hz 120 Vac as shown at the left block diagram in FIG. 7B. In addition, the digital three-phase synchroscope has an Ethernet interface 10/100 BASE-T for connecting the synchronization meter to the local area network (LAN) or the global one (WAN) and has Network services such as web server, Modbus TCP/IP, DHCP client. The 3-φ step-up transformer 880700 converting the voltage from 12 Vac to 120 Vac, for example, is same as a 3-φ step-down transformer converting the voltage from 120 Vac to 12 Vac by reversing the connections of the terminals.

A Hall effect type current clamp 88071 is installed around the output terminal of the electric power interconnection and summing bus 8805 (4) and the Hall effect type current clamp 88071 periodically measures the AC magnitude and the DC magnitude without direct contact to the output terminal of the electric power interconnection and summing bus 8805 (4) and an FPGA, PLC, or a computer software stores the time series data of the AC magnitude, the DC magnitude, the phase and waveform into a database and generates time histories on a LAN connected display screen and a remote display screen connected through the internet. The measurement data logged by the Hall effect type current clamp 88071 or a separate data logger are stored on an SSD drive for later review and analysis.

The output terminal of the digital three-phase synchroscope 88070 is branched with two legs and has the first and second legs to connect a first and second 3-φ (three-phase) net power meter 88071 in series with each leg. After the first 3-φ net power meter 88071 on the first leg to separately net meter the consumed electric power by an owner of the disclosed electric generator system, a high-leg delta transformer is connected to the first 3-φ net power meter 88071 on the first leg and electric outlets are connected to the high-leg delta transformer.

The second 3-φ net power meter 88071 is connected in series to the second leg of the digital three-phase synchroscope 88070 to net meter the electric power supplied to the PP. After the 3-φ net power meter 88071 on the other leg of the digital three-phase synchroscope 88070, a 3-φ short circuit breaker 88072 is connected to the 3-φ net power meter 88071 on the other leg. The electric short circuit causes sparks or smoke. The 3-φ short circuit breaker 88072 responds faster than 0.1 second to prevent a hot wire and a neutral wire from touching together (short circuit) so that electric sparks or smoke is prevented and the electric power system and a service technician working around the electric wire are protected. After the 3-φ short circuit breaker 88072, a 3-φ ground fault circuit interrupter (GFCI) switch 88073 is connected to the 3-φ short circuit breaker 88072. A ground fault occurs when a hot wire touches a ground resulting in electric current surge and blowing fuses or tripping a circuit breaker. The GFCI switch 88073 prevents electric current surge when a hot wire touches the ground. During the normal state, the GFCI switch 88073 transmits the 3-φ pure sine-wave electric power to the electric power transmission line of a public power grid (PPG) or cutting the 3-φ pure sine-wave electric power off instantly within 0.1 second from the public power grid when an abnormal operation or accident happens.

The 1-φ-to-1-φ cycloconverter bank (1~3) can be replaced by a built-in phase-locked loop for each phase of the three 1-φ-to-1-φ cycloconverter banks (1~3).

This circuit does not have conventional AC-DC-AC (AC to DC to AC) power inverters.

Each core of a computer 1000, having multicores, not only stores sampled data into a local database on the computer 1000 but also has a local level artificial intelligence (AI). The local level AI computes the optimal rotational speed of the turbine and the optimal number of three-phase electric generators to be driven by the driving wheel 7000 moving forward the connected axially telescoping motion of the telescoping square-structural tubing 8580. Further the local level AI shows the electric output power, supervising the functions of the electric devices, control devices and installed sensors, and carrying out periodic electric current flow monitoring within a reasonable period such as 0.1 second and generating electric current flow report and plots with respect to time. The local level AI makes periodic query to the local computer database to get the system parametric values and generated electric power stored by each core of the computer 1000 as an input set to a backpropagation equation having a plurality of layers of nodes to get the optimal electric output power minimizing mechanical vibrations and noises. In addition, the local level AI makes judgements for situational awareness and creates the judgement report to the server and network engineers and computer network administrators. The computer 1000 level AI predicts part failure in advance taking the judgements for situational awareness from the local level AI and the stored system parametric values in the database as input values to another backpropagation equation maximizing the system operational window and minimizing the system down time.

Alternatively, each 3-φ electric output power generated from each 3-φ electric power generator of the number (K×L) of 3-φ electric power generators 8000 is connected to a 3-φ Rectifier 8808 and each output power from the 3-φ Rectifier 8806 having DC component and high frequency ripple frequency is connected to each input terminal of the electric power interconnection and summing bus 8805. The 3-φ Rectifier 8806 makes the negative voltage profiles of the 3-φ electric power generator flipped up to positive voltage profiles and the ripple frequency at the output terminal of the 3-φ Rectifier 8806 is tripled by the 3-φ Rectifier 8806. In other words, the output from the 3-φ Rectifier 8806 simultaneously has a DC component and an AC ripple component having much higher frequency than the original frequency of the 3-φ electric power generator. Therefore, an inductive choke 8802 (to filter the DC component out of the electric power interconnection and summing bus 8805) and a capacitor bank 8803 (to pass only the AC ripple current) are connected in parallel to the output terminal of the electric power interconnection and summing bus 8805. A high frequency phase-controlled Silicon Controlled Rectifier (SCR) 8004 is connected to the capacitor bank 8803 making the computer 1000 control the phase-controlled Silicon Controlled Rectifier (SCR) 8004 output a DC output power. Finally, the DC output power from the high frequency phase-controlled Silicon Controlled Rectifier (SCR) 8004 and the output power from the inductive choke 8802 are summed together and transmitted to a battery bank 8809 and the battery power is connected to a 3-φ inverter device 8801, or directly to the 3-φ inverter device 8801 generating near pure 3-φ sinewaves. The output power from the 3-φ inverter device 8801 is connected in series to a 3-φ step-up transformer 880700 converting the voltage from 12 Vac to 120 Vac. The 3-φ step-up transformer 880700 is connected in series with a digital three-phase synchroscope 88070 for sensing, correcting, informing and displaying the instantaneous phase angle error and frequency error and for automatic switching of three-phase generators for parallel operation with the PPG or with other generators with rated frequency of 50 or 60 Hz as shown at the left block diagram in FIG. 7B. In addition, the digital three-phase synchroscope has an Ethernet interface 10/100 BASE-T for connecting the synchronization meter to the local area network (LAN) or the global one (WAN) and has Network services such as web server, Modbus TCP/IP, DHCP client and a circuit breaker.

A Hall effect type current clamp 88071 is installed around the output terminal of the electric power interconnection and summing bus 8805 (4) and the Hall effect type current clamp 88071 periodically measures the AC magnitude and the DC magnitude without direct contact to the output terminal of the electric power interconnection and summing bus 8805 (4) and an FPGA, PLC or a computer software stores the time series data of the AC magnitude, the DC magnitude, the phase and waveform into a database and generates time histories on a LAN connected display screen and a remote display screen connected through the internet. The measurement data logged by the Hall effect type current clamp 88071 or a separate data logger are stored on an SSD drive for later review and analysis.

A 3-φ (three-phase) net power meter 88071 is connected after the digital three-phase synchroscope 88070. After the 3-φ net power meter 88071, a 3-φ short circuit breaker 88072 is connected to the 3-φ (three-phase) net power meter 88071. The electric short circuit causes sparks or smoke. The 3-φ short circuit breaker 88072 responds faster than 0.1 second to prevent a hot wire and a neutral wire from touching together (short circuit) so that electric sparks or smoke is prevented and the electric power system and a service technician working around the electric wire are protected. After the 3-φ short circuit breaker 88072, a 3-φ ground fault circuit interrupter (GFCI) switch 88073 is connected to the 3-φ short circuit breaker 88072. Ground fault occurs when a hot wire touches a ground resulting in electric current surge and blowing fuses or tripping a circuit breaker. The GFCI switch 88073 prevents electric current surge when a hot wire touches the ground. During the normal state, the GFCI switch 88073transmits the 3-φ pure sine-wave electric power to the electric power transmission line of a public power grid (PPG) or cutting the 3-φ pure sine-wave electric power off instantly within 0.1 second from the public power grid when an abnormal operation or accident happens.

The hollow or solid rotating shaft 1 having the (M×N) number of welded arms 13 and the (M×N) number of articulate arms (having variable rotational arm length) satisfies the required total torque of the (K×L) number of 3-φ electric power generators 8000 driven by the hollow or solid rotating shaft 1.

The axial length of the hollow or solid rotating shaft 1 along the centerline of the hollow or solid rotating shaft 1 extends to accommodate the predefined number M (M=1, 2, 3, . . . , a predefined number) of hollow frustoconical housings 8 in FIG. 2 and each hollow frustoconical housing of the predefined number M of hollow frustoconical housings 8 contains the fixed number N (N=1, 2, . . . , a fixed number, e.g. 8 in FIG. 1) of the welded arms and the detailed structure of the limited number N of articulate twisting-moment-arms 2, 5, 6 and 7 is the limited number N of rotating links 2 because the direct radial distance to the distal end of each rotating link 2 varies with respect to the rotation angle of the hollow or solid rotating shaft 1. The distal end of each rotating link 2 has a heavy rolling wheel 6 wherein the direct radial length of the rotating link 2 from the axis of rotation of the hollow or solid rotating shaft 1 is variable with respect to rotation angle of the hollow or solid rotating shaft 1, wherein the rotating link 2 is articulately and rotationally folded reducing the direct radial arm length from the axis of rotation of the hollow or solid rotating shaft 1 with respect to rotation angle in the left and right half planes of the Cartesian coordinate system X-Y in FIG. 1 and the rotating link 2 is articulately and rotationally unfolded increasing the direct radial arm length from the axis of rotation of the hollow or solid rotating shaft 1 with respect to rotation angle in the left and right half planes of the Cartesian coordinate system X-Y.

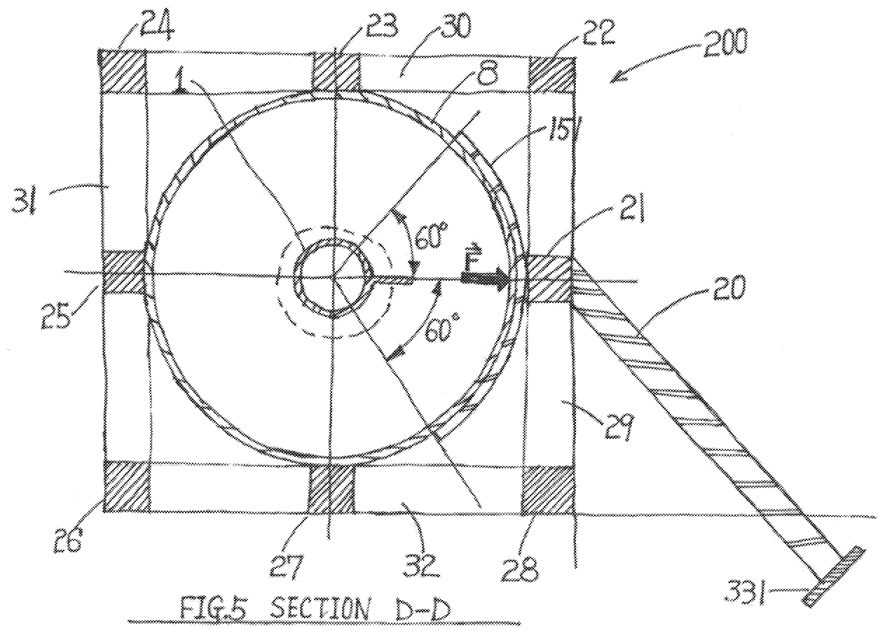

Each hollow frustoconical housing 8 contains the fixed number N of welded arms 13, and a bunch of ball bearings 1188 are assembled at both ends of each hollow frustoconical housing 8 for the hollow frustoconical housing 8 to be stationary without any rotational motion when the hollow or solid rotating shaft 1 rotates inside each hollow frustoconical housing 8. A washer-like thick steel plate 9 is welded on the narrow side of each hollow frustoconical housing 8 and the large outer edge of the washer-like thick steel plate 9 is welded or fastened to the support frames 21~28 in FIG. 5. The wide side of each hollow frustoconical housing 8 is welded or fastened to the support frames 21~28.

Each welded arm of the fixed number N (N=1, 2, . . . , a fixed number) of welded arms 13 has a welded arm bearing 30 at the distal end of each welded arm 13 and articulately connected the rotating link 2 having a rotating link bearing 30 at the proximal end of the rotating link 2. The welded arm bearing 30 and the rotating link bearing 30 have a rotation vector along the negative Y-axis perpendicular to the welded arm 13 making an articulated twisting-moment-arm by pivotal articulation with respect to a hinge bolt 3. The hinge bolt 3 passes through the welded arm and rotating link bearings 30 and assembles the rotating link bearing 30 and the welded arm bearing 30 and articulately extending the twisting-moment-arm-length of the hollow or solid rotating shaft 1.

A pair of washers 31 are inserted between the bolt head and the fastening nuts to reduce friction force between the bolt head and the top surface of the rotating link 2 and reduce the friction force between the bottom surface of the fixed arm and the fastening nuts.

Unlike a conventional turbine having an initial position of zero-energy-state without any rotational energy, the initial position of the GFAMIT turbine system has a potential energy creating an initial twisting moment which rotates the hollow cylindrical shaft 1, so that a stopper or braking system is needed to keep the GFAMIT turbine system on hold when not in use, and the hollow cylindrical shaft 1 must be in a stopped position applying brake force on the hollow cylindrical shaft 1 at the holding position. The length of the rotating link 2 and the weight of the heavy rolling wheel 6 are design parameters.

A flywheel and brake block 300 having a flywheel and brake shaft 301, the hollow or solid rotating shaft 1, and a toothed flywheel 40, a pre-selected number I pairs of braking shoes 41 and a pre-determined number j of anchor arms 57 wherein the pre-selected number I pairs of braking shoes 41 and the pre-determined number j of anchor arms 57 simultaneously hold the toothed flywheel 40 prohibiting the hollow or solid rotating shaft 1 from rotating motion by the gravity on a heavy rolling wheel 6 and wherein the simultaneous scissors motions of the pre-selected number I pairs of braking shoes 41 and the pre-determined number j of anchor arms 57 are controlled by the computer 1000.

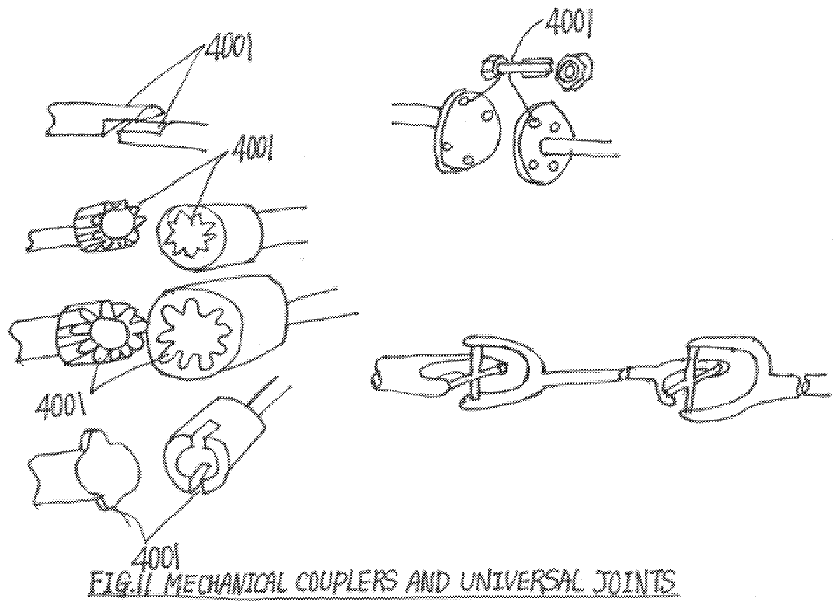

A torque coupling device 400 connecting a pair of mating mechanical shafts having a pair of mating male and female coupling ends 4001 for transferring the twisting torque of the mating female coupling end of the pair of mating male and female coupling ends 4001 driven by the flywheel and brake shaft 301 to the mating male coupling end of the pair of mating male and female coupling ends 4001, as shown in FIG. 11, a pair of flat surfaces of half cylindrical ends, a male and female gear shapes, a pair of protruded shape on a shaft and a pair of mating valleyed shape on a mating shaft, a pair of flanges having aligned holes and fasteners, and universal joints.

A torque measurement and transmission device 500 has a rotary torque sensor 505 measuring the shaft torque or shaft twisting moment of the hollow or solid rotating shaft 1 and having a display showing torque, speed and power values and plots on the display. To reduce the cost of the GFAMIT system, the rotary torque sensor 505 is replaced with a pair of piezoelectric strain gauges 506 wherein the piezoelectric strain gauges 506 measure the circumferential twisting strain of the torque coupling device shaft 401 in FIG. 7A connected in series to the hollow or solid rotating shaft 1. The sampled raw output data from the pair of piezoelectric strain gauges 506 are contaminated by noises and are very difficult to find the mean or median values so that it requires a Chebyshev filter Type I or Type II having at least 8^{th} order, Butterworth filter, elliptic filter, or Savitzky-Golay filter to display and read a smoothed data by reducing or washing out the contaminating high frequency noises in the sampled raw output data and reading the smoothed and most probable data without the noises. One shaft end of the rotary torque sensor 505 is connected to the hollow or solid rotating shaft 1 and the other shaft end of the rotary torque sensor 505 is connected to the gearbox driving shaft 501 of the gearbox device 600. The gearbox driving shaft 501 of the gearbox device 600 optionally has a series of universal joints in FIG. 11 to provide spacing between the gearbox device 600 and another gearbox device 601.

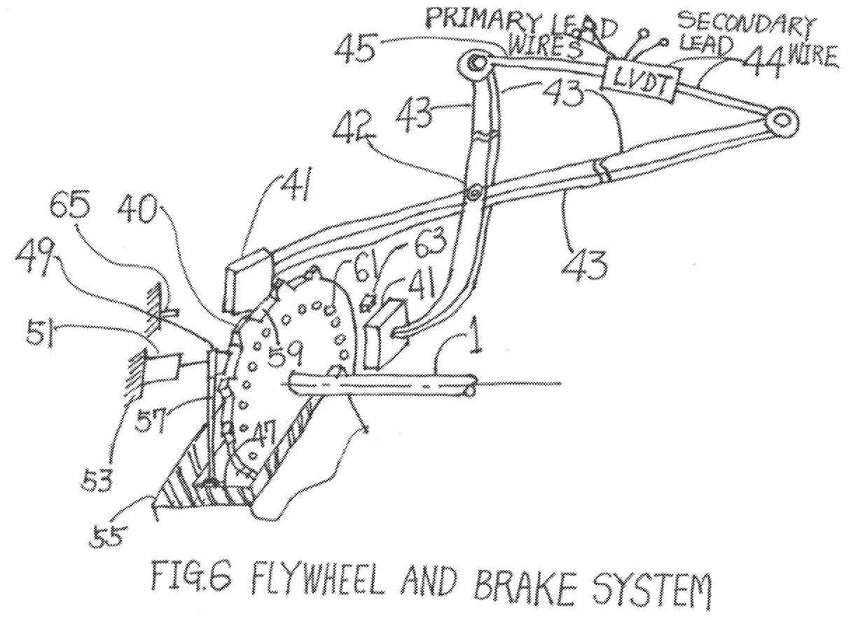

Without having the hollow frustoconical housing 8 and after rotating the hollow or solid rotating shaft 1 by releasing the pre-selected number I pairs of braking shoes 41 and the pre-determined number j of anchor arms 57 holding the toothed flywheel 40 shown in FIG. 6, and then rotating the hollow or solid rotating shaft 1, as the angular velocity of the hollow or solid rotating shaft 1 increases, each rotating link 2 and the heavy rolling wheel 6 gradually and radially stretches due to the centrifugal forces and at a certain angular velocity, the summation of the inertial counter-twisting moments acting each rotating link 2 and the heavy rolling wheel 6 in the left half side of the hollow or solid rotating shaft 1 become the same as the summation of the inertial twisting moments acting on each rotating link 2 and the heavy rolling wheel 6 in the right half plane of the rotation without having the hollow frustoconical housing 8, and eventually arrives at an equilibrium angular velocity in the ambient air space. Even though the rotational speed of the GFAMIT system arrives at the equilibrium angular speed, because of the rotational arm length differences between the left and right X-Y plane, the rotating shaft 1 receives the induced resultant centrifugal force difference toward the positive X-axis in the X-Y plane and the GFAMIT system needs a supportive reaction force to cancel the induced resultant centrifugal force difference in the right half plane.

When the GFAMIT system rotates, shear force on the hinge bolt 3 increases due to increase of centrifugal force in accordance with increase of angular velocity of the hollow or solid rotating shaft 1. Initially, the magnitude of the centrifugal forces working on the left half plane and the magnitude of the right half plane are different due to the longer rotational arm length in the right half plane than the rotational arm lengths in the left half plane. At a certain angular velocity and without considering the total external torque on all mechanical shafts of the electric generators, the summation of the inertial counter-twisting moments acting on the rotating links in the left half plane and resistive counter torque caused by the frictional force working on the rotating circumferential surfaces of the turbine eventually become the same as the summation of the inertial twisting moments acting on the rotating link 2 and the heavy rolling wheel 6 in the right half plane of the rotation. This angular velocity is the equilibrium angular velocity and the shear force on the hinge bolt 3 due to the centrifugal force passing the right half plane is constant and maximal. In other words, it is a constant angular velocity without having an external torque to rotate the hollow or solid rotating shaft 1 satisfying the rotation dynamic equation J(d²θ/dt²)+ζ((dθ/dt)+Kₛθ=0, wherein θ=rotation angle, J=moment of Inertia, ζ=viscosity and Kₛ=spring constant. However, in the case of an uncontrolled high rotational speed, there is a possibility of mechanical fracture of the related mechanical parts so that the rotating link 2 or the heavy rolling wheel 6 of the GFAMIT system is accidentally detached or disintegrated from the fastened or welded part by the induced resultant centrifugal force. When mechanical failure occurs, the induced resultant centrifugal force makes the disintegrated rotating link 2 or the heavy rolling wheel 6 radially fly and damage a part of the GFAMIT system or an operator or a person passing by can be injured. For the sake of preventing an accident due to structural failure of the GFAMIT system, a cylindrically hollow safety-housing (not shown) which is concentrical to the centerline of the rotating shaft 1 is added outside of the trajectory of the heavy rolling wheel 6 to protect the GFAMIT system in addition the disclosed variable arms in paragraph 116 at lines 10-13.

The hollow frustoconical housing 8 prohibits the rotating link 2 and the heavy rolling wheel 6 in the left half plane from being fully stretched and creates the torque (inertial twisting moment) difference between the rotating link 2 and the heavy rolling wheel 6 in the right half side and each rotating link 2 and the heavy rolling wheel 6 in the left half side.

With an external torque applied to the hollow or solid rotating shaft 1, the rotation dynamic equation of motion has non-zero external torque T, i.e., J(d²θ/dt²)+ζ((dθ/dt)+Kₛ θ=T,

$$[ \begin{matrix}\dot{θ} \\ \dot{ω}\end{matrix} ] = [ \begin{matrix}0 & 1 \\ ( - K / J ) & ( - ξ / J )\end{matrix} ] [ \begin{matrix}θ \\ ω\end{matrix} ] + [ \begin{matrix}0 & ( T / J )\end{matrix} ] [ \begin{matrix}u 1 \\ u 2\end{matrix} ]$$

wherein θ=rotation angle of the hollow or solid rotating shaft 1, ω=angular velocity of the hollow or solid rotating shaft 1, J=moment of Inertia, ζ=viscosity and Kₛ=spring constant, and T=torque (external twisting moment) to rotate the pre-decided number L of 3-φ electric power generators 8000, wherein in detail, J is the summation of rotational moment of inertial of the (M×N) arms attached to the hollow or solid rotating shaft 1, rotational Moment of Inertia (Mol) of the circular flywheel disk 40, and the dynamic system equation describes that the summation of the (positive and) inertially induced twisting moment (created by the gravitational force) of each twisting-moment-arm of the hollow or solid rotating shaft 1 having the rotating links 2 and the heavy rolling wheels 6 is equal to the summation of all (negative) external torque T to turn the pre-decided number L of 3-φ electric power generators 8000 driven by the rubber rim 701 of the driving wheel 7000.

The hollow or solid rotating shaft 1 has the limited number N of the rotating link 2 and the heavy rolling wheel 6 to satisfy a required total torque of the pre-decided number L of 3-φ electric power generators 8000 driven by the hollow or solid rotating shaft 1 and the length of the hollow or solid rotating shaft 1 extends to accommodate the limited number N of the rotating link 2 and the heavy rolling wheel 6. The weight of the heavy rolling wheel 6 and the length of the rotating link are design parameters to satisfy the required total torque to rotate the pre-decided number L of 3-φ electric power generators 8000.

What is emphasized here is the centrifugal force difference between the left and right half planes because of the difference in the rotational arms in the left and right half planes. This means that the turbine system is pushed toward the horizontal axis X of the right plane. The GFAMIT system needs a strong structure to create a counter-active reaction force in response to the total magnitude of the imbalanced centrifugal force for the purpose of cancelling the imbalanced centrifugal force components acting toward the right half plane.

The centrifugal force is proportional to the arm length and the squared angular velocity ω and creates bending of the hollow or solid rotating shaft 1 of the GFAMIT system. The horizontal components of the centrifugal forces act toward the horizontal axis X of the X-Y plane. To limit the bending and tortional tearing of the hollow or solid rotating shaft 1, a pair of strain gauge and piezoelectric sensor among a predefined number M of strain gauges and piezoelectric sensors are fixed along the same circumferential circle at the middle point of the rotational axis of the hollow or solid rotating shaft 1 and outsides of the predefined number M of hollow frustoconical housings 8. The strain gauge senses the instantaneous elongations of the hollow or solid rotating shaft 1 by the resultant centrifugal force creating the bending moments at both ends of the hollow or solid rotating shaft 1 around the hollow housings 8 and the piezoelectric sensor senses the twisting displacements of the hollow or solid rotating shaft 1 by the torque applied to the hollow or solid rotating shaft 1. Both centers of each strain gauge and each piezoelectric strain sensor are fixed along the circumferential circle at the middle length position of the hollow or solid rotating shaft 1but the axial sensing direction of the strain gauge and circumferential sensing direction of the piezoelectric strain sensor are perpendicular. The strain gauge fixed along the circumferential circle on the outer surface of the hollow or solid rotating shaft 1 measures the elongations of the hollow or solid rotating shaft 1 by the centrifugal force and the piezoelectric strain sensor along the circumferential circle measures the twisting displacements of the hollow or solid rotating shaft 1 at the middle length position of the hollow or solid rotating shaft 1 by the twisting torque applied to the hollow or solid rotating shaft 1. The locations of both strain gauge and piezoelectric strain sensor are at any location along the circumferential circle at the middle of the rotating shaft 1. Both the measured elongations values and twisting displacements fluctuate with respect to time due to the rotational motion of the hollow or solid rotating shaft 1. The measured output signals from the strain gauges and sensors are sampled and the sampled strain gauge and piezoelectric strain sensor output data fluctuates very much being contaminated by noises so that it requires a Chebyshev filter Type I or Type II having at least 8^{th} order, Butterworth filter, elliptic filter, or Savitzky-Golay filter to display and read a smoothed data by reducing or washing out the contaminating high frequency noises in the sampled data set and reading the smoothed and most probable data without the noises. A data logger stores the sampled data every time interval, the time interval equivalent to twice the rotational speed {1/(2ω)}, to the SSD drive.

Taking the Fourier transform of the stored measurement signals from the SSD drive for each encoder and tachometer, rotary torque sensor, accelerometers, the strain gauges and sensors and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder and tachometer equal to the desired angular velocity, the measured output signals from each rotary torque sensor close to the desired torque, the measured output signals from each accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known (e.g., Katsuhiko Ogata, Bernard Friedland) and are not explained here, and the dynamic system of the GFAMIT system is different and unique from the others.

The computer 1000 receives the measurement signal from the rotary torque sensor 505 or the piezoelectric strain gauges 506 equivalent to the corresponding torque value and divides the measurement signal by a single torque magnitude required to rotate a single 3-φ electric power generators 8000 driven by the rubber rim 701 of the driving wheel 7000 and determine the necessary number of the subset of the pulley 8040 of the pre-decided number L of 3-φ electric power generators 8000 to be attached or detached from the rubber rim 701 covered on the driving wheel 7000 and the computer 1000 selects the members of the subset of the pulley 8040 of the pre-decided number L of 3-φ electric power generators 8000 and the movement distance of attaching or detaching each 3-φ electric power generators 8000 is greater than zero and less than two inches. The computer 1000 is controlled by a server of a LAN or WAN computer network with Internet connection.

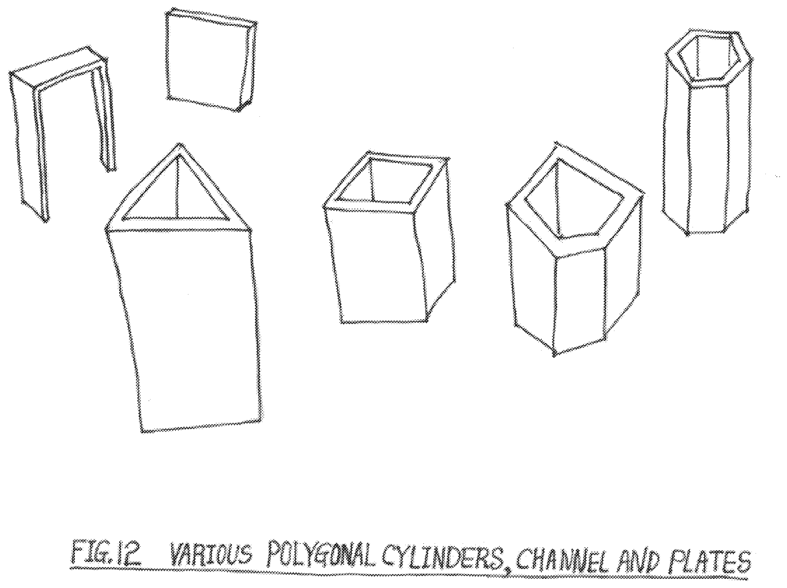

Therefore, the axial length of the hollow or solid rotating shaft 1 of the rotating shaft 1 is designed to endure the active bending moment made by the induced resultant centrifugal force less than the allowable elongations threshold strain value. And then, the designed hollow or solid rotating shaft 1 is supported by support frames 21~28 in FIG. 5 and the designed hollow or solid rotating shaft 1 can be repeatedly used to meet the required electric power requirements. If a large interval is required between the designed hollow rotating shafts, universal joints in FIG. 12 are used to connect the hollow rotating shafts 1 of the GFAMIT system.

The hollow frustoconical housing 8 prohibits the rotating links in the left half plane from being fully stretched and creates the centrifugal force difference and the inertial twisting moment difference between the twisting-moment-arms in the left and right half planes in FIG. 1. The fixed hollow frustoconical housing 8 reduces the magnitude of the centrifugal force action on the hinge bolt 3 wherein the centrifugal force acting on the hinge bolt 3 acts as a shear force applied on the hinge bolt 3 so that the reduction of the shear force applied on the hinge bolt 3 extends the operational life of the rotating links 2 in FIG. 1.

A circular plate 9 in FIG. 2 is fastened using various fasteners or welded to the hollow frustoconical housing 8 and fixedly supports the hollow frustoconical housing 8 to upper support beam 22 and lower support beam 28. The hollow frustoconical housing 8 and the circular plate 9 provide structural stability on the hollow frustoconical housing 8 against a reaction force on the surface of the heavy rolling wheel 6 in FIG. 1 when the rotating link 2 rotates with respect to the hinge bolt 3 inside the hollow frustoconical housing 8. The heavy rolling wheel 6 takes an elliptical heavy rolling wheel groove 61 toward the conical end-surface 81 having the shortest radius of the hollow frustoconical housing 8 by the reaction force of the centrifugal force applied to the heavy rolling wheel 6 and a rubber ring 60 or a solid rubber tire 6001 fitted and fixed on the circumferentially outer surface of the heavy rolling wheel 6 for the purpose of reducing noise for quiet operations and the longitudinal length of the hollow frustoconical housing 8 from the centerline of the hinge bolt 3 to the circular plate 9 of the hollow frustoconical housing 8 is long enough to house the rotating link 2, the heavy rolling wheel support 5 and the heavy rolling wheel 6 within the hollow frustoconical housing 8 and wherein the hollow frustoconical housing 8 is made of steel having enough strength to withstand the wear and the external forces applied to the inner surface of the hollow frustoconical housing 8. When the rotating link 2 rotates within the hollow frustoconical housing 8, the heavy rolling wheel 6, having the rubber ring 60 or a rubber tire 6001 and connected to the rotating link 2, follows the elliptical rolling wheel groove 61 formed toward the conical end-surface 81 having the shortest radius of the hollow frustoconical housing 8 by the centrifugal force and the reaction force applied to the heavy rolling wheel 6. The rolling wheel support 5 has a rotation vector along one of the positive and negative X-axis and rotates with respect to a rolling wheel bolt 4. The heavy rolling wheel 6 rotates with respect to a rolling wheel shaft bolt 7 and the related nuts providing 3 degrees of freedom (DoF) motions, but the nuts are not shown for simplicity of the disclosure. Friction between the heavy rolling wheel 6 and the inner surface of the hollow frustoconical housing 8 helps better tracking of the elliptical rolling wheel groove 61 by the heavy rolling wheel 6 and is as minimal as possible compared to the friction between the rubber ring 60 and the elliptical rolling wheel groove 61 formed on the inner surface of the hollow frustoconical housing 8. The rotating rink 2 on each other seven supporting arms 13 are not shown for simplicity of the disclosure work.

When the hollow or solid rotating shaft 1 rotates with a rotational velocity, the induced resultant centrifugal force vector F makes the rotating link 2 to be radially stretched and aligned with the arms 13 at the 3 O'clock position (90-degree position inside the widest end-surface of the hollow frustoconical housing 8). The rotating link 2 is rotated with respect to the hinge bolt 3 and folded and axially aligned parallel to the hollow or solid rotating shaft 1 at the 6 O'clock position (vertically downward position inside the narrowest end-surface of the hollow frustoconical housing 8) due to the reaction force from the inner surface of the hollow frustoconical housing 8 and the inertial twisting moment induced by the assembly of the rolling wheel support 5 and heavy rolling wheel 6.

The difference of the radial arm length at the 3 O'clock position and the 9 O'clock position induces the difference between the rotational moment of inertia of the arms 13 at the 3 O'clock position and the opposite rotational moment of inertia of the arms 13 at the 9 O'clock position and creates inertial twisting moment on the hollow or solid rotating shaft 1.

The centrifugal force vector F induced by the twisting-moment-arms acting on the hollow or solid rotating shaft 1 is not equal due to changing radius to the mass center of the heavy rolling wheel 6 from the longitudinal axis of rotation of the hollow or solid rotating shaft 1 and creates the unequal centrifugal force vector F acting on the hollow or solid rotating shaft 1. The different twisting-moment-arm-lengths creates bending moment on the hollow or solid rotating shaft 1 with respect to the journals of the hollow or solid rotating shaft 1.

Double layered bearing assembly 17 and 18, and 16 and 19 are applied on the journals of the hollow or solid rotating shaft 1. A pair of inner layer bearings 18 and 19 on both journal of the hollow or solid rotating shaft 1 are a pair of sliding ring-bearings 18 having a cylindrical shape and installed on the journals of the hollow or solid rotating shaft 1.

The sliding ring-bearing 18 increases the contact area to distribute the large centrifugal force vector F on the surface of the sliding ring-bearing 18 and withstand the mechanical moment created by the large centrifugal force vector F on the surface of the sliding ring-bearing 18 and minimize both mechanical vibration (of the journal due to the imbalanced centrifugal force vector F and bending moment applied on the hollow or solid rotating shaft 1) and the mechanical noise (for environmentally friendly and quiet operation with low angular velocity operation of the hollow or solid rotating shaft 1).

A pair of outer layer bearings 16 and 17 on the outer surface of the sliding ring-bearings 18 are needle bearings 16 and 17 withstanding the total weight of the hollow or solid rotating shaft and the related mechanical parts and the needle bearings 16 and 17 further cancelling or minimizing the friction force induced by the sliding ring-bearings 18 and 19.

Therefore, each pair of strain gauge and piezoelectric stain sensor of the predefined number M of strain gauges and piezoelectric strain sensors are fixed along the same circumferential circle at the middle point of the rotational axis of the hollow or solid rotating shaft 1 and outsides of the predefined number M of hollow frustoconical housings 8. The strain gauge senses the instantaneous elongations of the hollow or solid rotating shaft 1 by the resultant centrifugal force creating the bending moments at both ends of the hollow or solid rotating shaft 1 around the hollow housings 8 and the piezoelectric sensor senses the twisting displacements of the hollow or solid rotating shaft 1 by the torque applied to the hollow or solid rotating shaft 1.

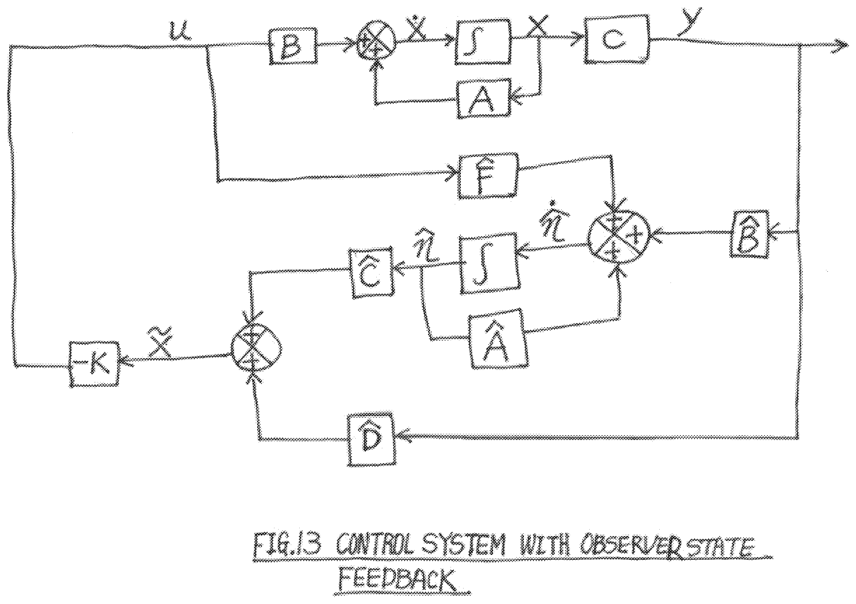

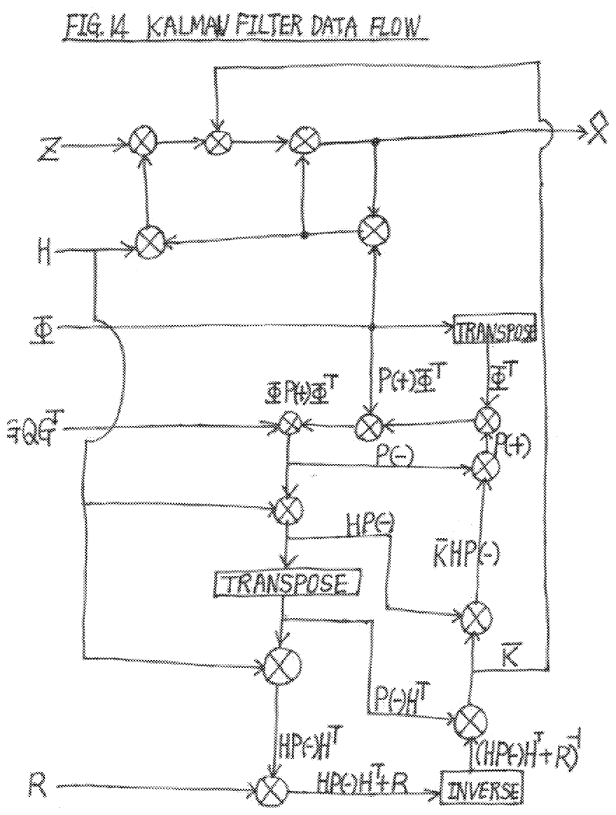

Both centers of each strain gauge and each piezoelectric strain sensor are fixed along the circumferential circle at the middle length position of the hollow or solid rotating shaft 1but the axial sensing direction of the strain gauge and circumferential sensing direction of the piezoelectric strain sensor are perpendicular. The strain gauge fixed along the circumferential circle on the outer surface of the hollow or solid rotating shaft 1 measures the elongations of the hollow or solid rotating shaft 1 by the resultant centrifugal force and the piezoelectric strain sensor along the circumferential circle measures the twisting displacements of the hollow or solid rotating shaft 1 at the middle length position of the hollow or solid rotating shaft 1 by the twisting torque applied to the hollow or solid rotating shaft 1. The locations of both strain gauge and piezoelectric strain sensor are at any location along the circumferential circle at the middle of the hollow or solid rotating shaft 1. The strain gauge outputs and the piezoelectric strain sensor outputs are signal conditioned, amplified and compared to the allowable threshold strain value to compute the strain error to be used in the dual closed-loop feedback servo-controller in FIG. 4 authored by Katsuhiko Ogata or the LQG/LQR closed-loop feedback servo-controller in FIG. 13 authored by Bernard Friedland, or Kalman filtering in FIG. 14 by Mohinder S. Grewal and Angus P. Andrews. The measured output signals from each of the strain gauges and piezoelectric sensors are sampled and a data logger stores the sampled data every time interval, every second, to the SSD drive and the LQG/LQR type closed-loop feedback servo-controller or the dual closed-loop feedback servo-controller regulate the rotational speed of the hollow or solid rotating shaft 1 to an optimal rotational speed using the measured output signals from the tachometer and encoder, and keep the measured shaft strain by the strain gauges and piezoelectric strain sensors less than an allowable elongations threshold strain value and allowable twisting displacements threshold strain value. The limited number M of strain gauges and piezoelectric strain sensors measure the elongations of the hollow or solid rotating shaft 1 by the centrifugal force and twisting displacements of the hollow or solid rotating shaft 1 by the torque applied to the hollow or solid rotating shaft 1.

A 120°-angle frustoconical reinforcement structure having a thickness intuitively determined or empirically determined or computed using a structural analysis FEM software (e.g., ANSYS, NASTRAN, ABAQUS) is added to the longer arm side outer surface of the hollow frustoconical housing 8 to withstand the unbalanced centrifugal force vector F applied to the longer arm side of the hollow frustoconical housing 8.

The centrifugal force vector F applied to the inner surface of the hollow frustoconical housing 8 is further supported by a 120°-angle frustoconical reinforcement structure 15 in FIGS. 2 and 151 in FIG. 5.

A centrifugal force supporting structure 200 comprises a plurality of horizontal frames 21-28 and a plural pair of vertical frames 29 and 31 for withstanding the induced resultant centrifugal force F. The left surface of the horizontal column 21 receives and withstands the total centrifugal force F from each 120°-angle frustoconical reinforcement structure 151 of a predefined number M of 120°-angle frustoconical reinforcement structures 15 and the right side surface of the horizontal column 21 has a predefined number Msb of slant beams 20 wherein each slant beam of the plurality of slant beams 20 has a foot 331 for providing the reaction force against the centrifugal force induced by rotating a limited number N of twisting-moment-arm 2 and a rolling wheel support assembly 5000. And each accelerometer pair of three pairs of accelerometers are fixed on the top surfaces at both ends of each horizontal frame of three horizontal frames 22, 23 and 24 for measuring the vertical accelerations and quantifying the vertical distance of vibration amplitudes by computing double-integral of the measured acceleration with respect to time and a pair of accelerometers fixed on the vertical surfaces of the left and right ends of the horizontal column 21 for measuring the magnitude of the centrifugal force F in the horizontal direction and the horizontal accelerations of the horizontal beam 21 and for quantifying the horizontal distance of vibration amplitudes by computing double-integral of the measured horizontal acceleration with respect to time. When necessary, the slant angle of the predefined number Msb of slant beams 20 can be reconfigured to the perpendicular angle so that the predefined number Msb of slant beams 20 can be fixed on a vertical wall of a structure or building. The proximal end of each slant beam of the plurality of slant beams 20 having a foot 331 at the distal end is provided a hinge so that each slant beam can be horizontally rotated, adapted and fastened to a vertical wall of a building or a plurality of body frames of an engine compartment of a vehicle and the foot 331 at the distal end of the slant beam having a plurality of slotted holes for fasteners to be inserted and fastened.

A centrifugal force supporting structure 200 comprises a horizontal column 21 between the 120°-angle frustoconical reinforcement structure 15 and a plurality of slant beams 20 for each 120°-angle frustoconical reinforcement structure 151 withstands the centrifugal force vector F in FIG. 5 and the plurality of slant beam 20 is a plurality of horizontal beams 20 in the case of using an existing wall as a support structure. A pair of accelerometers fixed on the vertical surface of the left and right ends of the horizontal column 21 measure the magnitudes of the centrifugal force vector F and a data sampler samples the output signals of the pair of accelerometers with a sampling frequence twice higher than the frequency of the output signals of the pair of accelerometers. The sampled accelerometer output data fluctuates very much being contaminated by noises so that it requires a Chebyshev filter Type I or Type II having at least 8^{th} order, Butterworth filter, elliptic filter, or Savitzky-Golay filter to display and read a smoothed data by reducing or washing out the contaminating high frequency noises in the sampled data set and reading the smoothed and most probable data without the noises. Ideally, the plurality of slant beams 20 are horizontally connected to the frame 21 but the plurality of slant beams 20 can have any slope angle if the plurality of slant beams 20 could cancel the centrifugal force created by rotating motion of the hollow or solid rotating shaft 1, depending on the situations such as a flat ground, an area close to a building structure, or a space close to a frame of a vehicle.

Each of the plurality of slant beams 20 has a plurality of foots 331 or feet 331, and the horizontal frames 21, 22-28 and two pairs of vertical frames 29 and 31 which receives the centrifugal force are supported by each of the plurality of slant beams 20 providing the reaction force against the centrifugal force (induced by the twisting-moment-arm 2 and the assembly of the rolling wheel support 5) wherein the total reaction force is in equilibrium with the centrifugal force induced by the rotating parts. The plurality of slant beams 20 are made of a strong material selected from a processed solid wood beam, steel H-section beam, T-section beam, channel-section beam, L-sectioned beam, square or rectangularly-cross-sectioned beam, steel pipe beam, rail-beam, or reenforced concrete beam. Each of the plurality of feet 331 is a circular steel plate, square or rectangular steel plate but can be any shape withstanding the centrifugal force and is coated with corrosion protective paint.

Three pairs of accelerometers are fixed on the top surfaces of the horizontal frames 21, 22 and 24. One pair of accelerometers fixed on the top surface of both ends of the middle-horizontal frame 23 measures the vertical vibrations of the horizontal frame 23 shaken by the hollow or solid rotating shaft 1 and related parts. The rest of the two pairs of accelerometers fixed on the top surfaces of the horizontal frames 22 and 24 measure the vertical accelerations of the horizontal frames 22 and 24 with respect to the horizontal frame 23. The smoothed output signals from the two pairs of accelerometers fixed on the top surfaces of the horizontal frames 22 and 24 are time-integrated twice to compute the probable vertical displacement-magnitude (distance) of the vibration amplitudes. The probable vertical distance-magnitude of the vibration is divided by half of the horizontal distance between the horizontal beams 22 and 24 resulting in the tangent value of the angular vibration. Taking inverse tangent and converting the radian to angular degree, the angular vibration of the supporting horizontal frames 21, 22 and 28 with respect to the longitudinal axis of the frame 21 is computed.

The heavy rolling wheel 6 follows the elliptical rolling wheel groove 61. A semi-circular rolling wheel groove 62 shown in FIG. 1 is a semi-circular path near the end surface of the shortest radius side of the hollow frustoconical housing 8 and the elliptical heavy rolling wheel groove 61 is an elliptical path from the top end of the semi-circular path toward the end surface of the largest radius side of the hollow frustoconical housing 8 and further extends meeting the lower end of the semi-circular rolling wheel groove 62 so that the rotating link 2 can be radially stretched and aligned with the arms 13 at the 90-degree position (3 O'clock position) and begins to fold elliptical following the rolling wheel groove 61 from the 3 O'clock position to 6 O'clock position.

The mass of the rolling wheel support 5 should be large enough to overcome the inherent friction force between the moving parts and produce driving torque to rotate the rotating shaft 1 and the pre-decided number L of 3-φ electric power generators 8000 connected to the hollow or solid rotating shaft 1. The heavier the rolling wheel support 5 is, the larger the centrifugal force and the rotating moment is.

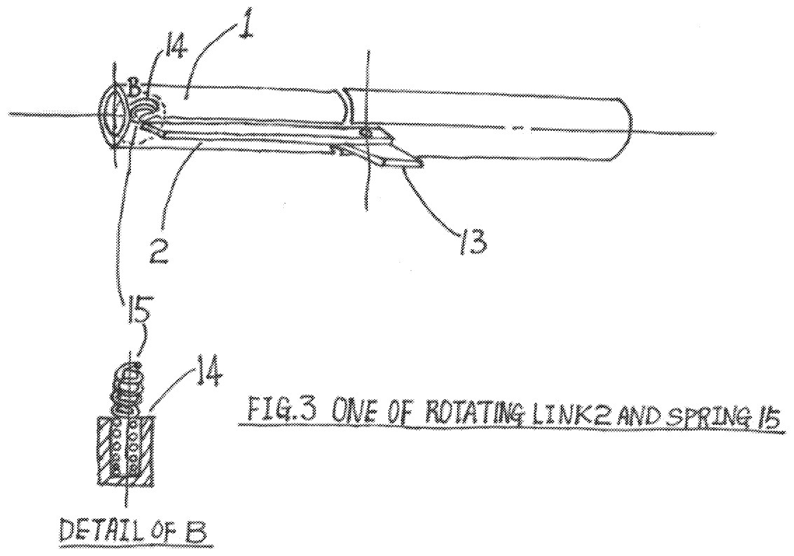

FIG. 3 discloses the rotating link 2 folded after 90-degree rotation from the 3 O'clock position to 6 O'clock position near the circular plate 9 and compressing a compression spring 15 to store the kinetic energy of the rotating link 2 and the heavy rolling wheel 6 into the compression spring 15 so that the compressed spring force of the compression spring 15 helps the rotating link 2 to simultaneously initiate rotation with respect to hinge bolt 3 and stretch from the folded position, and follow the top portion of the elliptical rolling wheel groove 61 after rotating 180-degrees inside the semi-circular rolling wheel groove 62 near the circular plate 9 shown in FIG. 2. The bottom half of the compression spring 15 is contained and fixed to the bottom of the closed cylinder 14 so that it does not come out of the closed cylinder 14.

The closed cylinder 14 has threads formed on the outer surface of the closed cylinder 14 and fitted into the hollow or solid rotating shaft 1 or it is placed into a hole on the hollow or solid rotating shaft 1 and welded to the top surface of the hollow or solid rotating shaft 1.

The elliptical rolling wheel groove 61 is determined by the following procedures.
1. On a thin paper, draw the open shape of a hollow frustoconical housing 8.
2. Make a replica of the open shape of the hollow frustoconical housing 8 on a thin and soft sheet metal and cut the outline of the drawn open shape of the hollow frustoconical housing 8 using a pair of metal cutting scissors or an appropriate tool and remove the sharp burs for safety.
3. Bend and form the open shape of the hollow frustoconical housing 8 as the 3-dimensional body of the hollow frustoconical housing 8.
4. Glue the thin paper of the open shape of the hollow frustoconical housing 8 on the inner surface of the hollow frustoconical housing 8.
5. Insert and concentrically align the assembly of the hollow or solid rotating shaft 1 along the centerline of the hollow frustoconical housing 8.
6. Rotate the hollow or solid rotating shaft 1 having the rotating link 2 and the heavy rolling wheel 6 axially and longitudinally folded along the centerline of the hollow or solid rotating shaft 1 until the heavy rolling wheel 6 is located at the top of the semi-circular rolling wheel groove 62.
7. Attach a marker pen at the distal end of the heavy rolling wheel 6.
8. Manually stretch and make the pen on the heavy rolling wheel 6 touch the inner surface of the paper on the hollow frustoconical housing 8.
9. Slowly rotate the hollow or solid rotating shaft 1 making the pen touch the paper and draw the trajectory of the pen on the paper on the inner surface of the hollow frustoconical housing 8 slowly turning the hollow frustoconical housing 8 180-degrees.
10. Remove the assembly of the hollow or solid rotating shaft 1 out of the hollow frustoconical housing 8.
11. Remove the paper having the drawn trajectory of the pen from the inner surface of the hollow frustoconical housing 8.
12. Make a copy of the drawn trajectory of the pen on another paper.
13. Glue the copy of the drawn trajectory of the pen on a sheet metal having a desired thickness and strength.
14. Do machining and form the elliptical rolling wheel groove 61 on the sheet metal having a desired thickness and strength along the drawn trajectory.
15. Bend and form the 3-dimensional hollow frustoconical housing 8 having the elliptical rolling wheel groove 61 on the inner surface of the hollow frustoconical housing 8.
16. Using a laser scanner, scan the elliptical rolling wheel groove 61 on the inner surface of the hollow frustoconical housing 8 and generate a digital file to be used on a CNC machine so that the CNC machine can form the elliptical rolling wheel groove 61 on the inner surface of a hollow frustoconical housing 8.

As shown in FIG. 2, the number of frustoconical housing 8 and the length of the hollow or solid rotating shaft 1 depends on the total torque of a fixed number K (e.g., 2 with solid-line, 3 including dashed-line, or six including the block 601 in FIG. 7A) of 7000 in FIG. 7A driven by a gearbox device 600 having a driving shaft and a plurality of driven shafts wherein the driven shafts rotate the fixed number K of driving wheels 7000. Each driving wheel 7000 is covered with rubber rim 701 which frictionally rotates a limited number (e.g., 12 in FIGS. 7A-7B) of driven pulleys 8040 rotating the driving shafts 8020 of the pre-decided number L (e.g., 12 in FIGS. 7A-7B) of 3-φ electric power generators 8000 frictionally driven by the fixed number K of driving wheels 7000 which is remotely driven by the hollow or solid rotating shaft 1. The diameter of the driving wheels 7000 is between n1 (e.g. 5)~n2 (e.g. 20) times larger than the diameter of the pulleys 8040 of the pre-decided number L of 3-φ electric power generators 8000 for the purpose of decreasing the angular velocity of the driving wheel 7000 resulting in decreased centrifugal force but the total twisting torque of the twisting-moment-arms is simultaneously greater than the total mechanical torque to drive the driven shaft of the pre-decided number L of 3-φ electric power generators 8000 wherein n1 and n2 are fixed numbers and the fraction n2/n1 is greater than 2, 20/5=4 and n1 is smaller than n2 and are design parameters. The diameter of each driving wheel also depends on the pre-decided number L of 3-φ electric power generators 8000 so that the circumferential length of the rubber rim 701 has enough room to attach and frictionally drive the pulleys 8040 of the pre-decided number L of 3-φ electric power generators 8000 to be all and simultaneously driven by the rubber rim 701 of the driving wheel 7000 wherein the total summation of diameters of the pulleys of the pre-decided number L of 3-φ electric power generators 8000 is less than circumferential length TTD of the outer diameter D of the rubber rim 701 for the purpose of providing enough space to mount the pre-decided number L of 3-φ electric power generators 8000 around the periphery of the rubber rim 701, and the friction force is automatically controlled by the computer 1000 controlling the command following motor driving the cross-sectionally-circular shaft 8570 creating axially telescoping motion of the telescoping square-structural tubing 8580 linearly sliding within the cross-sectionally square-tubular-pipe 8510 by the computer 1000, wherein a pair of accepting channel flanges 8582 accept the pivoting electric generator holder 8585 having the pivot arms 8586.

Physics teaches that the centrifugal force is proportional to the arm radius and the angular velocity squared of the twisting-moment-arm, i.e., F=(arm radius r)×(angular velocity of the twisting-moment-arm w)²=rw². Considering the gravitational force as an external force for the simplification of the analysis, the inertial twisting moment (Mₜ) equation of a fictitious weight (W) attached at the end of a fictitious twisting-moment-arm length r and an fictitious arm weight Wₐ concentrated at the centroid of the twisting-moment-arm is simply Mₜ=(r/2)(Wₐ)+(r)(W). In the case of a fixed number J of the twisting-moment-arms, the total twisting moment on the shaft is Mₜ₋ₜₒₜₐₗ=(J)((r/2)(Wₐ)+(r)(W)).

The flywheel disk and brake system 300 in FIG. 2 has a circular flywheel disk 40 in FIG. 6, a pre-selected number I pairs of braking shoes 41 and a pre-determined number j of anchor arms 57 shown in FIG. 6. When a necessity to stop the rotation of the hollow or solid rotating shaft 1 occurs, the circular flywheel disk and brake system 300 stops the angular motion of the hollow or solid rotating shaft 1. The circular flywheel disk 40 has teeth on the radial end surface and the center of the circular flywheel disk 40 in FIG. 6 is welded on the hollow or solid rotating shaft 1. Each pair of the pre-selected number I pairs of braking shoes 41 angularly placed with even angles simultaneously squeezes the radial surface of the circular flywheel disk and frictionally releases the rotational kinetic energy as heat dissipation by a pivot 42 and a pre-selected number I pairs of levers 43 pivoting the pre-selected number I pairs of braking shoes 41 by a scissor motion. An LVDT (Linear Variable Displacement Transducer) 44 (mounted on a pre-selected number I pairs of steel arms 45) is connected between the ends of the lever device 43 to do the braking action much faster than the frequency of manual braking actions by hands. The pre-selected number I of LVDTs are to brake, stop, or hold the hollow or solid rotating shaft 1 satisfying the measured output signals from the strain gauges and piezoelectric strain sensors less than an allowable elongations threshold strain value and allowable twisting displacements threshold strain value of the rotating shaft 1. The pre-selected number I of LVDTs and the pre-selected number I of pairs of braking shoes 41 are simultaneously controlled (pulled and pushed) by a group of microcontrollers having the LQG/LQR closed-loop feedback servo-controller algorithm or the dual feedback loop closed loop servo-controller algorithm. An empirical or intuitive control law can be designed to control the angular velocity of the hollow or solid rotating shaft 1 without bending the hollow rotating shaft, creating vibration above a vibration threshold or a noise threshold. The LQG/LQR closed-loop feedback servo-controller or the dual feedback loop closed loop servo-controller controls the angular velocity of the hollow or solid rotating shaft 1 with an optimal vicious damping and without creating oscillation of the angular velocity of the hollow or solid rotating shaft 1. All I/O signals of the pre-selected number I of LVDTs 44 are sampled and a data logger stores the sampled data every time interval, the time interval equivalent to twice of the rotational speed {1/(2ω)}, to the SSD drive of the computer 1000.

A limited number of on/off solenoid switches 51 controlled by the computer 1000 control the motions of the limited number of anchor arms 57. The limited number of anchor arms 57 radially enter the teeth gaps 59 formed on the circular flywheel disk 40 securely holding the rotation shaft fixed without any rotation after the pre-selected number I pairs of braking shoes 41 frictionally dissipates the rotational energy and stop the rotational motion of the hollow rotating shaft. 1. The pre-determined number j of anchor arms 57 pivot with respect to each pivot center shaft 47. Each distal end of the pre-determined number j of anchor arms 57 is connected to one of the limited number of on/off solenoid switches 51 and each on/off solenoid switch 51 is connected to a fixed wall 53. All I/O signals of the limited number of on/off solenoid switches 51 are sampled and the data logger stores the sampled I/O signals of the limited number of on/off solenoid switches 51 to the SSD drive. When stopping the hollow or solid rotating shaft 1, first, each LVDT 44 simultaneously pulls each of the pre-selected number I pairs of braking shoes 41 to stop the rotation motion of the hollow or solid rotating shaft 1. Encoder 63 counts the number of holes 61 on the radial surface of the circular flywheel disk 40 and a light emitting LED device 65 placed on a wall at the left side of the circular flywheel disk 40 emits light toward the encoder 43 and the encoder outputs are sampled and stored to the SSD drive by the data logger. Immediately sensing the zero angular velocity and angle of the hollow or solid rotating shaft 1, the limited number of on/off solenoid switches 51 are triggered simultaneously moving the pre-determined number j of anchor arms 57 to locking positions. The microcontroller controls the pre-selected number I of LVDTs 44, LED devices 65, solenoid switches 51, and runs the dual closed-loop feedback servo-controller algorithm in FIG. 4 or the LQG/LQR closed-loop feedback servo-controller algorithm, and receives the output signals coming from the tachometer (for angular velocity) and the encoder 63 (for angular position). The pre-selected number I of LVDTs and on/off solenoid switches 51 can be single if small torque requirement is needed. In the case of small torque requirement to turn generators of several KW, the plurality of slant beams 20 are provided with pivot shafts or hinges and are rotatable with respect to the pivot shafts or hinges on the frame 21 or may be unnecessary. The plurality of feet 331 and the frames 21, 22,28 and 29 are unnecessary and are not integrated and the 120°-angle frustoconical reinforcement structure 151 is not needed either.

The left end of a Flywheel shaft 301 connected to the circular flywheel disk 40 has one mechanical element of a well-known and over-the-counter-available mechanical-coupler (e.g., an axially half cut rod and a mating axially half cut rod, an axially-male-toothed shaft and a mating axially-female-toothed shaft, a male-gear and a mating female-gear, protruded pins on a shaft and sockets on a shaft, a pair of shaft-disk-holes and fasteners disclosed in FIG. 11) or hydraulic coupler and is coupled with the other mating mechanical coupling element of the mechanical shaft of a torque coupling device 400.

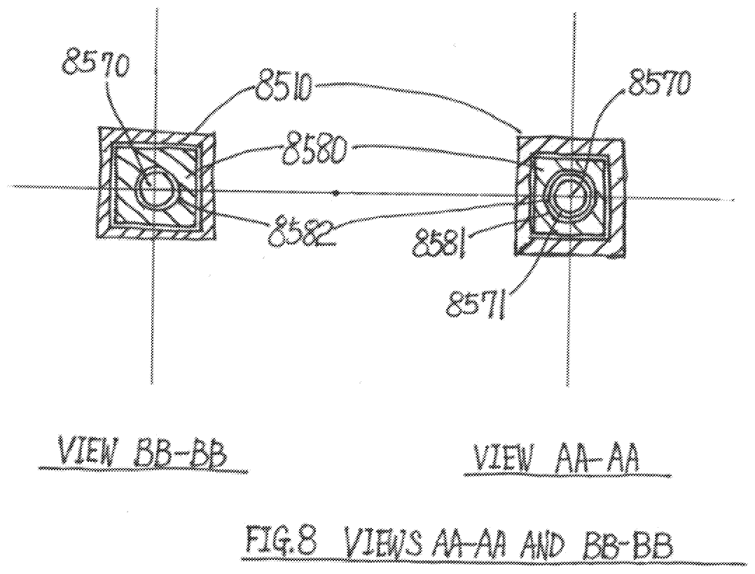

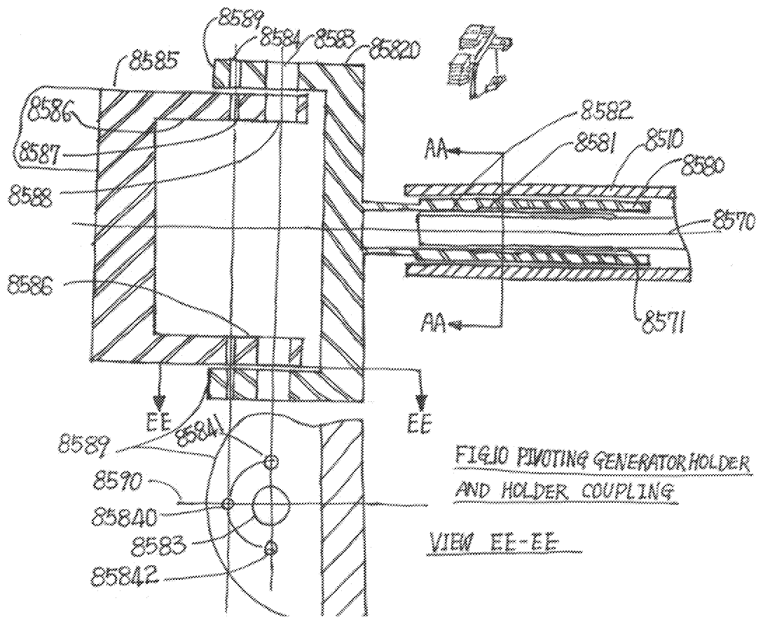

An electric generator mounting block 9210 is shown in FIGS. 7A~7B. The electric generator mounting block 9210 has three concentric cylinders. In detail, concentrical inner-cylindrical-support 8100, has a pre-fixed number i (e.g. 12) of square holes 8530 and for each square hole 8530 containing a cross-sectionally square-tubular-pipe 8510 containing a telescoping square-structural tubing 8580 among the pre-fixed number i of telescoping square-structural tubings 8580 wherein the telescoping square-structural tubing 8580 slides within the cross-sectionally square-tubular-pipe 8510 and wherein the pre-fixed number i is a multiple of the pre-decided number L, i.e., i=1 L, 2 L, 3 L, . . . , or an integer number added to the pre-decided number L, i.e., i=L+0, 1, 2, 3, . . . for increasing the capacity greater than the pre-decided number L of command following motors and providing redundant command following motors for later use, and for each of the pre-decided number L of cross-sectionally square-tubular-pipes 8510 to fixedly support the pivoting electric generator holder 8585 controlled by the pre-fixed number i of command following motors. The telescoping square-structural tubing 8580 has an internal step 8581 and circular female threads 8582 and the distal end of the telescoping square-structural tubing 8580 has accepting channel-shaped flanges 8589 disclosed in FIG. 10. The accepting channel-shaped flanges 8582 has a pair of bolt holes 8583 and 8588 and three fixing pin holes 85840, 85841, 85842 in FIG. 10. The circular female threads 8582 is mated with male threads 8571 partially formed on cross-sectionally-circular shaft 8570 directly connected with the mechanical output shaft of a command following motor selected from the group consisting of a DC-servo motor 8590 and a stepper motor 8591 (not shown) disclosed in FIGS. 7B-8 and the command following motor receives a command following signal from a vector output of the computer 1000 having control algorithm for each command following motor shown in FIG. 7A. The DC-servo motor 8590 or a stepper motor 8591 (not shown) rotates the cross-sectionally-circular shaft 8570 creating axially telescoping motion of the telescoping square-structural tubing 8580 linearly sliding within the cross-sectionally square-tubular-pipe 8510. The pair of accepting channel flanges 85820 accept a pivoting electric generator holder 8585 having pivot arms 8586 in FIG. 10. The pivot arms 8586 rotate with respect to a pivot bolt (not shown) inside pivot bolt holes 8583 and 8588 and the rotational motion of the pivot arms 8586 is fixed at one of the three fixing pin holes 85840~85842 allowing ±90° motions.

Concentrical middle-cylindrical-support 8200 has a pre-fixed number i (e.g. 12) of square holes 8540 for each square hole 8540 containing the distal end of the cross-sectionally square-tubular-pipe 8510 which fixedly supports each of a pre-fixed number i of command following motors for supporting the pre-decided number L of pivoting electric generator holder 8585 and increasing the capacity of the pre-decided number L of cross-sectionally square-tubular-pipes 8510 wherein the pre-fixed number i is a multiple of the pre-decided number L, i.e., i=1 L, 2 L, 3 L, . . . , or an integer number added to the pre-decided number L, i.e., i=L+0, 1, 2, 3, . . . for increasing the capacity greater than the pre-decided number L of command following motors and providing redundant command following motors for later use, and
wherein a reinforcement circular washer-like plate 8560 is fastened using various fasteners or welded on one wall surface of the radial wall surfaces of the concentrical inner-cylindrical-support 8100 and the Concentrical middle-cylindrical-support 8200 increasing the structural stability. The other wall surfaces of the radial wall surfaces of the concentrical inner-cylindrical-support 8100 and the Concentrical middle-cylindrical-support 8200 are open for the purpose of easy accessing and replacing and repairing of the mechanical parts inside the concentrical inner-cylindrical-support 8100 and the Concentrical middle-cylindrical-support 8200.

Concentrical outer-cylindrical-support 8300 has the pre-fixed number i (e.g. 12) of steel fastener brackets (not shown) to fixedly mount the DC-servo motor 8590 or a stepper motor 8591 (not shown) to be fixed on the inner surface of the Concentrical outer-cylindrical-support8300. The steel fastener brackets (not shown) are commercially over the shelf products for the purpose of reducing the manufacturing cost of the GFAMIT system. The opposite distal end of the pivoting electric generator holder 8585 has a first generator coupling hole 85890. Second generator coupling hole 85900 and third generator coupling hole 85910 are in the same second plane but have 180° rotated angular position from the first plane of the first generator coupling hole 85890. The first plane of the first generator coupling hole 85890 is parallel to the second plane of the second coupling hole 85900 and third coupling hole 85910. The middle fixing pin hole 8584 of the three fixing pin holes 8584 formed on the channel-shaped flanges 8589 accommodates and fixes the pivoting electric generator holder 8585 along the centerline 8590 of the channel-shaped flanges 8589. The pivoting electric generator holder 8585 fixed on the middle fixing pin hole 8584 of the three fixing pin holes 8584 fits to the generator mounting holes (not shown and built-in by the manufacturer) of an electric generator among the pre-decided number L of 3-φ electric power generators 8000 in FIG. 7A wherein the generator mounting holes are parallel to the centerline of the mechanical rotation shaft of each of the pre-decided number L of 3-φ electric power generators 8000. The fixing pin hole 8584 on the 90°-rotated-position formed on the channel-shaped flanges 8589 accommodates and fixes the pivoting electric generator holder 8585 rotated 90° from the centerline 8590 of the pivot shaft holes 8583. The pivoting electric generator holder 8585 fixed on the 90°-rotated-position formed on the channel-shaped flanges 8589 fits to generator mounting holes (not shown) of an electric generator among the pre-decided number L of 3-φ electric power generators 8000 in FIG. 7A perpendicular to the centerline of the mechanical rotation shaft of a 3-φ electric power generators 8000. The generator mounting holes (not shown) of each 3-φ electric power generator 8000 of the pre-decided number L (L=1, 2, 3, . . . , a pre-decided number) of 3-φ electric power generators 8000 in FIG. 7A are parallel to the centerlines of mechanical rotation shafts of the pre-decided number L of 3-φ electric power generators 8000, and the fixing pin hole 85841 or 85842 on the 90°-rotated-position formed on the channel-shaped flanges 8589 accommodates and fixes the pivoting electric generator holder 8585 rotated 90° from the centerline 8590 of the channel-shaped flanges 8589, wherein the pivoting electric generator holder 8585 fixed on the 90°-rotated-position formed on the channel-shaped flanges 8589 fits to generator mounting holes (not shown) of the 3-φ electric power generators 8000 in FIG. 7A perpendicular to the centerline of the mechanical rotation shaft of 3-φ electric power generators 8000.

A photovoltaic (PV) panel 88091 or a capacitor bank 88092 is fixed on or around each concentrical outer-cylindrical-support 8300 for providing a DC reactive excitation current to the stator excitation windings of a 3-φ electric power generator 8000 to induce a current in the rotor, wherein the DC current from the PV panel is supplied to the synchronous stator excitation windings which needs the DC reactive excitation current until the rotor current is induced in the rotor electromagnet windings and the extra-DC current from the PV panel is supplied to the output terminal of the electric power interconnection and summing bus 8805 (4), or is supplied to charge a battery bank 8809.

The computer 1000 comprises a group of microprocessors, an aggregation of solid-state hard drives (SSHDs) having writing speed of at least half giga-bites per second, a multicore CPU having at least base clock frequency of 4.4 giga-Hz, at least 10 cores for the purpose of simultaneous multi-threading and vector data communications between the CPU, the aggregation of SSHDs, Field Programmable Gate Arrays (FPGAs), and general-purpose operating system (OS) software running the computer 1000, and running hardware specific FPGA programs or VHDL or Verilog hardware description language programs wherein the hardware specific FPGA programs or VHDL or Verilog hardware description language programs controls the pre-fixed number i of command following motors and each command following motor controls the telescoping feed-depth of each of the pre-fixed number i of telescoping square-structural tubings 8580 holding one of the pre-decided number L of 3-φ electric power generators 8000 at the distal end of each telescoping square-structural tubing 8580 wherein each telescoping square-structural tubing 8580 slides within the cross-sectionally square-tubular-pipe 8510 in order to attach or detach the pulley 8040 of each of the pre-decided number L of 3-φ electric power generators and the telescoping feed-depth is less than 2 inch,
wherein the hardware specific FPGA programs or VHDL or Verilog hardware description language programs control the pre-selected number I of LVDTs of the flywheel and brake block 300 to brake, stop and hold the hollow or solid rotating shaft 1,
wherein the hardware specific FPGA programs or VHDL or Verilog hardware description language programs control or reconfigure the data samplers and dataloggers of a plurality of tachometers to sample the angular velocity signals and, a number M of strain gauges and piezoelectric strain sensors to measure the elongations of the hollow or solid rotating shaft 1 by the centrifugal force and twisting displacements of the hollow or solid rotating shaft 1 by the torque applied to the hollow or solid rotating shaft 1, a plurality of Hall effect type current clamps 88071 to generates the time histories of the AC magnitude, the DC magnitude, the phase, and the waveform of the electric current flowing through the output terminal of the electric power interconnection and summing bus 8805 (4),
wherein hardware specific FPGA programs or VHDL or Verilog hardware description language programs compute the angular velocity error between the reference rotational speed of the hollow or solid rotating shaft 1 and the angular velocity of the hollow or solid rotating shaft 1 measured by the tachometer or encoder and drives the angular velocity error to zero by a closed-loop feedback servo-control system and computes the instantaneous angular positions of the hollow or solid rotating shaft 1 using a software integrator or a hardware integrator,
wherein the hardware specific FPGA programs or VHDL or Verilog hardware description language programs control or reconfigure the data samplers and data loggers of the rotary torque sensor 505 in FIG. 7A between the output shaft of the torque coupling device 400 and the driving shaft of the gearbox device 600 rotating the rubber rim 701 of the driving wheel 7000 wherein the rubber rim 701 of the driving wheel 7000 drives the pulleys 8040 of the pre-decided number L of 3-φ electric power generators 8000 to measure the shaft torque,
wherein the hardware specific FPGA programs or VHDL or Verilog hardware description language programs control the pre-fixed number i command following motors for the pre-decided number L of 3-φ electric power generators to be attached or detached from the rubber rim 701 of the driving wheel 7000 and compute each rotating shaft strain error between the allowable elongations threshold strain value and allowable twisting displacements threshold strain value and the measured strains by each strain gauge and piezoelectric strain sensor and keeps the elongations and twisting displacements strain (created by the centrifugal force induced by the angular velocity of the hollow or solid rotating shaft 1) less than the allowable elongations threshold strain value and allowable twisting displacements threshold strain value,
wherein the hardware specific FPGA programs or VHDL or Verilog hardware description language programs computes the angular velocity error between the reference rotational speed of the hollow or solid rotating shaft 1 and the angular velocity of the hollow or solid rotating shaft 1 measured by the tachometer or computed using encoder output, receives the output signal measured by the rotary torque sensor 505, and divides the measured shaft torque magnitude from the rotary torque sensor 505 by a single torque magnitude rotating only a single 3-φ electric power generator 8000 driven by the rubber rim 701 of the driving wheel 7000 in order to determine the necessary number of the subset of the pulley 8040 of the pre-decided number L of 3-φ electric power generators 8000 to be attached or detached from the rubber rim 701 of the driving wheel 7000 and selects the members of the subset of the pulley 8040 of the pre-decided number L of 3-φ electric power generators 8000,
wherein the group of microprocessors do parallel processing of running the general-purpose operating system (OS) software of the computer 1000 and the digitized C3I data-traffic-volume between the CPU, SSHDs, and data samplers sampling the output signals produced by at least a plurality of tachometers and encoders, the number M of strain gauges and piezoelectric strain sensors, a plurality of Hall effect type current clamps 8807 measuring the generated electric current flow through the output terminal of the electric power interconnection and summing bus 8805 (4), the pre-selected number I of LVDTs 44, a plurality of solenoid switches, the pre-fixed number i of command following motors, the pair of accelerometers fixed on the vertical surface of the left and right ends of the horizontal column 21, the three pairs of accelerometers fixed on the top surfaces of the horizontal frames 21, 22-28, and running hardware specific FPGA programs or computer programs,
wherein the aggregation of solid-state hard drives (SSHDs) have writing speed of digital output signal data from data samplers sampling the output signals produced by at least a plurality of tachometers and encoders, at least the number M of strain gauges and piezoelectric strain sensors, a plurality of Hall effect type current clamps 8807 measuring the generated electric current flow from the pre-decided number L of 3-φ electric power generators, the pre-selected number I of LVDTs 44 and a plurality of solenoid switches, and the pre-fixed number i of command following motors,
wherein the pair of accelerometers fixed on the vertical surface of the left and right ends of the horizontal column 21 measure the magnitudes of the centrifugal force vector F and a data sampler samples the output signals of the pair of accelerometers with a sampling frequence twice higher than the frequency of the output signals of the pair of accelerometers, and the sampled accelerometer output data requires a Chebyshev filter Type I or Type II having at least 8^{th} order, Butterworth filter, elliptic filter, or Savitzky-Golay filter to display and read a smoothed data by reducing or washing out the contaminating high frequency noises in the sampled data set and reading the smoothed and most probable data without the noises;
wherein the three pairs of accelerometers are fixed on the top surfaces of the horizontal frames 21, 22-28 and all sampled accelerometer output data require a Chebyshev filter Type I or Type II having at least 8^{th} order, Butterworth filter, elliptic filter, or Savitzky-Golay filter to display and read a smoothed data by reducing or washing out the contaminating high frequency noises in the sampled data set and read the smoothed and most probable data without the high frequency noises, wherein one pair of accelerometers fixed on the top surface of the middle-horizontal frame 23 measures the vertical vibrations of the horizontal frame 23 shaken by the hollow or solid rotating shaft 1 and related parts, wherein the rest two pairs of accelerometers fixed on the top surfaces of the horizontal frames 22 and 24 measure the vertical accelerations of the horizontal frames 22 and 24 with respect to the horizontal frame 23, wherein the smoothed output signals from the two pairs of accelerometers fixed on the top surfaces of the horizontal frames 22 and 24 are time-integrated twice to compute the probable vertical distance-magnitude of the vibration. The probable vertical distance-magnitude of the vibration is divided by half of the horizontal distance between the horizontal beams 22 and 24 resulting in the tangent value of the angular vibration, wherein taking inverse tangent and converting the radian to angular degree, the angular vibration of the supporting horizontal frames 21, 22-28 with respect to the longitudinal axis of the frame 21 is computed,
wherein the hardware specific FPGA programs or computer programs control the pre-fixed number i of command following motors using the shaft torque output signal from the rotary torque sensor located between the output shaft of the torque coupling device 400 and the driving shaft of the gearbox device 600 wherein the driving shaft rotates the driving wheel 7000 having the rubber rim 701 wherein the rubber rim 701 of the driving wheel 7000 drives the pulleys 8040 of the pre-decided number L of 3-φ electric power generators 8000,
wherein the hardware specific FPGA programs or computer programs computes the elongations and twisting displacements strain errors of the hollow or solid rotating shaft 1 between the allowable elongations threshold strain value and allowable twisting displacements threshold strain value and the measured elongations strain by the strain gauges and the measured twisting displacements strain sensors and a closed-loop feedback servo-controller keeps the rotating shaft strain, created by the centrifugal force induced by the angular velocity of the hollow or solid rotating shaft 1, less than the allowable elongations threshold strain value and allowable twisting displacements threshold strain value,
wherein the closed-loop feedback servo-controller computes the angular velocity error between the reference rotational speed of the hollow or solid rotating shaft 1 and the measured angular velocity of the hollow or solid rotating shaft 1 measured by the tachometer or computed using encoder output and drives the angular velocity error to zero, and the hardware specific FPGA programs or computer programs determines the necessary number of the subset of the pulley 8040 of the pre-decided number L of 3-φ electric power generators 8000 to be attached or detached from the rubber rim 701 of the driving wheel 7000.

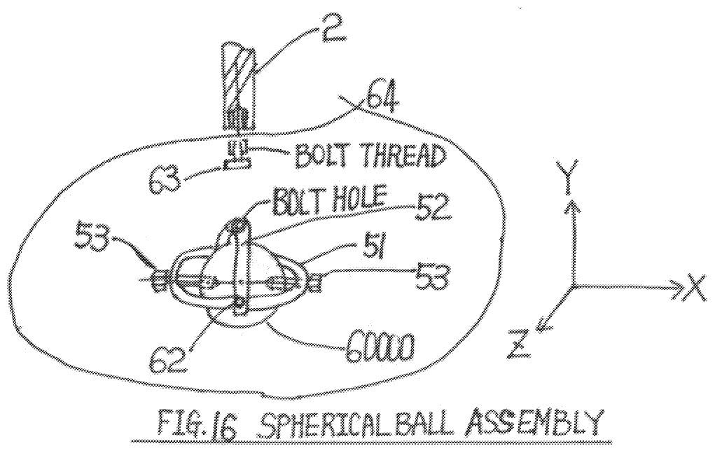

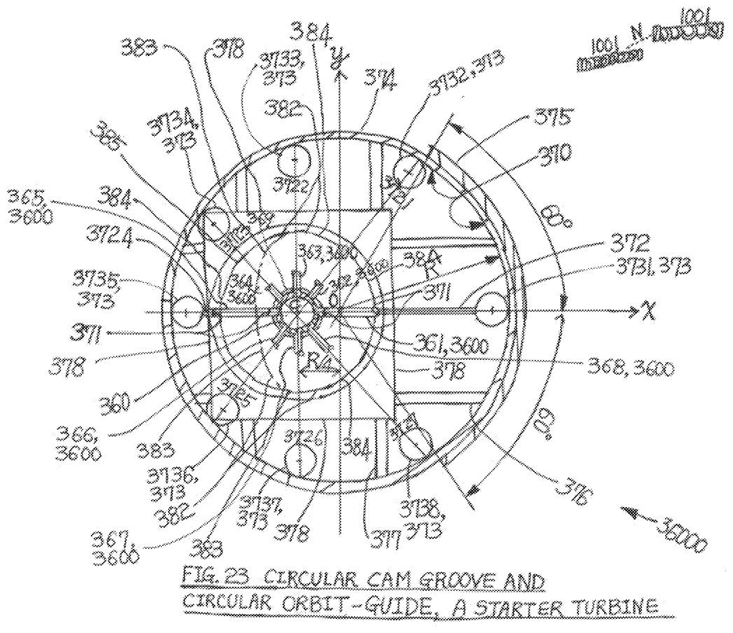

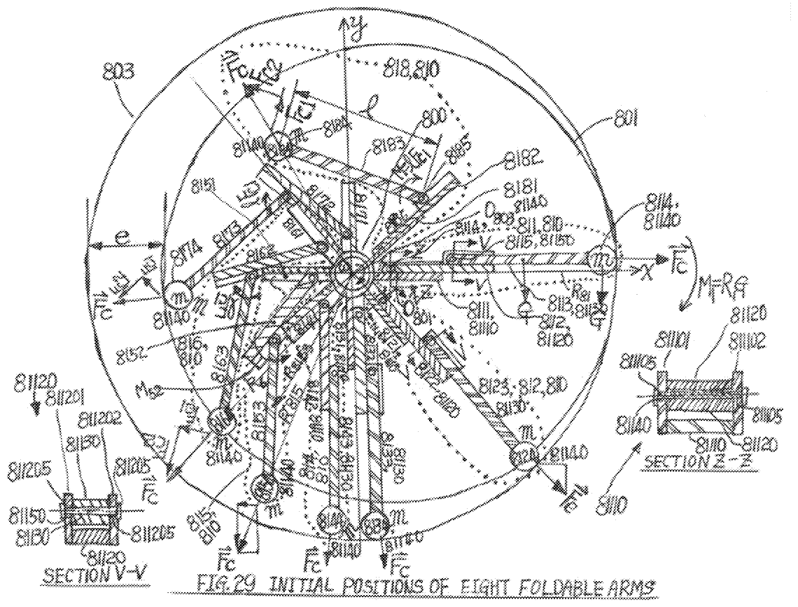

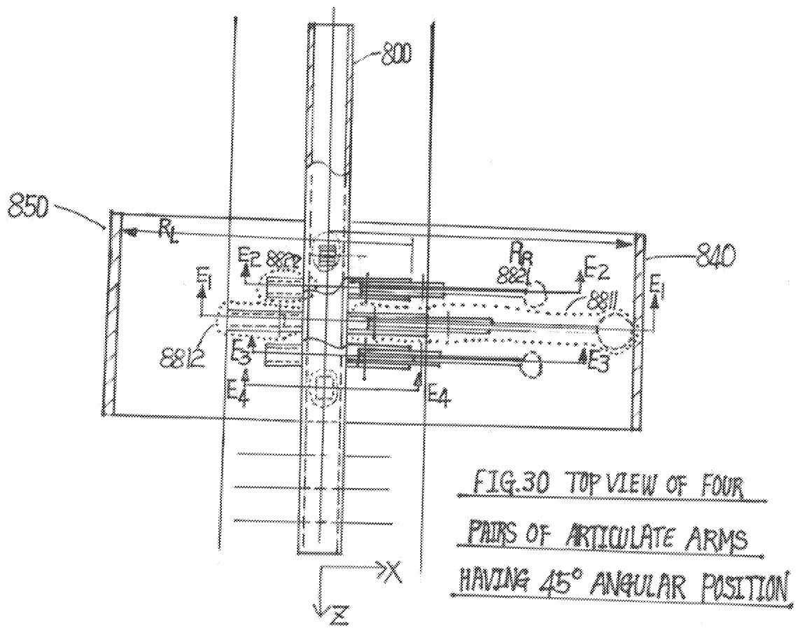

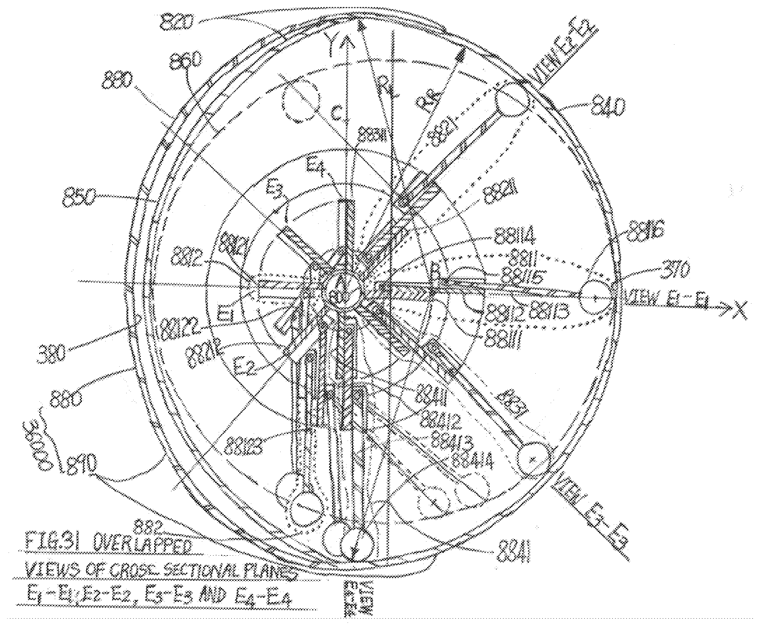

A starter turbine 36000 in FIG. 23 for starting to rotate the GFAMIT without attaching the pre-decided number L of 3-φ electric power generators 8000 to the fixed number K driving wheels 7000 comprises an integrated semi-circular and elliptical hollow-orbit-guide 890 in FIG. 31 or a circular orbit-guide 374 in FIG. 23 wherein the integrated semi-circular and elliptical hollow-orbit-guide 890 in FIG. 31 consists of a semi-circular hollow-orbit-guide 840 and a semi-elliptical hollow-orbit-guide 880 and welded together wherein the rotational center of the hollow cylindrical shaft 800 in FIGS. 29-31 is located at the middle point between the two focal points C and D of the semi-elliptical hollow-orbit-guide 880 and the rotation center of the hollow cylindrical shaft 800 is simultaneously at the middle of the vertical diameter of the semi-circular hollow-orbit-guide 840 wherein a circular orbit-groove 370 in FIG. 23 is also formed on the inner surface of the semi-circular hollow-orbit-guide 840 in FIG. 30 for helping orbital motions of a rubber coated steel sphere 373 among a limited number N of rubber coated steel spheres 373 in FIG. 23 wherein the structure of the rubber coated steel sphere 373 is in detail same as a spherical ball assembly 64 in FIG. 16 and a semi-elliptical orbit-groove 380 is also formed on the inner surface of the semi-elliptical hollow-orbit-guide 880, or wherein the circular orbit-guide 374 in FIG. 23 has a circular orbit-groove 370 and a hollow or solid rotating shaft 360 wherein the rotational center C of the hollow or solid rotating shaft 360 is eccentrically located at, one quarter (¼) of the radius of the circular orbit-guide 8 from the center O of the circular orbit-guide 8.

The rotation arm of the rubber coated steel sphere 373 is longer than the rotation arm of a heavy rolling wheel 6 or a spherical steel sphere 60000.

The hollow cylindrical shaft 800 and the hollow or solid rotating shaft 360 has a limited number N (N=1, 2, 3, . . . , a limited number, eight cylindrically hollow arms 361, . . . , 368 as shown in FIG. 23) of fixed cylindrical arms 3600 in FIG. 23. Each fixed cylindrical arm of the limited number N of fixed cylindrical arms 3600 contains each of the limited number of inner telescoping cylinders 372 doing a linear telescoping motion inside each of the limited number N of fixed cylindrical arms 3600 resulting in variable twisting-moment-arms and variable rotational moment of inertia to rotate the hollow or solid rotating shaft 360. Each proximal end of the limited number of inner telescoping cylinders 372 has a stopper stud 385 keeping each proximal end of the limited number of inner telescoping cylinders 372 within the limited number N of fixed cylindrical arms 3600 in the case of fully stretched states at the 3 O'clock position and the stem of the stopper stud 385 doing sliding motion inside the elongated slot 371 formed on the fixed cylindrical arms 3600.

A circular and elliptical cam-follower groove 382 is formed inside the pair of steel plates 378 wherein the circular and elliptical cam-follower groove 382 consists of a circular cam-follower groove 384 in the right half plane and an elliptical cam-follower groove 383 in the left half plane, wherein each inner telescoping cylinder 372 of a limited number N of inner telescoping cylinders 372 is inserted into each cylindrically hollow arm of the limited number N of cylindrically hollow arms 3600 and the stem of a stopper stud 385 connects the cylindrically hollow arms 361, . . . , 368, elongated slot 371 and the inner telescoping cylinder 372, i.e., 3721~3727 individually (omitted for the clarity of the drawing) in FIG. 23 and the head of the stopper stud 385 inserted into and follows the circular and elliptical cam-follower groove 382.

Each distal end of the limited number of inner telescoping cylinders 372 has a rubber coated steel sphere 373 among a limited number N of rubber coated steel spheres 373 (collectively nominal, in detail, 3731~3738 in FIG. 23) wherein the structure of the rubber coated steel sphere 373 is in detail same as a spherical ball assembly 64 in FIG. 16.

Each arm length of the limited number N of fixed cylindrical arms 3600 is a design parameter, for example, a fraction (for example, one half) of the radius of the circular orbit-guide 374 so that the ratio of the twisting-moment-arm of the center of the steel sphere 3731 on the positive x-axis divided by the twisting-moment-arm of the center of the steel sphere 3735 on the negative x-axis in FIG. 23, is (5/4)/(3/4)=5/3=(1+2/3), that is, the twist moment of the steel sphere 3731 on the positive x-axis is 1.667 times bigger than the twist moment of the steel sphere 3735 on the negative x-axis. Because the twist moment of the steel sphere 3731 on the positive x-axis is (1+2/3) times is bigger than the twist moment of the steel sphere 3735 on the negative x-axis, the total summation of the twist moments of the steel spheres 3731~3738 initiates the rotational motions of the steel spheres when the pre-selected number I pairs of braking shoes 41 and the pre-determined number j of anchor arms 57 are simultaneously released by the computer 1000.

The limited number N of cylindrically hollow arms 3600 are welded on the hollow or solid rotating shaft 360 and an elongated slot 371 of a plurality of elongated slots 371 is formed on each fixed cylindrical of the limited number N of cylindrically hollow arms 3600 for the stopper stud to be restricted within the elongated slot 371 and slide within the elongated slot 371 and simultaneously reduce the viscous resistance force of the telescoping motions of the inner telescoping cylinders 372 within the limited number N of cylindrically hollow arms 3600 and the end of each fixed cylindrical arm makes a circular trajectory 384, wherein the limited number N of cylindrically hollow arms 3600 are welded along a circular circumference on the hollow or solid rotating shaft 360 making the circular trajectory 384 or along a spiral circumference on the hollow or solid rotating shaft 360 and the limited number N of cylindrically hollow arms 3600 making the limited number N of circular trajectories 384.

Each fixed cylindrical of the limited number N of cylindrically hollow arms 3600 contains one of the limited number N of compression springs 1001. Each spring force of the limited number N of compression spring is 2~3 times bigger than the viscous resistance force between each outer surface of the telescoping arms 372 and each inner surface of the limited number N of cylindrically hollow arms 3600. The spring constant and the spring diameter of the compression spring, and the spring wire diameter of the compression spring are design parameters to be chosen. The length of the compression spring 1001 partially or fully fills the empty space of each cylindrically hollow arm of the limited number N of cylindrically hollow arms 3600 when each inner telescoping cylinder 372 of the Inner telescoping cylinders 372 is inserted into each cylindrically hollow arm of the limited number N of cylindrically hollow arms 3600 to help the inner telescoping cylinders 372 radially stretched within the end of each cylindrically hollow arm 3600 but limited inside the circular orbit-guide 8 by the spring force and the length of the compression spring 1001 is fully compressed at the 9 O'clock position.

A pair of strain gauge and piezoelectric sensor is fixed along the same circumferential circle at the middle point of the rotational axis of the hollow or solid rotating shaft 360 of the starter turbine sensing the time histories of the elongations of the hollow or solid rotating shaft 360 by the centrifugal force creating the bending moments at both ends of the hollow or solid rotating shaft 360 and sensing the twisting displacements of the hollow or solid rotating shaft 1 by the torque applied to the hollow or solid rotating shaft 1. Both centers of the pair of strain gauge and piezoelectric strain sensor are fixed along the circumferential circle at the middle length position of the hollow or solid rotating shaft 360but the axial sensing direction of the strain gauge and circumferential sensing direction of the piezoelectric strain sensor are perpendicular, the strain gauge fixed along the circumferential circle on the outer surface of the hollow or solid rotating shaft 360 measures the elongations of the hollow or solid rotating shaft 360 by the centrifugal force and the piezoelectric strain sensor along the circumferential circle measures the twisting displacements of the hollow or solid rotating shaft 360 at the middle length position of the hollow or solid rotating shaft 360 by the twisting torque applied to the hollow or solid rotating shaft 360, the locations of both strain gauge and piezoelectric strain sensor are at any locations along the circumferential circle at the middle of the rotating shaft 360, both the measured elongations values and twisting displacements fluctuate with respect to time due to the rotational motion of the hollow shaft 1, wherein the measured output signals from the strain gauges and piezoelectric strain sensors are sampled and the sampled strain gauge and piezoelectric strain sensor output data fluctuates very much being contaminated by noises so that it requires a Chebyshev filter Type I or Type II having at least 8^{th} order, Butterworth filter, elliptic filter, or Savitzky-Golay filter to display and read a smoothed data by reducing or washing out the contaminating high frequency noises in the sampled data set and reading the smoothed and most probable data without the noises, a data logger stores the sampled data every time interval, time interval equivalent to twice of the rotational speed {1/(2ω)}, to the SSD drive.

Taking the Fourier transform of the stored measurement signals from the SSD drive for each encoder and tachometer, rotary torque sensor, accelerometers, the strain gauges and piezoelectric strain sensors and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder and tachometer equal to the desired angular velocity, the measured output signals from each rotary torque sensor close to the desired torque, the measured output signals from each accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known (e.g., Katsuhiko Ogata, Bernard Friedland) and are not explained here, and the dynamic system of the GFAMIT system is different and unique from the others.

The hollow or solid rotating shaft 360 of the starter turbine 36000 is coaxially connected to the hollow or solid rotating shaft 1.

A 120° circular orbit-guide reinforcement 375 further supports the circular orbit-guide 374 against the summation of the centrifugal forces induced by the rubber coated steel spheres 373.

A pair of steel plates 378, a circular and elliptical cam-follower groove 382 and a pair of horizontal supporting bars 376 and a pair of vertical supporting bars 377 provide more structural stability.

The proximal end of each slant beam of the plurality of slant beams 20 having a foot 331 has a hinge to rotate and adapt and be fastened to a plurality of related body frames of an engine compartment of a vehicle and the foot 331 at the distal end of the slant beam has a plurality of slotted holes for fasteners to be inserted and fastened.

The horizontal frames 21, 22-28 and vertical frames 29 and 31 and each slant beam of the plurality of slant beams 20 having a foot 331 are fixed with the body frames of the engine compartment of a vehicle.

The resultant centrifugal force vector F induced by the variable or articulate twisting-moment-arms fixed or welded on the hollow or solid rotating shaft 1 is pointed toward the forward direction of the vehicle and the resultant centrifugal force vector F rotates the wheels of the vehicle and contributes to propel the vehicle forward.

The vehicle is an engine-equipped car, electric car, engine-equipped truck, electric truck, train, ship, submarine, aircraft, low orbit communications satellite, or winged spacecraft orbiting an Earth orbit below the geosynchronous orbit.

The 3-φ output power generated by the pre-decided number L of 3-φ electric power generators 8000 is directly supplied to the electric motor of the electric car or electric truck, or the 3-φ output power generated by the pre-decided number L of 3-φ electric power generators 8000 is supplied to the battery packs of the vehicle, wherein the vehicle is an engine-equipped car, electric car, engine-equipped truck, electric truck, train, ship, submarine, aircraft, low orbit communications satellite, or winged spacecraft orbiting an Earth orbit below the geosynchronous orbit.

Alternatively, the concentrical inner-cylindrical-support 8100 is a polygonal hollow-cylinder having a defined number j (j=3, 4, 5, . . . , a defined integer greater than the prior integer) of flat and same-size sidewalls and includes a thin plate and a channel shape of “C” or the upper half of alphabet “E”. Alternatively, the concentrical middle-cylindrical-support 8200 and concentrical outer-cylindrical-support 8300 are also a defined number j (j=3, 4, 5, . . . , a defined integer greater than the prior integer) of flat and same-size sidewalls and includes a thin plate and a channel shape of “C” or the upper half of alphabet “E”.

### Second Embodiment (FIGS. 1-14, 15-16)

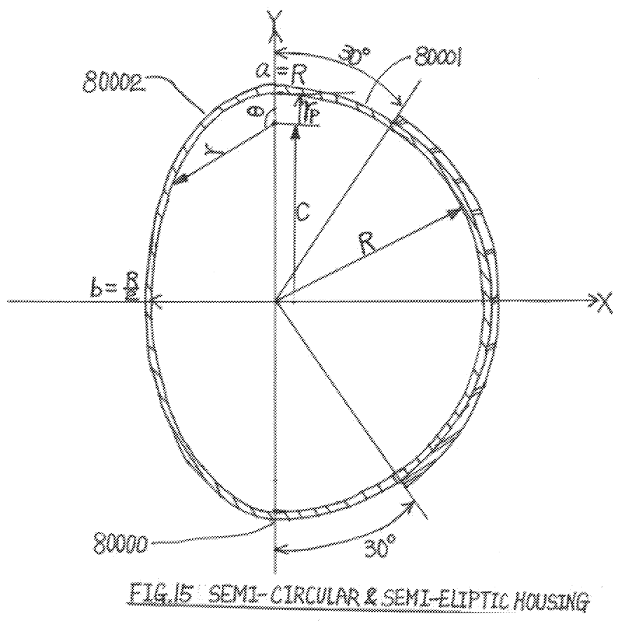

FIG. 15 discloses a composite hollow housing 80000 made of a semi-circular cylindrical housing 80001 and a semi-elliptical housing 80002 and the composite hollow housing 80000 is one of a number M of composite hollow housings 80000. The composite hollow housing 80000 contains the hollow or solid rotating shaft 1 at the center of the diameter of the semi-circular cylindrical housing 80001. The semi-circular cylindrical housing 80001 has a radius R from the center of the semi-circle. The semi-elliptical housing 80002 has the major arm length a, as shown in FIG. 16, the same as the radius R of the semi-elliptical housing 80002. The equation of an ellipse is x²/a²+y²/b²=1, and the eccentricity e of an ellipse is e=sqrt(1−b²/a²)=c/R. Taking the major arm a=R and the minor arm b=R/2, e=sqrt{1−(R/2)²/R²}=sqrt(1−1/4)=sqrt(3/4)=sqrt(3)/2=0.866. The location c of the focus of the ellipse from the x-axis is c=Rₑ={R}{sqrt(3)/2)}=(R)(1.732/2)=0.866 R. The elliptic radius r is same as r={a(1−e²)/(1+ecos θ}}. When θ=0°, r=rₚ={a(1−e²)/(1+ecos(0°))}={a(1−e²)/(1+e)}={a(1−e)}=R(1−0.866)=0.134 R which verifies that c=R−rₚ=R−0.134 R=0.866 R. Keeping the major arm length R fixed and changing the length of the minor arm b to any desired length, the locations of the two focal points of an ellipse is computed to make a semi-elliptic hollow cylinder matching the semi-circular hollow cylinder having the same major arm length as the radius R of the semi-circular hollow cylinder as shown in FIG. 15.

FIG. 16 shows another embodiment of the assembly of the rolling wheel support 5 shown in FIG. 1 providing 4 degrees of freedom (DoF) motion. The rolling wheel support 5, heavy rolling wheel 6 and the rolling wheel shaft bolt 7 in FIG. 1 are replaced with a spherical ball 60000 having two pivoting bolts 53 passing through an inner gimbal 51 and fixed into the spherical ball 60 by the threads at the distal end of each pivoting bolts 53 and the mating female threads in the spherical ball 60 and rotating with respect to the pivoting bolts 53. An outer gimbal 52 is pivotally assembled with the inner gimbal 51 by two pivotal bolts 62 forming 90-degree angular displacement from the two pivoting bolts 53 as shown in FIG. 16. The outer gimbal 52 has a hole for a top threaded bolt 63 so that the spherical ball assembly 64 in FIG. 16 slides along the non-threaded shaft of the top threaded bolt 63 and the outer gimbal 52 rotates with respect to the top thread 63 providing four DoF motions of a linear sliding motion and three rotational motions so that the spherical ball assembly 64 makes total four DoF motion and the top thread 63 is fixed with the rotating link 2 and the heavier the spherical ball assembly is, the greater the inertial twisting moment is generated wherein the composite hollow housing 80000 is axially long enough to house the rotating link 2. The spherical ball 60 does not need to have the elliptical rolling wheel groove 61 in FIG. 1. Because of four DoF rotating motion of the spherical ball assembly 64 within the composite hollow housing 80000, the spherical ball 60 automatically follows a curved path even though the elliptical rolling wheel groove 61 is not provided on the inner surface of the semi-elliptical housing 80002 making the manufacturing process of the composite hollow housing 80000 simpler without forming the curved path on the inner surface of the semi-elliptical housing 80002. The composite hollow housing 80000 is axially long enough to house the rotating link 2 and the spherical ball assembly 64. The rotating link 2 with the spherical ball assembly 64 begins to be folded entering into the semi-elliptical housing 80002 after 180° rotation within the semi-circular cylindrical housing 80001, and the semi-elliptical housing 80002 prohibits the rotating link 2 from being radially stretched from the folded position but helps for the rotating link 2 being axially stretched along axial directions inside the semi-elliptical housing 80002 parallel to the centerline of the composite hollow housing 80000. The limited number N sets of welded arms 13 are welded along a circular circumference on the hollow or solid rotating shaft 1 or along a spiral circumference on the hollow or solid rotating shaft 1.

The centrifugal force is proportional to the arm length and the squared angular velocity ω and creates bending of the hollow or solid rotating shaft 1 of the GFAMIT system. The horizontal components of the centrifugal forces act toward the horizontal axis X of the X-Y plane. To limit the bending and tortional tearing of the hollow or solid rotating shaft 1, a pair of strain gauge and piezoelectric sensor among a predefined number M of strain gauges and piezoelectric strain sensors are fixed along the same circumferential circle at the middle point of the rotational axis of the hollow or solid rotating shaft 1 and outsides of the predefined number M of hollow frustoconical housings 8 sensing the time histories of the elongations of the hollow or solid rotating shaft 1 by the centrifugal force creating the bending moments of the hollow or solid rotating shaft 1 around the hollow housings 8 and sensing the twisting displacements of the hollow or solid rotating shaft 1 by the torque applied to the hollow or solid rotating shaft 1. Both centers of each strain gauge and each piezoelectric strain sensor are fixed along the circumferential circle at the middle length position of the hollow or solid rotating shaft 1but the axial sensing direction of the strain gauge and circumferential sensing direction of the piezoelectric strain sensor are perpendicular. The strain gauge fixed along the circumferential circle on the outer surface of the hollow or solid rotating shaft 1 measures the elongations of the hollow or solid rotating shaft 1 by the centrifugal force and the piezoelectric strain sensor along the circumferential circle measures the twisting displacements of the hollow or solid rotating shaft 1 at the middle length position of the hollow or solid rotating shaft 1 by the twisting torque applied to the hollow or solid rotating shaft 1. The locations of both strain gauge and piezoelectric strain sensor are at any location along the circumferential circle at the middle of the rotating shaft 1. Both the measured elongations values and twisting displacements fluctuate with respect to time due to the rotational motion of the hollow or solid rotating shaft 1. The measured output signals from the strain gauges and piezoelectric strain sensors are sampled and the sampled strain gauge and piezoelectric strain sensor output data fluctuates very much being contaminated by noises so that it requires a Chebyshev filter Type I or Type II having at least 8^{th} order, Butterworth filter, elliptic filter, or Savitzky-Golay filter to display and read a smoothed data by reducing or washing out the contaminating high frequency noises in the sampled data set and reading the smoothed and most probable data without the noises. A data logger stores the sampled data every time interval, the time interval equivalent to twice of the rotational speed {1/(2w)}, to the SSD drive.

Taking the Fourier transform of the stored measurement signals from the SSD drive for each encoder and tachometer, rotary torque sensor, accelerometers, the strain gauges and sensors and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder and tachometer equal to the desired angular velocity, the measured output signals from each rotary torque sensor close to the desired torque, the measured output signals from each accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known (e.g., Katsuhiko Ogata, Bernard Friedland) and are not explained here, and the dynamic system of the GFAMIT system is different and unique from the others.

Unlike a conventional turbine having an initial position of zero-energy-state without any rotational energy, the initial position of the GFAMIT turbine system has a potential energy creating an initial twisting moment which rotates the hollow cylindrical shaft 1, so that a stopper or braking system is needed to keep the GFAMIT turbine system on hold when not in use, and the hollow cylindrical shaft 1 must be in a stopped position applying brake force on the hollow cylindrical shaft 1 at the holding position. The length of the rotating link 2 and the weight of the heavy rolling wheel 6 are design parameters.

A flywheel disk and brake system 300 in FIG. 2 is connected to one end of the hollow or solid rotating shaft 1 to stop the rotation of the hollow or solid rotating shaft 1.

The proximal end of each slant beam of the plurality of slant beams 20 having a foot 331 has a hinge to rotate and adapt and be fastened to a plurality of related body frames of an engine compartment of a vehicle and the foot 331 at the distal end of the slant beam has a plurality of slotted holes for fasteners to be inserted and fastened.

The horizontal frames 21, 22-28 and vertical frames 29 and 31 and each slant beam of the plurality of slant beams 20 having a foot 331 are fixed with the body frames of the engine compartment of a vehicle.

The resultant centrifugal force vector F induced by the variable or articulate twisting-moment-arms fixed or welded on the hollow or solid rotating shaft 1 is pointed toward the forward direction of the vehicle and the resultant centrifugal force vector F rotates the wheels of the vehicle and contributes to propel the vehicle forward.

The vehicle is an engine-equipped car, electric car, engine-equipped truck, electric truck, train, ship, submarine, aircraft, low orbit communications satellite, or winged spacecraft orbiting an Earth orbit below the geosynchronous orbit.

The 3-φ output power generated by the pre-decided number L of 3-φ electric power generators 8000 is directly supplied to the electric motor of the electric car or electric truck, or the 3-φ output power generated by the pre-decided number L of 3-φ electric power generators 8000 is supplied to the battery packs of the vehicle, wherein the vehicle is an engine-equipped car, electric car, engine-equipped truck, electric truck, train, ship, submarine, aircraft, low orbit communications satellite, or winged spacecraft orbiting an Earth orbit below the geosynchronous orbit.

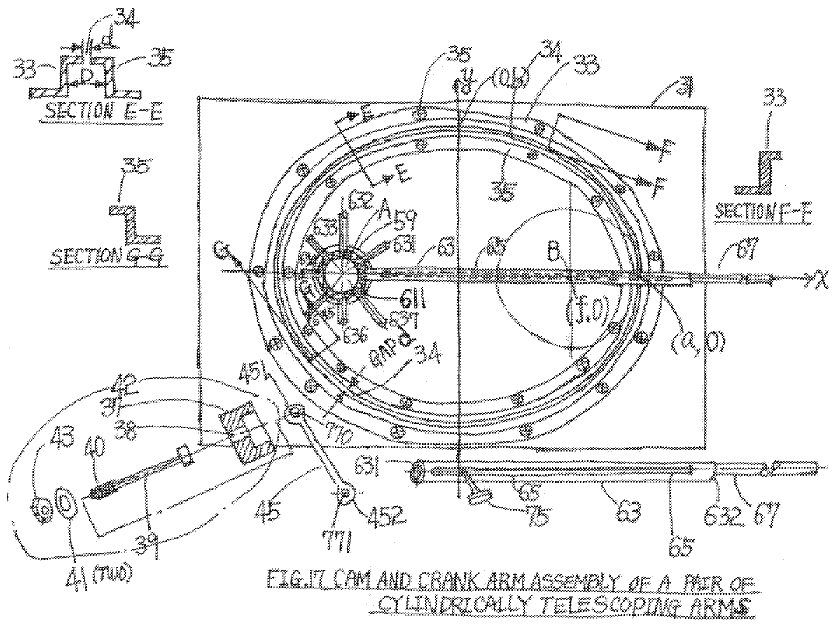

### Third Embodiment (FIGS. 17~20)

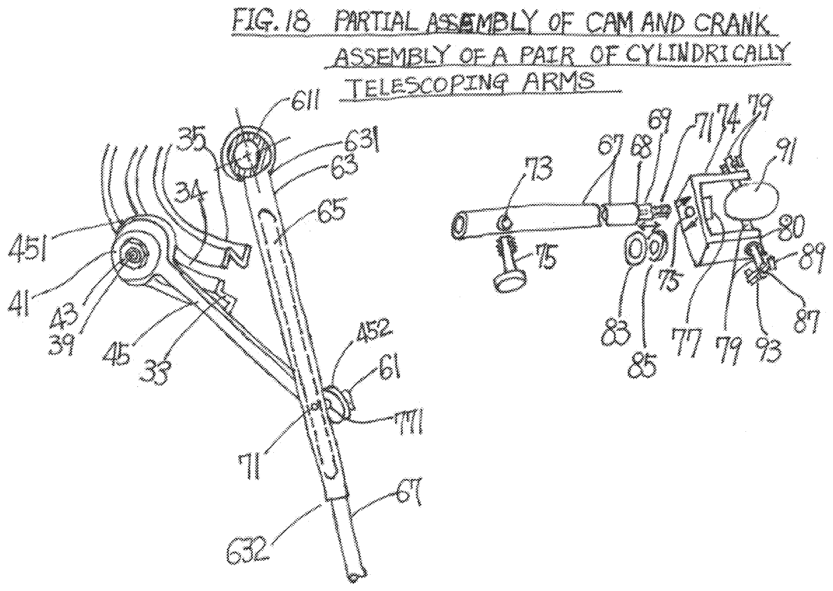

FIG. 17 discloses a view of a cam and crank arm assembly of another different embodiment of a gravity-force applied and moment imbalanced turbine (GFAMIT) driving a pre-decided number L of 3-φ electric power generators 8000. In FIG. 17, a rectangular steel plate 31 has a thickness of 1~10 mm having a shaft hole 59 for a hollow cylindrical shaft 611 rotating with an angular velocity ω inside the shaft hole 59. A limited number N (N=1, 2, 3, . . . , a limited number) sets of fixed cylindrical arms 63 (eight fixed and cylindrically-hollow arms 63, 631, . . . , 637 in FIG. 17) are fixed or welded on the outer surface of the hollow cylindrical shaft 611 close to the end of the hollow cylindrical shaft 611 so that the limited number N of fixed cylindrical arms 63 rotate with the same angular velocity ω inside the shaft hole 59. Each fixed cylindrical arms 63 has an axially slotted hole 65. The limited number N sets of fixed cylindrical arms 63 are welded along a circular circumference on the hollow or solid rotating shaft 611. An outer elliptic orbit-guide 33 is made of a vertically z-cross-sectional angle beam 33 having a cross-section F-F in FIG. 17 bent during a hot forging process or casted forming the outer elliptic orbit-guide 33 and an inner elliptic orbit-guide 35 is made of another vertically z-cross-sectional angle beam 35 having a cross-section E-E bent during a hot forging process or casted forming the inner elliptic orbit-guide 35. An elliptical cam-groove 34 shown in Section E-E having a guide gap d and an inner groove width D in FIG. 17 is formed between the outer elliptic orbit-guide 33 and the inner elliptic orbit-guide 35. The points on the groove centerline of the elliptical cam-groove 34 satisfies the ellipse equation

$$\frac{{x}^{2}}{{a}^{2}} + \frac{{y}^{2}}{{b}^{2}} = 1$$

wherein a is major axis vertex position in the first quadrant of the x-y Cartesian coordinates, b is minor axis vertex position, the mass centroid of the ellipse is the origin of the x-y Cartesian coordinates and focal points (−f, 0) and (f, 0) on the x-y Cartesian coordinates satisfies the equation a²−b²=f² and eccentricity e of the ellipse satisfies e=\sqrt{1−b²/a²}. In FIG. 17, the center of the hollow cylindrical shaft 611 is located on the left focal point (−f) of the elliptical cam-groove 34 in FIG. 17. The outer elliptic orbit-guide 33 is placed on the rectangular steel plate 31 concentrically matching the center of the shaft hole 59 and the left focal point (−f) of the groove centerline of the elliptical cam-groove 34 and is welded on the rectangular steel plate 31. A cam-groove follower shaft 39 is inserted into the cam-follower hole 38 of a cam-groove follower 37 forming a cam-groove follower assembly 42. The cam-groove follower assembly 42 is inserted inside of the outer elliptic orbit-guide 33 and then the cam groove 34 having a gap-width d as shown in FIG. 17 is formed by placing, fixing and welding the inner elliptic orbit-guide 35 on the rectangular steel plate 31. Each inner telescoping cylinder 67 of the Inner telescoping cylinders 67 is inserted into the fixed cylindrical arm 63 and each inner telescoping cylinder 67 has a threaded hole 73 in FIG. 18. After aligning the threaded hole 73, the axially slotted hole 65 in FIGS. 17~18 and a crank arm hole 771 of a crank arm 45, then an end-threaded pivot bolt 75 is inserted into the crank arm hole 771 and is mated into and fastened into threaded hole 73. The axially slotted hole 65 faces the cam groove 34.

As shown in FIG. 17, a headed cam follower shaft 39 has a thread 40 at the distal end, an unthreaded shaft and a shaft head at the opposite and proximal end. The unthreaded shaft supports and holds the cam-groove follower 37 inside the inner groove width D between the outer elliptic orbit-guide 33 and the inner elliptic orbit-guide 35 and the unthreaded shaft slides inside and along the guide gap d of the outer elliptic orbit-guide 33 and the inner elliptic orbit-guide 35. The longitudinal axis of the headed cam follower shaft 39 passing through and holding the cam follower 37 on the unthreaded shaft of the headed cam follower shaft 39 is aligned with the other crank arm hole 770 of the crank arm 45 and the washers 41 and fastened by the nut 43.

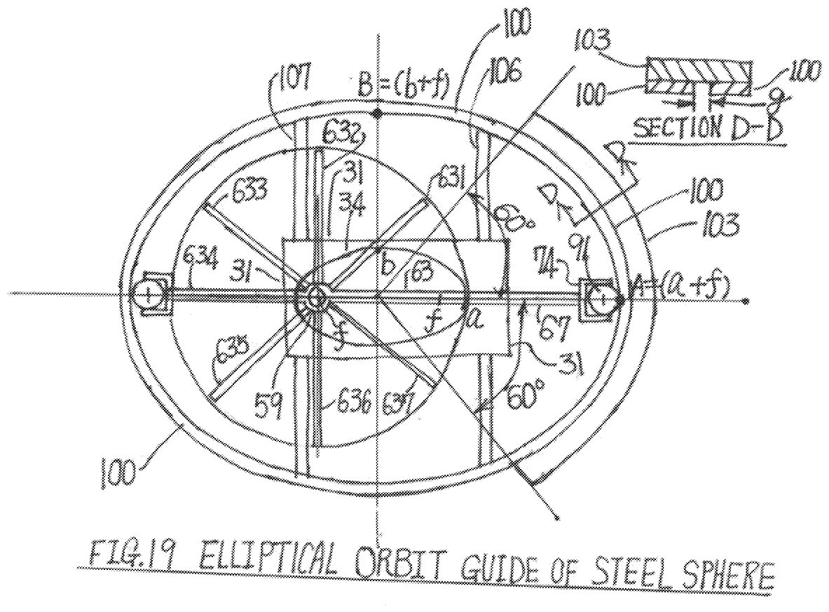

The longitudinal axis of the end-threaded pivot bolt 75 is aligned with the crank arm hole 771 of the crank arm 45, the axially slotted hole 65 on the fixed cylindrical arms 63 and the female thread hole 73 on the inner telescoping cylinder 67 inserted into the fixed cylindrical arms 63. The end-threaded pivot bolt 75 passes through the crank arm hole 771 on the crank arm 45 and mated and fixed with the female thread hole 73 made on the inner telescoping cylinder 67. The end-threaded pivot bolt 75 creates the telescoping motion inside the fixed cylindrical arm 63 and the inner telescoping cylinder 67 extends and shrinks the total arm length of rotation depending on the rotation angle. The distal end of the inner telescoping cylinder 67 has been machined out to provide step 68 and channel cage sliding shaft 69 and male thread 71. Channel cage 74 has a circular hole 75 and the channel cage sliding shaft 69 passes through a washer 83, the circular hole 75, another washer 85 and channel cage nut 77 fixedly assembling the channel cage 74 at the end of the inner telescoping cylinder 67. The length of the crank arm 45 is short and is approximately 2~10 times the diameter of the circular head 451 in FIG. 17. The length of the channel cage sliding shaft 69 is a design parameter considering the manufacturing and machining tolerances of the related mechanical parts providing the linearly sliding motion cushion of the radial motion (by the centrifugal force induced by the rotational angular velocity ω of the inner telescoping cylinder 67 and the steel sphere 91) of the channel cage 74 assembly on the channel cage sliding shaft 69 against the inner surface of an elliptical orbit-guide 100 having two focal points f and −f in FIG. 19 among a number M of elliptical orbit-guides 100 made of the steel sphere 91. Each elliptical orbit-guide 100 is made of a pair of elliptical hollow rings 100 and a thickness and a width of the pair of the elliptical hollow ring 100 are designed satisfying the design requirements and the pair of elliptical hollow rings 100 have a clearance g shown in section D-D of half inch and one inch between each of the pair of elliptical hollow rings 100 as shown in FIG. 19. The steel sphere 91 is coated with rubber material 92 for elliptical orbit traction and quiet operations. The channel cage 74 linearly slides along the channel cage sliding shaft 69 in FIG. 18 and rotates with respect to the channel cage sliding shaft 69 having two DoF motion. Steel sphere 91 having two sphere rotation shafts 79 is assembled with the channel cage 74 and the sphere rotation shafts 79 passes through channel cage holes 80. Holding bolt 89 passes through sphere rotation shaft hole 87 and holding nut 93 is fixed on the holding bolt 89 to keep the sphere rotation shafts 79 integrated with the channel cage 74. FIG. 19 discloses elliptical orbit-guide 100 of the steel sphere 91 in FIG. 19.

As shown in FIGS. 19~20, the inner surface of the elliptical orbit-guide 100 satisfies the equation

$$\frac{{x}^{2}}{{A}^{2}} + \frac{{y}^{2}}{{B}^{2}} = 1$$

wherein A is major axis vertex position in the first quadrant of the x-y Cartesian coordinates and, A=(a+nf) wherein n is a fixed real number greater than zero and is a design parameter, e.g. n=2.0, f is the focal point of the elliptical cam-groove 34 in FIG. 17, B is minor axis vertex position and, B=(b+nf), the center of the ellipse is the origin of the x-y Cartesian coordinates and focal points (−f, 0) and (f, 0) on the x-y Cartesian coordinates satisfies the equation A²−B²=(a²−b²)+2nf (a−b)=F² and eccentricity of the ellipse satisfies e=\sqrt{1−B²/A²}.

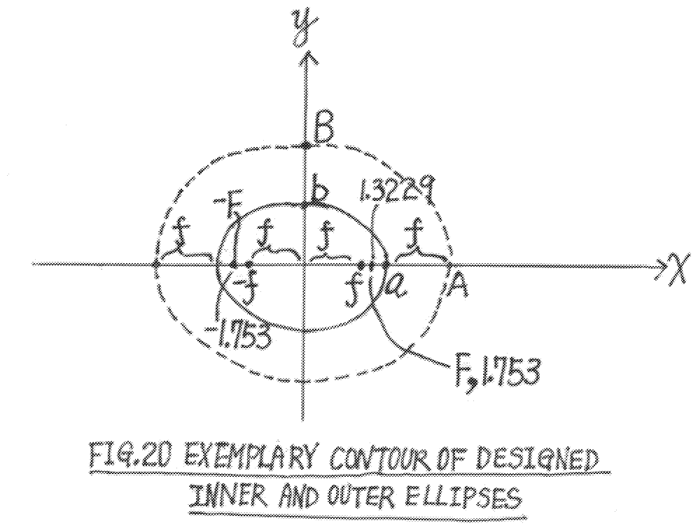

In the case of (a=2, b=1.5, n=2, f=1), F=square root ((a²−b²)+2nf (a−b))=square root (3.0729)=1.753. FIG. 20 discloses the inner ellipse of (a=2, b=1.5, f=1.3229) with a solid line as a cam-groove and the outer ellipse of (A=a+f=2+f, B=b+f=1.5+f, f=1.3229) with a dotted line as an elliptical orbit-guide of the steel sphere 91 and the calculated new focal point of the outer ellipse is F=1.753.

The center of rotation of the hollow cylindrical shaft 611 is to be located between the focal point-f of the elliptical cam-groove 34 and the focal point-F of the elliptical orbit-guide 100. The longitudinal centerline of the hollow cylindrical shaft 611 is located at the left focal point (−f) and the fixed cylindrical arm 63 and the rest of fixed cylindrical arms 631, . . . , 637 are fixed or welded on the hollow cylindrical shaft 611 but the center of the hollow cylindrical shaft 611 can be placed on any point between the left focal point (−f) of the elliptical cam-groove 34 and the left focal point (−F) of the elliptical orbit-guide 100. The rectangular steel plate 31 having the elliptical cam-groove 34 is supported by a left steel plate support-beam 107 and a right steel plate support-beam 106 and welded with the elliptical orbit-guide 100. The inner telescoping cylinder 67 sliding within the fixed cylindrical arm 63 is shown in FIG. 19 and the other seven inner telescoping cylinder 67 longitudinally sliding inside the rest of fixed cylindrical arms 631, . . . , 637 are not shown for the clarity of the drawings in FIG. 19.

The radius differences of the twisting-moment-arms of the inner telescoping cylinder 67 and the steel sphere 91 between the left and right planes inside the elliptical orbit-guide 100 create both of centrifugal force difference toward the direction having the largest twisting-moment-arm and the inertial twisting moment differences between the left and right planes causing continuous rotational motion of the hollow cylindrical shaft 611.

An elliptical reinforcement steel layer 103 is added on the outer surface of the elliptical orbit-guide 100 to withstand the centrifugal force induced by the steel sphere 91.

The hollow cylindrical shaft 611 has the limited number N of fixed cylindrical arm 63 and inner telescoping cylinder 67 to satisfy a required total torque of the pre-decided number L of 3-φ electric power generators 8000 driven by the hollow cylindrical shaft 611 and the length of the hollow cylindrical shaft 611 extends to accommodate the limited number N of fixed cylindrical arm 63 and inner telescoping cylinder 67.

The same supporting frames and beams in FIG. 5 are used in FIG. 19 to withstand the centrifugal force acting on the inner surface of elliptical orbit-guide 100. The slant beams 20, the plurality of feet 331 and the frames 21, 22,28 and 29 in FIG. 5 are installed around the elliptical orbit-guide 100 and the elliptical reinforcement steel layer 103 in FIG. 19. In the case of small torque requirement to turn generators of several KW, the slant beam 20, the plurality of feet 331 and the frames 21, 22,28 and 29 in FIG. 5 may be unnecessary and may not be integrated and the 120-degree elliptical reinforcement steel layer 103 in FIG. 19 may not be needed either. The supporting structures withstanding the total centrifugal forces are the same as the previous embodiments.

The centrifugal force is proportional to the arm length and the squared angular velocity ω and creates bending of the hollow cylindrical shaft 611 of the GFAMIT system. The horizontal components of the centrifugal forces act toward the horizontal axis X of the X-Y plane. To limit the bending and tortional tearing of the hollow cylindrical shaft 611, a pair of strain gauge and piezoelectric sensor among a predefined number M of strain gauges and piezoelectric strain sensors are fixed along the same circumferential circle at the middle point of the rotational axis of the hollow cylindrical shaft 611 and outsides of the predefined number M of hollow frustoconical housings 8 sensing the time histories of the elongations of the hollow cylindrical shaft 611 by the centrifugal force creating the bending moments of the hollow cylindrical shaft 611 around the hollow housings 8 and sensing the twisting displacements of the hollow cylindrical shaft 611 by the torque applied to the hollow cylindrical shaft 611. Both centers of each strain gauge and each piezoelectric strain sensor are fixed along the circumferential circle at the middle length position of the hollow cylindrical shaft 611but the axial sensing direction of the strain gauge and circumferential sensing direction of the piezoelectric strain sensor are perpendicular. The strain gauge fixed along the circumferential circle on the outer surface of the hollow cylindrical shaft 611 measures the elongations of the hollow cylindrical shaft 611 by the centrifugal force and the piezoelectric strain sensor along the circumferential circle measures the twisting displacements of the hollow cylindrical shaft 611 at the middle length position of the hollow cylindrical shaft 611 by the twisting torque applied to the hollow cylindrical shaft 611. The locations of both strain gauge and piezoelectric strain sensor are at any location along the circumferential circle at the middle of the rotating shaft 1. Both the measured elongations values and twisting displacements fluctuate with respect to time due to the rotational motion of the hollow cylindrical shaft 611. The measured output signals from the strain gauges and piezoelectric strain sensors_are sampled and the sampled strain gauge and piezoelectric strain sensor output data fluctuates very much being contaminated by noises so that it requires a Chebyshev filter Type I or Type II having at least 8^{th} order, Butterworth filter, elliptic filter, or Savitzky-Golay filter to display and read a smoothed data by reducing or washing out the contaminating high frequency noises in the sampled data set and reading the smoothed and most probable data without the noises. A data logger stores the sampled data every time interval, the time interval equivalent to twice of the rotational speed {1/(2w)}, to the SSD drive.

Taking the Fourier transform of the stored measurement signals from the SSD drive for each encoder and tachometer, rotary torque sensor, accelerometers, the strain gauges and piezoelectric strain sensors and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder and tachometer equal to the desired angular velocity, the measured output signals from each rotary torque sensor close to the desired torque, the measured output signals from each accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known (e.g., Katsuhiko Ogata, Bernard Friedland) and are not explained here, and the dynamic system of the GFAMIT system is different and unique from the others.

Unlike a conventional turbine having a zero-energy state initial position without any rotational energy, the initial position of the GFAMIT turbine system has a potential energy creating an initial twisting moment which rotates the hollow cylindrical shaft 611. Therefore, a stopper or braking system is needed to keep the GFAMIT turbine system on hold when not in use. The hollow cylindrical shaft 611 must be in a stopped position applying brake force on the hollow cylindrical shaft 611. The length of the rotating link 2 and the weight of the steel sphere 91 are design parameters.

A flywheel disk and brake system 300 in FIG. 2 is connected to one end of the hollow cylindrical shaft 611 to stop the rotation of the hollow cylindrical shaft 611.

The proximal end of each slant beam of the plurality of slant beams 20 having a foot 331 has a hinge to rotate and adapt and be fastened to a plurality of related body frames of an engine compartment of a vehicle and the foot 331 at the distal end of the slant beam has a plurality of slotted holes for fasteners to be inserted and fastened.

The horizontal frames 21, 22-28 and vertical frames 29 and 31 and each slant beam of the plurality of slant beams 20 having a foot 331 are fixed with the body frames of the engine compartment of a vehicle.

The resultant centrifugal force vector F induced by the variable or articulate twisting-moment-arms fixed or welded on the hollow or solid rotating shaft 1 is pointed toward the forward direction of the vehicle and the resultant centrifugal force vector F rotates the wheels of the vehicle and contributes to propel the vehicle forward.

The vehicle is an engine-equipped car, electric car, engine-equipped truck, electric truck, train, ship, submarine, aircraft, low orbit communications satellite, or winged spacecraft orbiting an Earth orbit below the geosynchronous orbit.

The 3-φ output power generated by the pre-decided number L of 3-d electric power generators 8000 is directly supplied to the electric motor of the electric car or electric truck, or the 3-φ output power generated by the pre-decided number L of 3-φ electric power generators 8000 is supplied to the battery packs of the vehicle, wherein the vehicle is an engine-equipped car, electric car, engine-equipped truck, electric truck, train, ship, submarine, aircraft, low orbit communications satellite, or winged spacecraft orbiting an Earth orbit below the geosynchronous orbit.

### Fourth Embodiment (FIGS. 19, 1-14, 17~18, 20~22)

The fourth embodiment is the same as the third embodiment except that the crank arm 45 in the third embodiment is not used by changing the structure of the linkage structure and the outer elliptic orbit-guide 33 and the inner elliptic orbit-guide 35 are replaced with a first thick steel plate 760 and a second thick steel plate 770. In FIG. 17, a rectangular steel plate 31 has a thickness of 1~10 mm having a shaft hole 59 for a hollow cylindrical shaft 611 rotating with an angular velocity ω inside the shaft hole 59 to rotate a pre-decided number L of 3-φ electric power generators.

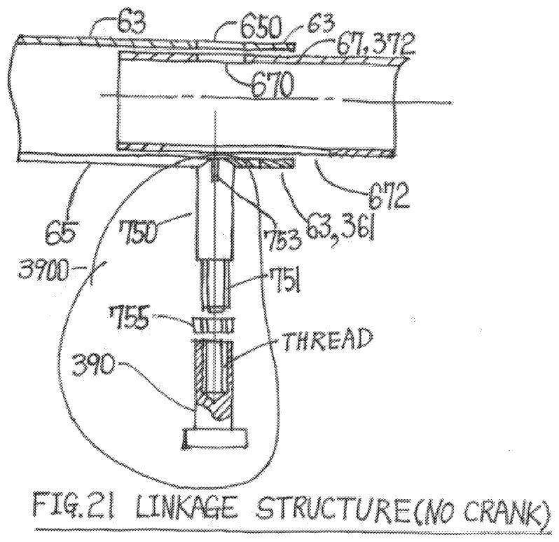

In FIG. 21, the headed cam follower shaft 39 is replaced by a cam follower shaft assembly 3900 having a female-threaded cam follower shaft 390 passing through the cam-groove follower 37 in FIG. 17. The threaded pivot bolt 75 is replaced by an inner cylinder telescoping pin 750 in FIG. 21 having a straight driver hole 753, a male threaded end 751, and a female nut 755. The female nut 755 provides stronger fixing force between the inner cylinder telescoping pin 750 and the female-threaded cam follower shaft 390.

An inner assembly hole 670 on the inner telescoping cylinder 67 and an outer assembly hole 650 on the fixed cylindrical arm 63 are aligned to access a straight slot 753 on the head of the inner cylinder telescoping pin 750 so that the inner cylinder telescoping pin 750 is rotated and tightened by a straight screwdriver to fixedly connect the inner cylinder telescoping pin 750 and the female-threaded cam follower shaft 390. The elongated slot 672 on the inner telescoping cylinder 67 provides assembling tolerance when they are assembled. The axially slotted hole 65 provides the telescoping motion of the inner telescoping cylinder 67 inside the fixed cylindrical arm 63.

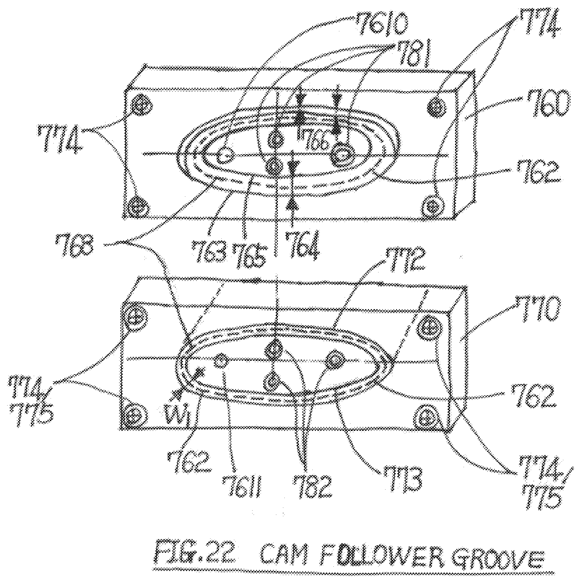

FIG. 22 discloses the dashed common centerline 762 of an elliptical cam-follower groove 768 having a wider cam-groove width 764 (than a groove width W1 on the second thick steel plate 770) with a cam-groove depth 766 forming a rectangular trough on a first thick steel plate 760. On a second thick plate 770, an elliptical through hole 772 (the two dotted lines in FIG. 22 show an elliptical through hole), bigger than the dashed common centerline 762 but smaller than the outer edge line 763 of the elliptical cam-follower groove 768, is formed on the second thick steel plate770 so that the elliptical cam-follower groove 768 houses and holds a cam-groove follower 37 in FIG. 17 inside the rectangular trough. An inner elliptic cam-groove cap 773 is bigger than inner edge 765 of the rectangular trough on the first thick steel plate 760 and has a circular through hole 7610 on the first thick steel plate 760 on the major axis of the inner edge 765. On the second thick steel plate 770, a circular through hole 7611 is made on the major axis of the inner elliptic cam-groove guide 773, wherein the circular through holes 7611 on the second thick steel plate 770 are aligned with the circular through holes 7610 on the first thick steel plate 760 so that the circular through holes 7611 and the circular through hole 7610 are aligned with the shaft hole 59 on the rectangular steel plate 31 in FIG. 17 and contains the hollow cylindrical shaft 611 to be rotated. The three threaded fastening holes 781 and four threaded fastening holes 774 on the first thick steel plate 760 and the three threaded fastening holes 782 on the inner elliptic cam-groove cap 773 and the four threaded fastening holes 775 on the second thick steel plate770 are aligned with the related threaded fastening holes to be fastened by bolts. One of the first and second thick steel plates 760 and 770 is fixed or welded on the rectangular steel plate 31. On the surface of the second thick steel plate 770, the centerline 762 of elliptical cam-follower groove 768 is copied and drawn. The diameter of the female-threaded cam follower shaft 390 is narrower than the elliptical cam-follower groove 768 and slides along the centerline 762. The cam-groove follower 37 and the female-threaded cam follower shaft 390 in FIG. 21 are inserted into the elliptical cam-follower groove 768. The first and second thick steel plates 760 and 770 are fixed with the bolts 775 through the threaded fastening holes 774, 781 and 782. The other mechanical elements not mentioned in the fourth embodiment are the same as the mechanical elements in the third embodiment and the supporting structures withstanding the total centrifugal forces and inertial twisting moments are same as the previous embodiments.

The centrifugal force is proportional to the arm length and the squared angular velocity ω and creates bending of the hollow cylindrical shaft 611 of the GFAMIT system. The horizontal components of the centrifugal forces act toward the horizontal axis X of the X-Y plane. To limit the bending and tortional tearing of the hollow cylindrical shaft 611, a pair of strain gauge and piezoelectric sensor among a predefined number M of strain gauges and piezoelectric strain sensors are fixed along the same circumferential circle at the middle point of the rotational axis of the hollow cylindrical shaft 611 and outsides of the predefined number M of hollow frustoconical housings 8 sensing the time histories of the elongations of the hollow cylindrical shaft 611 by the centrifugal force creating the bending moments of the hollow cylindrical shaft 611 around the hollow housings 8 and sensing the twisting displacements of the hollow cylindrical shaft 611 by the torque applied to the hollow cylindrical shaft 611. Both centers of each strain gauge and each piezoelectric strain sensor are fixed along the circumferential circle at the middle length position of the hollow cylindrical shaft 611but the axial sensing direction of the strain gauge and circumferential sensing direction of the piezoelectric strain sensor are perpendicular. The strain gauge fixed along the circumferential circle on the outer surface of the hollow cylindrical shaft 611 measures the elongations of the hollow cylindrical shaft 611 by the centrifugal force and the piezoelectric strain sensor along the circumferential circle measures the twisting displacements of the hollow cylindrical shaft 611 at the middle length position of the hollow cylindrical shaft 611 by the twisting torque applied to the hollow cylindrical shaft 611. The locations of both strain gauge and piezoelectric strain sensor are at any location along the circumferential circle at the middle of the rotating shaft 1. Both the measured elongations values and twisting displacements fluctuate with respect to time due to the rotational motion of the hollow cylindrical shaft 611. The measured output signals from the strain gauges and piezoelectric strain sensors are sampled and the sampled strain gauge and piezoelectric strain sensor output data fluctuates very much being contaminated by noises so that it requires a Chebyshev filter Type I or Type II having at least 8^{th} order, Butterworth filter, elliptic filter, or Savitzky-Golay filter to display and read a smoothed data by reducing or washing out the contaminating high frequency noises in the sampled data set and reading the smoothed and most probable data without the noises. A data logger stores the sampled data every time interval, the time interval equivalent to twice of the rotational speed {1/(2ω)}, to the SSD drive.

Taking the Fourier transform of the stored measurement signals from the SSD drive for each encoder and tachometer, rotary torque sensor, accelerometers, the strain gauges and piezoelectric strain sensors and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder and tachometer equal to the desired angular velocity, the measured output signals from each rotary torque sensor close to the desired torque, the measured output signals from each accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known (e.g., Katsuhiko Ogata, Bernard Friedland) and are not explained here, and the dynamic system of the GFAMIT system is different and unique from the others.

Unlike a conventional turbine having a zero-energy state initial position without any rotational energy, the initial position of the GFAMIT turbine system has a potential energy creating an initial twisting moment which rotates the hollow cylindrical shaft 611. Therefore, a stopper or braking system is needed to keep the GFAMIT turbine system on hold when not in use. The hollow cylindrical shaft 611 must be in a stopped position applying brake force on the hollow cylindrical shaft 611. The length of the rotating link 2 and the weight of the steel sphere 91 are design parameters.

A flywheel disk and brake system 300 in FIG. 2 is connected to one end of the hollow cylindrical shaft 611 to stop the rotation of the hollow cylindrical shaft 611.

The proximal end of each slant beam of the plurality of slant beams 20 having a foot 331 has a hinge to rotate and adapt and be fastened to a plurality of related body frames of an engine compartment of a vehicle and the foot 331 at the distal end of the slant beam has a plurality of slotted holes for fasteners to be inserted and fastened.

The horizontal frames 21, 22-28 and vertical frames 29 and 31 and each slant beam of the plurality of slant beams 20 having a foot 331 are fixed with the body frames of the engine compartment of a vehicle.

The resultant centrifugal force vector F induced by the variable or articulate twisting-moment-arms fixed or welded on the hollow or solid rotating shaft 1 is pointed toward the forward direction of the vehicle and the resultant centrifugal force vector F rotates the wheels of the vehicle and contributes to propel the vehicle forward.

The vehicle is an engine-equipped car, electric car, engine-equipped truck, electric truck, train, ship, submarine, aircraft, low orbit communications satellite, or winged spacecraft orbiting an Earth orbit below the geosynchronous orbit.

The 3-φ output power generated by the pre-decided number L of 3-φ electric power generators 8000 is directly supplied to the electric motor of the electric car or electric truck, or the 3-φ output power generated by the pre-decided number L of 3-φ electric power generators 8000 is supplied to the battery packs of the vehicle, wherein the vehicle is an engine-equipped car, electric car, engine-equipped truck, electric truck, train, ship, submarine, aircraft, low orbit communications satellite, or winged spacecraft orbiting an Earth orbit below the geosynchronous orbit.

### Fifth Embodiment (FIGS. 1-14, 23-24)

In the fifth embodiment disclosed in FIG. 23, the elliptical cam-groove and elliptical orbit-guide 100 in the third embodiment is replaced by a circular orbit-guide 374 having a circular orbit-groove 370 and a hollow or solid rotating shaft 360 to rotate a pre-decided number L of 3-φ electric power generators wherein the hollow or solid rotating shaft 360 has a limited number N (N=1, 2, 3, . . . , a limited number, eight cylindrically hollow arms 361, . . . , 368 as shown in FIG. 23) of fixed cylindrical arms 3600 and wherein the circular orbit-guide 374 is one of a number M of circular orbit-guides 374.

The hollow or solid rotating shaft 360 passes through a through hole 369 formed on a pair of steel plates 378 and the limited number N of cylindrically hollow arms 3600 are welded on the hollow or solid rotating shaft 360 and an elongated slot 371 is formed on each fixed cylindrical of the limited number N of cylindrically hollow arms 3600 and the end of each fixed cylindrical arm makes a circular trajectory 384. The limited number N of cylindrically hollow arms 3600 are welded along a circular circumference on the hollow or solid rotating shaft 360 or along a spiral circumference on the hollow or solid rotating shaft 360.

The steel plate 378 is welded on the edge of the circular orbit-guide 374 by a pair of horizontal supporting bars 376 and a pair of vertical supporting bars 377, and a 120° circular orbit-guide reinforcement 375 is welded on the outer surface of the circular orbit-guide 374.

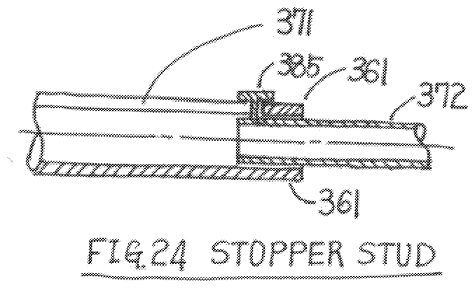

A circular and elliptical cam-follower groove 382 is formed inside the pair of steel plates 378 wherein the circular and elliptical cam-follower groove 370 consists of a circular cam-follower groove 384 in the right half plane and an elliptical cam-follower groove 383 in the left half plane and contains a cam follower 37 in FIG. 17 wherein the linkage structure in FIG. 21, i.e., an inner cylinder telescoping pin 750, a female nut 755, a female-threaded cam follower shaft 390, a rhombus linkage arm 65 (wherein the fixed cylindrical arm 63 is same as the fixed cylindrical arms 361~368 in FIG. 23) connect the cam follower 37 in FIG. 17 and the telescoping arm 67 which is same as inner telescoping cylinder 372, 3721~3727 (omitted for the clarity of the drawing) in FIG. 23. The linkage structure in FIGS. 23-24 comprises Inner telescoping cylinders 372 wherein each inner telescoping cylinder 372 of the Inner telescoping cylinders 372 is inserted into each cylindrically hollow arm of the limited number N of cylindrically hollow arms 3600 and each inner telescoping cylinder 372 has an inner assembly hole 670 and each cylindrically hollow arm of the limited number N of cylindrically hollow arms 3600 has an outer assembly hole 650 in FIG. 21. The outer assembly hole 650 and the inner assembly hole 670 are aligned to access a straight slot 753 on the head of an inner cylinder telescoping pin 750 so that the inner cylinder telescoping pin 750 is rotated and tightened by a straight screwdriver to fixedly connect the inner cylinder telescoping pin 750 and a female-threaded cam follower shaft 390, wherein the diameter of the female-threaded cam follower shaft 390 passes through the cam-groove follower 37, the inner cylinder telescoping pin 750 has the straight driver hole 753, a male threaded end 751, and a female nut 755 wherein the female nut 755 provides stronger fixing force between the inner cylinder telescoping pin 750 and the female-threaded cam follower shaft 390.

Each rubber coated steel sphere 3731~3738 in FIG. 23 is connected to the inner telescoping cylinder 372 with the channel cage 74 in FIGS. 18-19. When the hollow or solid rotating shaft 360 rotates, each rubber coated steel spheres 3731~3738 induces centrifugal forces with respect to the centerline of the hollow or solid rotating shaft 360, rotates the hollow or solid rotating shaft 360 and moves on the inner surface of the circular orbit-guide 374. The circular orbit-guide reinforcement 375 further supports the induced resultant centrifugal forces and simultaneously the supporting frames and the plurality of feet 331 in FIG. 5 provides reaction force to cancel the induced resultant centrifugal forces. In the case of small torque requirement to turn generators of several KW, the slant beam 20, the plurality of feet 331 and the frames 21, 22,28 and 29 in FIG. 5 are unnecessary and are not integrated and the 120-degree circular reinforcement 375 in FIG. 23 is not needed either. The supporting structures withstanding the total centrifugal forces are the same as the previous embodiments.

The centrifugal force is proportional to the arm length and the squared angular velocity ω and creates bending of the hollow cylindrical shaft 360 of the GFAMIT system. The horizontal components of the centrifugal forces act toward the horizontal axis X of the X-Y plane. To limit the bending and tortional tearing of the hollow cylindrical shaft 360, a pair of strain gauge and piezoelectric sensor among a predefined number M of strain gauges and piezoelectric strain sensors are fixed along the same circumferential circle at the middle point of the rotational axis of the hollow cylindrical shaft 360 and outsides of the predefined number M of hollow frustoconical housings 8 sensing the time histories of the elongations of the hollow cylindrical shaft 360 by the centrifugal force creating the bending moments of the hollow cylindrical shaft 360 around the hollow housings 8 and sensing the twisting displacements of the hollow cylindrical shaft 360 by the torque applied to the hollow cylindrical shaft 360. Both centers of each strain gauge and each piezoelectric strain sensor are fixed along the circumferential circle at the middle length position of the hollow cylindrical shaft 360but the axial sensing direction of the strain gauge and circumferential sensing direction of the piezoelectric strain sensor are perpendicular. The strain gauge fixed along the circumferential circle on the outer surface of the hollow cylindrical shaft 360 measures the elongations of the hollow cylindrical shaft 360 by the centrifugal force and the piezoelectric strain sensor along the circumferential circle measures the twisting displacements of the hollow cylindrical shaft 360 at the middle length position of the hollow cylindrical shaft 360 by the twisting torque applied to the hollow cylindrical shaft 360. The locations of both strain gauge and piezoelectric strain sensor are at any location along the circumferential circle at the middle of the rotating shaft 1. Both the measured elongations values and twisting displacements fluctuate with respect to time due to the rotational motion of the hollow cylindrical shaft 360. The measured output signals from the strain gauges and piezoelectric strain sensors are sampled and the sampled strain gauge and piezoelectric strain sensor output data fluctuates very much being contaminated by noises so that it requires a Chebyshev filter Type I or Type II having at least 8^{th} order, Butterworth filter, elliptic filter, or Savitzky-Golay filter to display and read a smoothed data by reducing or washing out the contaminating high frequency noises in the sampled data set and reading the smoothed and most probable data without the noises. A data logger stores the sampled data every time interval, the time interval equivalent to twice the rotational speed {1/(2ω)}, to the SSD drive.

Taking the Fourier transform of the stored measurement signals from the SSD drive for each encoder and tachometer, rotary torque sensor, accelerometers, the strain gauges and piezoelectric strain sensors and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder and tachometer equal to the desired angular velocity, the measured output signals from each rotary torque sensor close to the desired torque, the measured output signals from each accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known (e.g., Katsuhiko Ogata, Bernard Friedland) and are not explained here, and the dynamic system of the GFAMIT system is different and unique from the others.

Unlike a conventional turbine having a zero-energy state initial position without any rotational energy, the initial position of the GFAMIT turbine system has a potential energy creating an initial twisting moment which rotates the hollow cylindrical shaft 360. Therefore, a stopper or braking system is needed to keep the GFAMIT turbine system on hold when not in use. The hollow cylindrical shaft 360 must be in a stopped position applying brake force on the hollow cylindrical shaft 360. The length of the rotating link 2 and the weight of the steel sphere 91 are design parameters.

A flywheel disk and brake system 300 in FIG. 2 is connected to one end of the hollow or solid rotating shaft 360 to stop the rotation of the hollow or solid rotating shaft 360.

The proximal end of each slant beam of the plurality of slant beams 20 having a foot 331 has a hinge to rotate and adapt and be fastened to a plurality of related body frames of an engine compartment of a vehicle and the foot 331 at the distal end of the slant beam has a plurality of slotted holes for fasteners to be inserted and fastened.

The horizontal frames 21, 22-28 and vertical frames 29 and 31 and each slant beam of the plurality of slant beams 20 having a foot 331 are fixed with the body frames of the engine compartment of a vehicle.

The resultant centrifugal force vector F induced by the variable or articulate twisting-moment-arms fixed or welded on the hollow or solid rotating shaft 1 is pointed toward the forward direction of the vehicle and the resultant centrifugal force vector F rotates the wheels of the vehicle and contributes to propel the vehicle forward.

The vehicle is an engine-equipped car, electric car, engine-equipped truck, electric truck, train, ship, submarine, aircraft, low orbit communications satellite, or winged spacecraft orbiting an Earth orbit below the geosynchronous orbit.

The 3-φ output power generated by the pre-decided number L of 3-φ electric power generators 8000 is directly supplied to the electric motor of the electric car or electric truck, or the 3-φ output power generated by the pre-decided number L of 3-φ electric power generators 8000 is supplied to the battery packs of the vehicle, wherein the vehicle is an engine-equipped car, electric car, engine-equipped truck, electric truck, train, ship, submarine, aircraft, low orbit communications satellite, or winged spacecraft orbiting an Earth orbit below the geosynchronous orbit.

### Sixth Embodiment (FIGS. 1-14, 25-26)

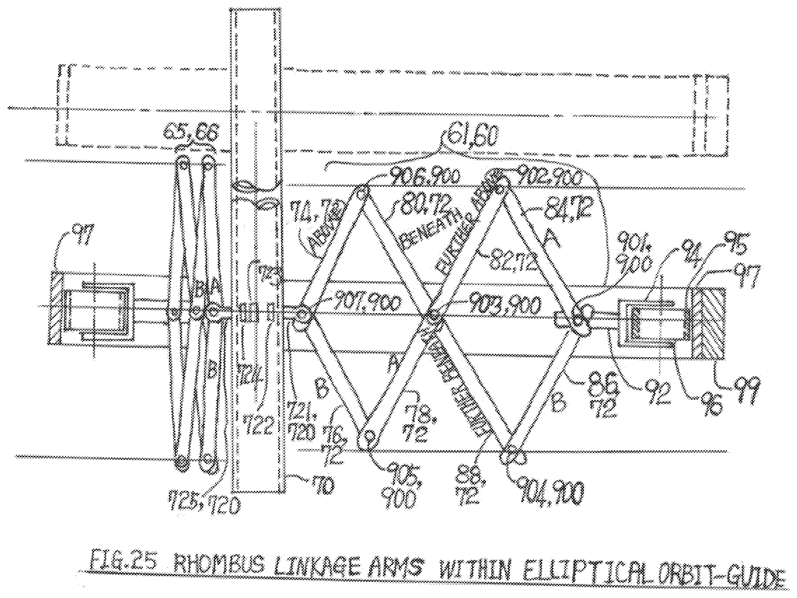

The sixth embodiment in FIG. 25 discloses a limited number of rhombus linkage arm units 60 (collectively 60, eight rhombus linkage arm units, individually, 61, 64, 62~63 and 65~68, not shown in FIG. 25) around a hollow or solid rotating shaft 70 positioned on the left focal point of an elliptical housing 97 which is one of a number M of elliptical housings 97, a steel roller 96 connected to the distal end of the limited number of rhombus linkage arm units 60 and having rubber coating 95 on the steel roller 96 and orbiting the inner surface of the elliptical housing 97 (same as elliptical orbit-guide 100 in FIG. 19). The hollow or solid rotating shaft 70 has the limited number N of welded arms 721 to connect eight (for example) rhombus linkage arm units 61 and 64, 62-63 (not shown) and 65-68 (not shown). Each rhombus linkage arm unit 60 of the limited number N of rhombus linkage arm units 60 comprises a multiples of four of rotating linkages 72 (collectively and nominally 72, individually eight rotating linkages 74, 76, 78, 80, 82, 84, 86, and 88) and a multiples of three plus one of connecting pins 900 (for example, seven (2×3+1) connecting pins 901~907) forming a rhombus linkage 61 of the limited number N of rhombus linkage arm units 60. The limited number N of fixed connecting rods are welded along a circular circumference on the hollow or solid rotating shaft 70 or along a spiral circumference on the hollow or solid rotating shaft 70.

The distal end of the rhombus linkage 61 has a roller connecting rod 92 having a roller channel support 94, rubber coating 95, steel roller 96 orbiting on the inner surface of the elliptic housing 97 and elliptical orbit-guide reinforcement 99 (same as the elliptical reinforcement steel layer 103). When the hollow or solid rotating shaft 70 rotates, the centrifugal force radially stretches the rhombus linkage arms 61~68 toward the inner surface of the elliptic housing 97 and the rhombus linkage arm 61 is fully stretched at the 3 O'clock position and having the maximum inertial twisting moment due to the gravitational force on the steel roller 96 and the rhombus linkage arm 65 is fully folded at the 9 O'clock position and having the maximal and opposite inertial twisting moment at the 9 O'clock position.

The number of units of the rhombus linkage arms 61~68 is determined by the required total external torque of each embodiment of the invention. The same support structure in FIG. 5 is used to withstand the centrifugal forces acting on the inner surface of the elliptic housing 97. However, in the case of small torque requirement to turn generators of several KW, the slant beam 20, the plurality of feet 331 and the frames 21, 22,28 and 29 in FIG. 5 are unnecessary and are not integrated and the 120-degree elliptical reinforcement 103 in FIG. 19 is not needed either.

Without having the elliptical housing 97 and then rotating the hollow or solid rotating shaft 70, as the angular velocity of the hollow or solid rotating shaft 70 increases, the rhombus linkage arms 60 (i.e., 61~68) radially stretches due to the centrifugal forces and at a certain angular velocity, the summation of the counter-inertial twisting moments acting on the rhombus linkage arms 65~68 in the left half side of the hollow or solid rotating shaft 70 become the same as the summation of the inertial twisting moments acting on the rhombus linkage arms 61~64 in the right half plane of the rotation.

Because the rotation center of the hollow or solid rotating shaft 70 is located at the left focal center of the elliptical housing 97, the elliptical housing 97 prohibits the rhombus linkage arms 65~68 in the left half plane fully stretched and creates the inertial twisting moment difference between the rhombus linkage arms 61~64 in the right half side in FIG. 25 and the rhombus linkage arms 65~68 in the left half side in FIG. 25. The hollow or solid rotating shaft 70 has a limited number N (N=1, 2, . . . , limited number) of units of the rhombus linkage arms 61~68 to satisfy a required total torque of the pre-decided number L of 3-φ electric power generators 8000 driven by the hollow or solid rotating shaft 70 and the length of the hollow or solid rotating shaft 70 extends to accommodate the limited number N (N=1, 2, . . . , limited number) of units of the rhombus linkage arms 61~68. The supporting structures withstanding the total centrifugal forces are the same as the previous embodiments.

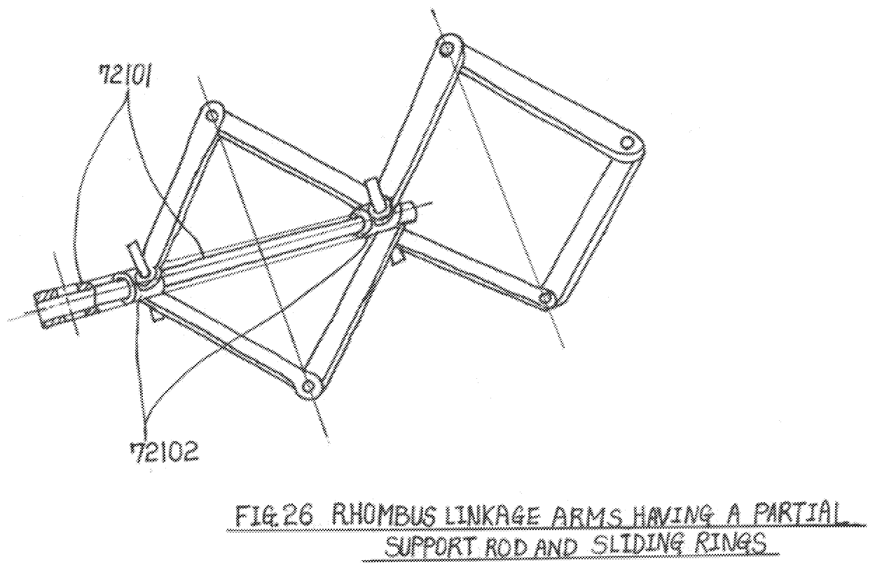

FIG. 26 discloses a rhombus linkage arm having a partial support rod and sliding rings to provide more structural stability of the rhombus linkage arm.

The centrifugal force is proportional to the arm length and the squared angular velocity ω and creates bending of the hollow cylindrical shaft 70 of the GFAMIT system. The horizontal components of the centrifugal forces act toward the horizontal axis X of the X-Y plane. To limit the bending and tortional tearing of the hollow cylindrical shaft 70, a pair of strain gauge and piezoelectric sensor among a predefined number M of strain gauges and piezoelectric strain sensors are fixed along the same circumferential circle at the middle point of the rotational axis of the hollow cylindrical shaft 70 and outsides of the predefined number M of hollow frustoconical housings 8 sensing the time histories of the elongations of the hollow cylindrical shaft 70 by the centrifugal force creating the bending moments of the hollow cylindrical shaft 70 around the hollow housings 8 and sensing the twisting displacements of the hollow cylindrical shaft 70 by the torque applied to the hollow cylindrical shaft 70. Both centers of each strain gauge and each piezoelectric strain sensor are fixed along the circumferential circle at the middle length position of the hollow cylindrical shaft 70but the axial sensing direction of the strain gauge and circumferential sensing direction of the piezoelectric strain sensor are perpendicular. The strain gauge fixed along the circumferential circle on the outer surface of the hollow cylindrical shaft 70 measures the elongations of the hollow cylindrical shaft 70 by the centrifugal force and the piezoelectric strain sensor along the circumferential circle measures the twisting displacements of the hollow cylindrical shaft 70 at the middle length position of the hollow cylindrical shaft 70 by the twisting torque applied to the hollow cylindrical shaft 70. The locations of both strain gauge and piezoelectric strain sensor are at any location along the circumferential circle at the middle of the rotating shaft 1. Both the measured elongations values and twisting displacements fluctuate with respect to time due to the rotational motion of the hollow cylindrical shaft 70. The measured output signals from the strain gauges and piezoelectric strain sensors are sampled and the sampled strain gauge and piezoelectric strain sensor output data fluctuates very much being contaminated by noises so that it requires a Chebyshev filter Type I or Type II having at least 8^{th} order, Butterworth filter, elliptic filter, or Savitzky-Golay filter to display and read a smoothed data by reducing or washing out the contaminating high frequency noises in the sampled data set and reading the smoothed and most probable data without the noises. A data logger stores the sampled data every time interval, the time interval equivalent to twice of the rotational speed {1/(2ω)}, to the SSD drive.

Taking the Fourier transform of the stored measurement signals from the SSD drive for each encoder and tachometer, rotary torque sensor, accelerometers, the strain gauges and piezoelectric strain sensors_and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder and tachometer equal to the desired angular velocity, the measured output signals from each rotary torque sensor close to the desired torque, the measured output signals from each accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known (e.g., Katsuhiko Ogata, Bernard Friedland) and are not explained here, and the dynamic system of the GFAMIT system is different and unique from the others.

Each fixed connecting rod 720 in FIG. 25 optionally has a partial rhombus linkage arm support 72101 in FIG. 26 and a pair of rhombus linkage arm sliding rings 72102.

Unlike a conventional windmill turbine having a zero-energy state initial position without any rotational energy, the initial position of the GFAMIT turbine system has an initial twisting moment rotating the hollow or solid rotating shaft 70. Therefore, a stopper or braking system is needed to keep the GFAMIT turbine system on hold when not in use. The hollow or solid rotating shaft 70 must be in a stopped position applying brake force on the hollow or solid rotating shaft 70. The length of the rotating link 2 and the weight of the steel sphere 91 are design parameters.

A flywheel disk and brake system 300 in FIG. 2 is connected to one end of the hollow or solid rotating shaft 70 to stop the rotation of the hollow or solid rotating shaft 70.

The proximal end of each slant beam of the plurality of slant beams 20 having a foot 331 has a hinge to rotate and adapt and be fastened to a plurality of related body frames of an engine compartment of a vehicle and the foot 331 at the distal end of the slant beam has a plurality of slotted holes for fasteners to be inserted and fastened.

The horizontal frames 21, 22-28 and vertical frames 29 and 31 and each slant beam of the plurality of slant beams 20 having a foot 331 are fixed with the body frames of the engine compartment of a vehicle.

The resultant centrifugal force vector F induced by the variable or articulate twisting-moment-arms fixed or welded on the hollow or solid rotating shaft 1 is pointed toward the forward direction of the vehicle and the resultant centrifugal force vector F rotates the wheels of the vehicle and contributes to propel the vehicle forward.

The vehicle is an engine-equipped car, electric car, engine-equipped truck, electric truck, train, ship, submarine, aircraft, low orbit communications satellite, or winged spacecraft orbiting an Earth orbit below the geosynchronous orbit.

The 3-φ output power generated by the pre-decided number L of 3-φ electric power generators 8000 is directly supplied to the electric motor of the electric car or electric truck, or the 3-φ output power generated by the pre-decided number L of 3-φ electric power generators 8000 is supplied to the battery packs of the vehicle, wherein the vehicle is an engine-equipped car, electric car, engine-equipped truck, electric truck, train, ship, submarine, aircraft, low orbit communications satellite, or winged spacecraft orbiting an Earth orbit below the geosynchronous orbit.

### Seventh Embodiment (FIGS. 1-14, 28)

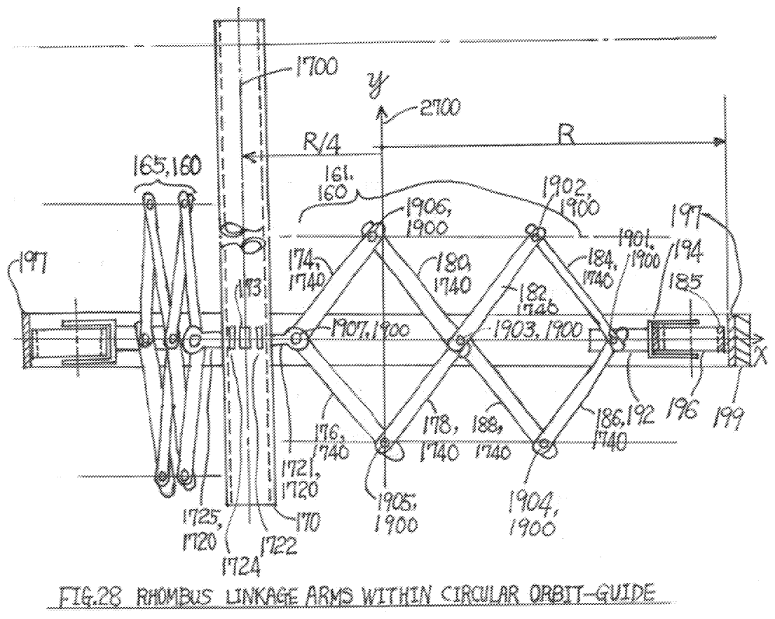

In the seventh embodiment in FIG. 28, the elliptical housing 97 in FIG. 25 is replaced by a circular orbit-guide 197 in FIG. 28 which is one of a number M of circular orbit guides 197. The seventh embodiment discloses a limited number N (N=1, 2, . . . , a limited number) of rhombus linkage arms assembly 160 collectively and nominally in FIG. 28 (e.g., eight rhombus linkage arms 161~168 individually in detail) around a hollow or solid rotating shaft 170 wherein the longitudinal axis 1700 of rotation of the hollow or solid rotating shaft 170 is positioned at an eccentric rotation point (e.g., −R/4) of the circular orbit-guide 197 on the left x-axis from the origin of the x-y Cartesian coordinates in FIG. 28 and R is the radius of the circular orbit-guide 197 in FIG. 28, a steel roller 196 has a rubber coating 195 on the steel roller 196 and orbiting the inner surface of the circular orbit-guide 197 in FIG. 28. The hollow or solid rotating shaft 170 has the limited number N (e.g., eight) of connecting rods 1720 (i.e., 1721~1728) on the outer surface of the hollow or solid rotating shaft 170 and each rhombus linkage arm unit 160 (i.e., eight rhombus linkage arms 161~164~168 in FIG. 28) of the limited number N of rhombus linkage arm units 160 comprises a multiples of four of rotating linkages 1740 (i.e., 8 rotating linkages 174, 176, 178, . . . , 184, 186, 188) and a multiples of three plus one of connecting pins 1900 (i.e., 7 connecting pins 1901~1907) forming a rhombus linkage 160 of the limited number N of rhombus linkage arm units 160 and seven connecting pins 1900 (i.e., 1901~1907) forming the number N of rhombus linkage 160. The limited number N of connecting rods 1720 are welded along a circular circumference on the hollow or solid rotating shaft 170 or along a spiral circumference on the hollow or solid rotating shaft 170.

The distal end of each of the number N of rhombus linkage arms assembly 160 has a roller connecting rod 192 having a roller support channel 194, the steel roller 196 having the rubber coating 195 on the steel roller 196 and orbiting the inner surface of the circular orbit-guide 197 and a circular orbit-guide reinforcement 199 proving further structural stability.

When the hollow or solid rotating shaft 170 rotates, the centrifugal force radially stretches the rhombus linkage arms 161~168 toward the inner surface of the inner surface of the circular orbit-guide 197 and the rhombus linkage arm 161 is fully stretched at the 3 O'clock position and having the maximum inertial twisting moment due to the gravitational force on the steel roller 196 and the rhombus linkage arm 165 is fully folded at the 9 O'clock position and having the maximal opposite inertial twisting moment at the 9 O'clock position.

Without having the elliptical housing 197 and then rotating the hollow or solid rotating shaft 170, as the angular velocity of the hollow or solid rotating shaft 170 increases, the rhombus linkage arms 161~168 radially stretches due to the centrifugal forces and at a certain angular velocity, the summation of the counter-inertial twisting moments acting on the rhombus linkage arms 165~168 in the left half side of the hollow or solid rotating shaft 170 become the same as the summation of the inertial twisting moments acting on the rhombus linkage arms 161~164 in the right half plane of the rotation.

Because the rotation center of the hollow or solid rotating shaft 170 is eccentrically located at a point on the negative half x-axis of the x-y Cartesian coordinate system, the circular housing 197 prohibits the rhombus linkage arms 165~168 in the left half plane from being fully stretched and creates the inertial twisting moment difference between the rhombus linkage arms 61~64 in the right half side in FIG. 28 and the rhombus linkage arms 65~68 in the left half side in FIG. 28. The number N of rhombus linkage arms assembly 160 is determined by the required total external torque of the pre-decided number L of 3-φ electric power generators and the inertial twisting moments created by the number N of rhombus linkage arms assembly 160 in FIG. 28 within each of the number M of circular orbit guides 197 and wherein the length of the hollow or solid rotating shaft 70 extends to accommodate the number (Mx N) of the rhombus linkage arms 60. The same support structure in FIG. 5 is used to withstand the centrifugal forces acting on the inner surface of the circular orbit-guide 197. However, in the case of small torque requirement to turn generators of several KW, the slant beam 20, the plurality of feet 331 and the frames 21, 22,28 and 29 in FIG. 5 are unnecessary and are not integrated and the 120 degree the circular orbit-guide reinforcement 199 in FIG. 28 is not needed either. The supporting structures withstanding the total centrifugal forces are the same as the previous embodiments. FIG. 26 discloses a rhombus linkage arm having a partial support rod and sliding rings to provide more structural stability of the rhombus linkage arm.

The centrifugal force is proportional to the arm length and the squared angular velocity ω and creates bending of the hollow cylindrical shaft 170 of the GFAMIT system. The horizontal components of the centrifugal forces act toward the horizontal axis X of the X-Y plane. To limit the bending and tortional tearing of the hollow cylindrical shaft 170, a pair of strain gauge and piezoelectric sensor among a predefined number M of strain gauges and piezoelectric strain sensors are fixed along the same circumferential circle at the middle point of the rotational axis of the hollow cylindrical shaft 170 and outsides of the predefined number M of hollow frustoconical housings 8 sensing the time histories of the elongations of the hollow cylindrical shaft 170 by the centrifugal force creating the bending moments of the hollow cylindrical shaft 170 around the hollow housings 8 and sensing the twisting displacements of the hollow cylindrical shaft 170 by the torque applied to the hollow cylindrical shaft 170. Both centers of each strain gauge and each piezoelectric strain sensor are fixed along the circumferential circle at the middle length position of the hollow cylindrical shaft 170but the axial sensing direction of the strain gauge and circumferential sensing direction of the piezoelectric strain sensor are perpendicular. The strain gauge fixed along the circumferential circle on the outer surface of the hollow cylindrical shaft 170 measures the elongations of the hollow cylindrical shaft 170 by the centrifugal force and the piezoelectric strain sensor along the circumferential circle measures the twisting displacements of the hollow cylindrical shaft 170 at the middle length position of the hollow cylindrical shaft 170 by the twisting torque applied to the hollow cylindrical shaft 170. The locations of both strain gauge and piezoelectric strain sensor are at any location along the circumferential circle at the middle of the rotating shaft 1. Both the measured elongations values and twisting displacements fluctuate with respect to time due to the rotational motion of the hollow cylindrical shaft 170. The measured output signals from the strain gauges and piezoelectric strain sensors are sampled and the sampled strain gauge and piezoelectric strain sensor output data fluctuates very much being contaminated by noises so that it requires a Chebyshev filter Type I or Type II having at least 8^{th} order, Butterworth filter, elliptic filter, or Savitzky-Golay filter to display and read a smoothed data by reducing or washing out the contaminating high frequency noises in the sampled data set and reading the smoothed and most probable data without the noises. A data logger stores the sampled data every time interval, the time interval equivalent to twice the rotational speed {1/(2ω)}, to the SSD drive.

Taking the Fourier transform of the stored measurement signals from the SSD drive for each encoder and tachometer, rotary torque sensor, accelerometers, the strain gauges and piezoelectric strain sensors and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder and tachometer equal to the desired angular velocity, the measured output signals from each rotary torque sensor close to the desired torque, the measured output signals from each accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known and are not explained here, and the dynamic system of the GFAMIT system is different and unique from the others.

Each fixed connecting rod 720 in FIG. 25 optionally has a partial rhombus linkage arm support 72101 in FIG. 26 and a pair of rhombus linkage arm sliding rings 72102.

Unlike a conventional windmill turbine having a zero-energy state initial position without any rotational energy, the initial position of the GFAMIT turbine system has a potential energy creating an initial twisting moment rotating the hollow cylindrical shaft 170. Therefore, a stopper or braking system is needed to keep the GFAMIT turbine system on hold when not in use. The hollow cylindrical shaft 170 must be in a stopped position applying brake force on the hollow cylindrical shaft 70. The length of the rotating link 2 and the weight of the steel sphere 91 are design parameters.

A flywheel disk and brake system 300 in FIG. 2 is connected to one end of the hollow or solid rotating shaft 170 to stop the rotation of the hollow or solid rotating shaft 170.

The proximal end of each slant beam of the plurality of slant beams 20 having a foot 331 has a hinge to rotate and adapt and be fastened to a plurality of related body frames of an engine compartment of a vehicle and the foot 331 at the distal end of the slant beam has a plurality of slotted holes for fasteners to be inserted and fastened.

The horizontal frames 21, 22-28 and vertical frames 29 and 31 and each slant beam of the plurality of slant beams 20 having a foot 331 are fixed with the body frames of the engine compartment of a vehicle.

The resultant centrifugal force vector F induced by the variable or articulate rotating arms fixed or welded on the hollow or solid rotating shaft 1 is pointed toward the forward direction of the vehicle and the resultant centrifugal force vector F rotates the wheels of the vehicle and contributes to propel the vehicle forward.

The vehicle is an engine-equipped car, electric car, engine-equipped truck, electric truck, train, ship, submarine, aircraft, low orbit communications satellite, or winged spacecraft orbiting an Earth orbit below the geosynchronous orbit.

The 3-φ output power generated by the pre-decided number L of 3-φ electric power generators 8000 is directly supplied to the electric motor of the electric car or electric truck, or the 3-output power generated by the pre-decided number L of 3-φ electric power generators 8000 is supplied to the battery packs of the vehicle, wherein the vehicle is an engine-equipped car, electric car, engine-equipped truck, electric truck, train, ship, submarine, aircraft, low orbit communications satellite, or winged spacecraft orbiting an Earth orbit below the geosynchronous orbit.

### Eighth Embodiment (FIGS. 1-14, 25-27)

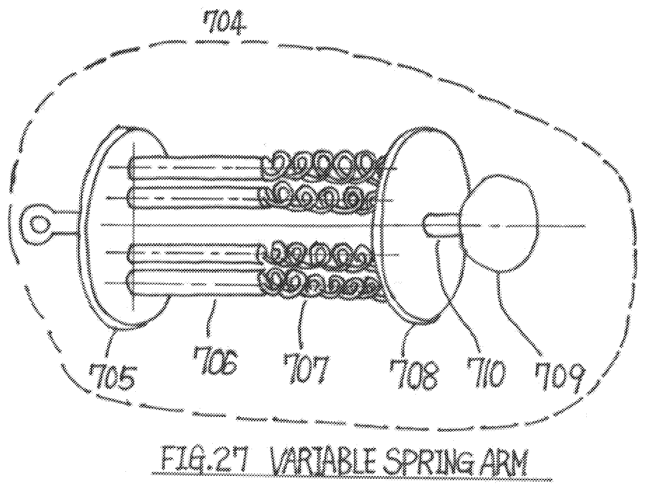

FIG. 27 discloses anelastic or flexible spring arm assembly 704 comprising a number k of tension springs 707 partially contained inside the number k of spring support cylinders 706. The proximal ends of the number k of parallel tension springs 707 are fixed or welded on the left steel plates first and then the number k of spring support cylinders 706 are inserted around the number k of tension springs 707 and are pushed to the surface of the left steel plate 705 and then the bottom of the spring support cylinders 706 and the left steel plate 705 are welded together. The distal ends of the number k of parallel tension springs 707 are fixed and welded on a right steel plate 708. A heavy steel sphere 709 is connected to the right steel plate 708 with an interfacing rod 710. Each spring constant, spring length and the number k are design parameters of the number k of parallel tension springs 707.

A hollow or solid rotating shaft 70 in FIG. 25 is positioned on the left focal point of an elliptical housing 97 (in FIG. 25) which is one of a number M of elliptical housings 97 and a limited number N (N=1, 2, . . . , limited number) of welded connecting rods 721 are welded around the hollow or solid rotating shaft 70 to connect the limited number N of variable spring arm assembly 704 in FIG. 27. The elliptical housing 97 can be replaced with a circular housing having an eccentric rotation center of the hollow or solid rotating shaft 70, a composite hollow-orbit-guide 820 in FIG. 31 consisting of a semi-circular hollow-orbit-guide 840 and a quasi-semi-circular hollow-orbit-guide 850, or an integrated semi-circular and elliptical hollow-orbit-guide 890 consisting of a semi-circular hollow-orbit-guide 840 and a semi-elliptical hollow-orbit-guide 880 and the semi-elliptical hollow-orbit-guide 880.

The limited number N of welded connecting rods 721 are welded along a circular circumference on the hollow or solid rotating shaft 70 or along a spiral circumference on the hollow or solid rotating shaft 70.

The heavy steel sphere 709 orbits the inner surface of the elliptical housing 97 and elliptical orbit-guide reinforcement 99 is added on top of the elliptical housing 97. When the hollow or solid rotating shaft 70 rotates, the centrifugal force radially stretches the elastic or flexible spring arm assembly 704 toward the inner surface of the elliptical housing 97. The elastic or flexible spring arm assembly 704 is fully stretched at the 3 O'clock position and having the maximum inertial twisting moment due to the gravitational force on the heavy steel sphere 709 and the elastic or flexible spring arm assembly 704 is fully folded at the 9 O'clock position and having the maximal and opposite inertial twisting moment at the 9 O'clock position.

The number of units of the elastic or flexible spring arm assembly 704 is determined by a required total torque of a pre-decided number L of 3-φ electric power generators 8000 driven by the hollow or solid rotating shaft 70. The same support structure in FIG. 5 is used to withstand the centrifugal forces acting on the inner surface of the elliptic housing 97. However, in the case of small torque requirement to turn generators of several KW, the slant beam 20, the plurality of feet 331 and the frames 21, 22,28 and 29 in FIG. 5 are unnecessary and are not integrated and the 120-degree elliptical reinforcement 103 in FIG. 19 is not needed either.

Because the rotation center of the hollow or solid rotating shaft 70 is located at the left focal center of the elliptical housing 97, the elliptical housing 97 prohibits the elastic or flexible spring arm assembly 704 in the left half plane fully stretched and creates the inertial twisting moment difference between the elastic or flexible spring arm assembly 704 in the right half side in FIG. 25 and the elastic or flexible spring arm assembly 704 in the left half side in FIG. 25. The hollow or solid rotating shaft 70 has a limited number N of elastic or flexible spring arm assemblies 704 to satisfy the required total torque of the pre-decided number L of 3-φ electric power generators 8000 driven by the hollow or solid rotating shaft 70 and the length of the hollow or solid rotating shaft 70 extends to accommodate the limited number N of variable spring arm assembly 704. The supporting structures withstanding the total centrifugal forces are the same as the previous embodiments.

The centrifugal force is proportional to the arm length and the squared angular velocity ω and creates bending of the hollow cylindrical shaft 70 of the GFAMIT system. The horizontal components of the centrifugal forces act toward the horizontal axis X of the X-Y plane. To limit the bending and tortional tearing of the hollow cylindrical shaft 70, a pair of strain gauge and piezoelectric sensor among a predefined number M of strain gauges and piezoelectric strain sensors are fixed along the same circumferential circle at the middle point of the rotational axis of the hollow cylindrical shaft 70 and outsides of the predefined number M of hollow frustoconical housings 8 sensing the time histories of the elongations of the hollow cylindrical shaft 70 by the centrifugal force creating the bending moments of the hollow cylindrical shaft 70 around the hollow housings 8 and sensing the twisting displacements of the hollow cylindrical shaft 70 by the torque applied to the hollow cylindrical shaft 70. Both centers of each strain gauge and each piezoelectric strain sensor are fixed along the circumferential circle at the middle length position of the hollow cylindrical shaft 70but the axial sensing direction of the strain gauge and circumferential sensing direction of the piezoelectric strain sensor are perpendicular. The strain gauge fixed along the circumferential circle on the outer surface of the hollow cylindrical shaft 70 measures the elongations of the hollow cylindrical shaft 70 by the centrifugal force and the piezoelectric strain sensor along the circumferential circle measures the twisting displacements of the hollow cylindrical shaft 70 at the middle length position of the hollow cylindrical shaft 70 by the twisting torque applied to the hollow cylindrical shaft 70. The locations of both strain gauge and piezoelectric strain sensor are at any location along the circumferential circle at the middle of the rotating shaft 1. Both the measured elongations values and twisting displacements fluctuate with respect to time due to the rotational motion of the hollow cylindrical shaft 70. The measured output signals from the strain gauges and piezoelectric strain sensors are sampled and the sampled strain gauge and piezoelectric strain sensor output data fluctuates very much being contaminated by noises so that it requires a Chebyshev filter Type I or Type II having at least 8^{th} order, Butterworth filter, elliptic filter, or Savitzky-Golay filter to display and read a smoothed data by reducing or washing out the contaminating high frequency noises in the sampled data set and reading the smoothed and most probable data without the noises. A data logger stores the sampled data every time interval, the time interval equivalent to twice of the rotational speed {1/(20)}, to the SSD drive.

Taking the Fourier transform of the stored measurement signals from the SSD drive for each encoder and tachometer, rotary torque sensor, accelerometers, the strain gauges and piezoelectric strain sensors and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder and tachometer equal to the desired angular velocity, the measured output signals from each rotary torque sensor close to the desired torque, the measured output signals from each accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known (e.g., Katsuhiko Ogata, Bernard Friedland) and are not explained here, and the dynamic system of the GFAMIT system is different and unique from the others.

Unlike a conventional windmill turbine having a zero-energy state initial position without any rotational energy, the initial position of the GFAMIT turbine system has a potential energy creating an initial twisting moment rotating the hollow cylindrical shaft 70. Therefore, a stopper or braking system is needed to keep the GFAMIT turbine system on hold when not in use. The hollow cylindrical shaft 70 must be in a stopped position applying brake force on the hollow cylindrical shaft 70. The length of the rotating link 2 and the weight of the steel sphere 91 are design parameters.

A flywheel disk and brake system 300 in FIG. 2 is connected to one end of the hollow or solid rotating shaft 70 to stop the rotation of the hollow or solid rotating shaft 70.

The proximal end of each slant beam of the plurality of slant beams 20 having a foot 331 has a hinge to rotate and adapt and be fastened to a plurality of related body frames of an engine compartment of a vehicle and the foot 331 at the distal end of the slant beam has a plurality of slotted holes for fasteners to be inserted and fastened.

The horizontal frames 21, 22-28 and vertical frames 29 and 31 and each slant beam of the plurality of slant beams 20 having a foot 331 are fixed with the body frames of the engine compartment of a vehicle.

The resultant centrifugal force vector F induced by the variable or articulate twisting-moment-arms fixed or welded on the hollow or solid rotating shaft 1 is pointed toward the forward direction of the vehicle and the resultant centrifugal force vector F rotates the wheels of the vehicle and contributes to propel the vehicle forward.

The vehicle is an engine-equipped car, electric car, engine-equipped truck, electric truck, train, ship, submarine, aircraft, low orbit communications satellite, or winged spacecraft orbiting an Earth orbit below the geosynchronous orbit.

The 3-φ output power generated by the pre-decided number L of 3-φ electric power generators 8000 is directly supplied to the electric motor of the electric car or electric truck, or the 3-φ output power generated by the pre-decided number L of 3-φ electric power generators 8000 is supplied to the battery packs of the vehicle, wherein the vehicle is an engine-equipped car, electric car, engine-equipped truck, electric truck, train, ship, submarine, aircraft, low orbit communications satellite, or winged spacecraft orbiting an Earth orbit below the geosynchronous orbit.

### Ninth Ninth Embodiment (FIGS. 1-14, 29)

FIGS. 25-27 related to FIGS. 1-14 disclose the eighth embodiment. A hollow cylindrical shaft 800 in FIG. 29 has a limited number N (N=1, 2, . . . , limited number) of articulate arms 810 within each circular orbit guide of a number M of circular orbit guides 801 to satisfy a required total torque of a pre-decided number L of 3-φ electric power generators 8000 driven by the hollow cylindrical shaft 800 and the length of the hollow cylindrical shaft 800 extends to accommodate the limited number N of articulate arms 810 (i.e., 811~818) within each circular orbit guide of a number M of circular orbit guides 801.

FIG. 29 discloses the initial positions of, for example, eight sets 811~818 of articulated arms of the hollow cylindrical shaft 800 projected onto the same cross-sectional plane but each pair of the twisting-moment-arms are fixed along the hollow or solid rotating shaft 800 as shown in FIG. 30.

FIG. 29 discloses a single circular orbit guide 801 containing a rotation center of a hollow cylindrical shaft 800 eccentrically located from the geometric center of the single circular orbit guides 801 and the eccentricity of the rotational axis of the hollow cylindrical shaft 800 from the geometric center of the circular orbit guide 801 is a design parameter.

Unlike a conventional windmill turbine having a zero-energy state initial position without any rotational energy, the initial position of the GFAMIT turbine system has a potential energy creating an initial twisting moment to rotate the hollow or solid rotating shaft 800. Therefore, a stopper or braking system such a flywheel disk and brake system 300 is needed to keep the GFAMIT turbine system on hold when not in use. The hollow cylindrical shaft 800 is in a stopped position applying brake force on the radial surface of the circular flywheel disk 40 with the pre-selected number I pairs of braking shoes 41 and placing the pre-determined number j of anchor arms 57 to locking positions shown in FIG. 6.

Releasing the pre-determined number j of anchor arms 57 and then making free of the pre-selected number I pairs of braking shoes 41, the hollow cylindrical shaft 800 begins to rotate due to the clockwise inertial twisting moment, e.g, Mₜₒₜₐₗ=Σ_{i=811~818}Mᵢ, wherein, i.e., M₁=(R₈₁₁) (Gm₈₁₁₄) created by the gravitational forces G acting on the steel sphere 8114 and other inertial twisting moments created by the rest seven articulate arms 812~818, are M₂=(R₈₁₂)(G), . . . , M₈=(R₈₁₈)(G m₈₁₈₄). For the exemplary fifth articulate arm 8 in the left half plane among the eight articulate arms, the magnitude of the opposing counterclockwise inertial twisting moment M₅=M₅₁+M₅₂+M₅₃=(R₈₁₅)(Gm₈₁₅₄)+(R₈₁₅₃) (G m₈₁₅₃)+(R₈₁₅₂) (G m₈₁₅₂) is much smaller than the magnitude of the clockwise inertial twisting moment M₁ in the right half plane, because of shorter arm length of the fifth articulate arm 815 than the arm length 811 at the opposite angular position of 180° in the right hand side of the y-axis. As the rotational angular velocity ω of the hollow cylindrical shaft 800 increases, the induced resultant centrifugal forces F_{c} acting on each steel sphere m_{8114~8184} increases. For example, regarding the articulate arm 818 in FIG. 29, the perpendicular component of the centrifugal force F_{c1} acting on the steel spheres m₈₁₈₄ makes clockwise rotation of the articulate linkage 8183 with respect to the pivoting shaft 8185. The cross-hatched bottom of the articulate link 8182 stops the further rotation of the articulate link 8183 to rotate with respect to each of the pivot shafts 8185 and 8186 making a radially full-stretched articulate arm 818 like the articulate arm 811. When each vertical y-axis component of the centrifugal force acting on each steel sphere of the eight steel spheres 8114~8184 become equal to the vertical gravitational force of each steel sphere, the articulate arms 811~818 are stretched in full radial length and there exists no difference in the articulate arms. At this moment, the inertial twisting moment to drive and rotate the hollow cylindrical shaft 800 is zero and the rotational velocity of the hollow or solid rotating shaft 800 is in equilibrium and results in a constant rotational velocity of the hollow cylindrical shaft 800.

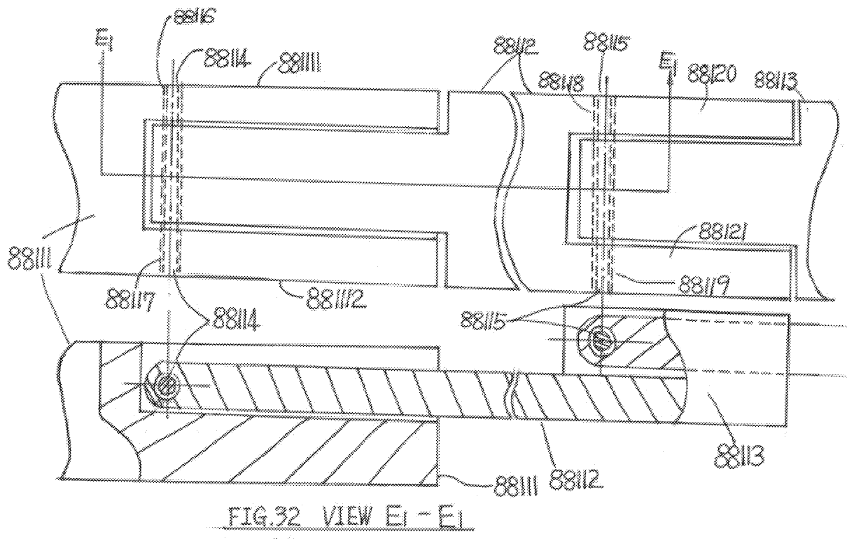

The hollow cylindrical shaft 800 has a limited number N (eight in FIG. 29) of fixed arms 81110 (e.g. and i.e., 8111, 8121, . . . , 8171, 8181) on the outer surface of the hollow cylindrical shaft 800. FIG. 29 discloses the limited number N of first connecting rods 81120 (e.g. and i.e., 8112, 8122, 8132, 8142, 8152, 8162, 8172, 8182), and second connecting rods 81130 (e.g. and i.e., 8113, 8123, 8133, 8143, 8153, 8163, 8173, 8183) and the limited number N of the steel spheres 81140 (e.g. and i.e., 8114, 8124, . . . , 8184) and wherein each steel sphere is fixed to each distal end of each second connecting rod. Each proximal end of each second connecting rod rotates with respect to a pivot bolt 88115 and the axis of pivoting motion is perpendicular to the longitudinal axis of the first connecting rod and the second connecting rod connected together by the pivot bolt 88115. The distal end of each first connecting rod 8112 and the proximal end of each second connecting rod 8113 are pivoting with respect to the pivot bolt 88115 in FIG. 32 and the axis of pivoting motion is perpendicular to the longitudinal axis of the first connecting rod and the second connecting rod connected together by the pivot bolt 88114.

The distal end of each first connecting rod 8112 prohibits each second connecting rod 8113 from rotating more than 180° from the horizontal axis passing through the rotational axis of the hollow cylindrical shaft 800 after passing the 3 O'clock direction as shown in FIG. 29 and creates maximal inertial twisting moment acting on the center of the steel spheres 8114 and the gravity force acting on the second connecting rod 8113 and the first connecting rod 8112.

Additionally, the proximal end of each first connecting rod 8112 and the proximal end of each fixed arm 8111 are connected by a pivot bolt 88114 in FIG. 32. The distal end of each fixed arm 8111 prohibits each first connecting rod 8112 from rotating more than 180° from the horizontal axis passing through the rotational axis of the hollow cylindrical shaft 800 after passing the 3 O'clock direction as shown in FIG. 29 and creates maximal inertial twisting moment acting on the center of the steel spheres 8114 and the gravity forces acting on the second connecting rod 8113 and the first connecting rod 8112.

In the case of a single rotating plane having all articulate arms 810 as shown in FIG. 29, the steel sphere 81140 fixed to the distal end of each second connecting rod 8113 overlaps or entangles over the lower articulate arm 810 in the left half plane of the rotational plane.

In the case of a four rotating planes E1~E4 having all articulate arms 810 as shown in FIG. 30, the steel sphere 81140 fixed to the distal end of each second connecting rod 8113 drops along the gravitational force of the Earth without any overlapping or entangling over the previously lower articulate arm 810 in the left half plane of the rotational plane shown in FIG. 29.

The limited number N of fixed arms, for example, 8111, 8121, 8211, 8212, 8311, 8312, 8411, 8412 in FIGS. 29 and 88111, 88121, 88211, 88212, 88311, 88312, 88411, 88412 in FIG. 31, are welded along a spiral circumference on the hollow cylindrical shaft 800.

Each hollow orbit guide among the number M of hollow orbit guides containing the rotational center of the hollow cylindrical shaft 800 has one of the four hollow orbit guides as follows.

First, FIG. 29 discloses a single circular orbit guide 801 containing a rotation center O₈₀₁ of a hollow cylindrical shaft 800 eccentrically displaced to the right-hand side from the origin of the x-y axis of the single circular orbit guide 801 without an eccentric displacement and the hollow cylindrical shaft 800 has the limited number N of articulate arms 810 within each of the number M of circular orbit guides 801.

Second, FIGS. 30 and 31 discloses a composite hollow-orbit-guide 820 consisting of a semi-circular hollow-orbit-guide 840 and a quasi-semi-circular hollow-orbit-guide 850. The semi-circular orbit-guide 840 has a vertical diameter and a radius R_{R}. And the quasi-semi-circular orbit-guide 850 has its own vertical diameter and a radius R_{L} and the radius R_{L} is larger than the radius R_{R}. Because the radius R_{L} is larger than the radius R_{R}, the vertical diameter side of the semi-circular hollow-orbit-guide 840 is inserted into the vertical diameter side of the quasi-semi-circular orbit-guide 850. The rotational center of the hollow cylindrical shaft 800 is placed in the middle of the vertical diameter of the semi-circular orbit-guide 840. The middle of the vertical diameter of the quasi-semi-circular orbit-guide 850 is located at the distal end of the fixed arm 88111 as further shown in FIG. 31 so that the rotational arm length in the left half plane is shorter than the rotational arm length in the right half plane, so that the twisting-moment-arm length of the limited number N of articulate arms 810 in the left half plane is folded and shorter than the twisting-moment-arm length on the right half plane. The orbit-guide 840 in the right half plane of the x-y plane is a semi-circular orbit-guide of radius R_{R} centered at the center of the hollow or solid rotating shaft 800 so that the articulate arms 8811, 8821, 8831 and 8841 are stretched in full length along the radial direction of the rotation of the hollow or solid rotating shaft 800. The articulate arms in the left half plane of the x-y plane cannot be stretched in full length along the radial direction of the rotation of the hollow or solid rotating shaft 800 so that the counterclockwise inertial twisting moments are smaller than the clockwise inertial twisting moments in the right half plane. In FIG. 31, the second link 88413 and the steel sphere 88414 of the articulate arm 8841 are rotated in counterclockwise direction with respect to the rotation center at the proximal end of the first link drawn with dashed cross-section in FIG. 31.

The extra-top and bottom ends of the quasi-semi-circular orbit-guide 850 greater than the top and bottom ends of the semi-circular orbit-guide 840 have been cut away by a proper machine tool. The vertical ends of the semi-circular orbit-guide 840 are welded together with the top and bottom ends of the quasi-semi-circular orbit-guide 850 forming the integrated semi-circular and quasi-semi-circular hollow-orbit-guide 820 and the protruded sharp edges have been grinded out and sunk valleys are filled with molten weld metals. The integrated semi-circular and quasi-semi-circular hollow-orbit-guide 820 has a rotation center of the hollow cylindrical shaft 800 at the center of the middle of the diameter of the semi-circular hollow-orbit-guide 840 co-locating the origin of the X-Y Cartesian coordinate system. The composite hollow-orbit-guide 820 creates large inertial twisting moment difference between the left arm (in the negative half plane of the x-y plane) and the right arm (in the positive half plane of the x-y plane) by prohibiting the first and second link from being stretched full toward the radial direction of the rotation of the hollow or solid rotating shaft 800.

The hollow cylindrical shaft 800 has a limited number N of articulate arms 810 within each of a number M of integrated semi-circular and quasi-semi-circular hollow orbit-guides 820.

Third, FIG. 30 discloses that an elliptical hollow-orbit-guide 860 has a rotation center of the hollow cylindrical shaft 800 at the left focal point A of the single elliptical hollow-orbit-guide 860 on the x-axis and the hollow cylindrical shaft 800 has a limited number N of articulate arms 810 within each elliptical hollow-orbit-guide of the number M of single elliptical hollow orbit-guides 860. The dashed line 860 is an elliptical orbit-guide having left focal points A (at the center of the hollow or solid rotating shaft 800) and right focal point B (at the end of the fixed arm) wherein the center of the hollow or solid rotating shaft 800 is centered at the left focal point A and having the longest arm length which is fully stretched at 3 O'clock position. The arm length within the elliptical orbit-guide 860 is shorter than the arm length within the semi-circular orbit-guide 840 and 850 but has a smoother surface without having a joint boundary.

Fourth, FIGS. 30 and 31 discloses that an integrated semi-circular and elliptical hollow-orbit-guide 890 consisting of a semi-circular hollow-orbit-guide 840 and a semi-elliptical hollow-orbit-guide 880 and the semi-elliptical hollow-orbit-guide 880 has the major axis same as the vertical radius of the semi-circular orbit-guide 840 and the semi-elliptical hollow-orbit-guide 880 having upper focal point C and lower focal point D. The rotational center of the hollow cylindrical shaft 800 is located at the middle between the two focal points C and D of the elliptical orbit-guide 860, i.e., the integrated semi-circular and semi-elliptical hollow-orbit-guide 840-890 has a rotation center of the hollow cylindrical shaft 800 at the middle of the vertical axis of the semi-circular hollow-orbit-guide 840 and co-locating the center of the major arm of the semi-elliptical hollow-orbit-guide 880 at the middle of the diameter of the hollow cylindrical shaft 800 wherein the hollow cylindrical shaft 800 has a limited number N of articulate arms 810 within each integrated semi-circular and semi-elliptical hollow-orbit-guide of the number M of integrated semi-circular and semi-elliptical hollow orbit-guides 890. A semi-circular orbit-groove 370 is also formed on the inner surface of the semi-circular hollow-orbit-guide 840 for helping orbital motions of a heavy steel sphere 88116 which is in detail the spherical ball assembly 64 in FIG. 16 and a semi-elliptical orbit-groove 380 is also formed on the inner surface of the semi-elliptical hollow-orbit-guide 880.

The top view FIG. 30 discloses four pairs of articulate arms at four different points E1~E4 on the longitudinal z-axis of the hollow or solid rotating shaft 800 wherein the fixed links of each pair have 180-degree phase angle on the same x-y plane to avoid the articulate arms interfering and damaging each other, instead of eight articulate arms having 45 degree-phase angle on the same x-y plane in FIG. 29. Instead of drawing each separate view on each sheet, the four cross-sectional views have overlapped in FIG. 31 for convenience to show all initial positions of the four pairs of articulate arms.

In FIG. 31, the four cross-sectional planes E1~E4 perpendicular to the sheet are projected onto a rotational plane of the four pairs of articulate arms. The articulate arms 8811 and 8812 are in the same x-y plane as shown in FIG. 30, but the articulate arms 8821 and 8831 and 8841 in FIG. 31 are in the different cross-sectional planes E2~E4 as shown in FIGS. 30 and 31. In the right half plane from the y-axis of the x-y plane, articulate arm 8811 is in full stretched motion having largest rotational radius but in the left half plane from the y-axis of the x-y plane, the articulate arm 8812 has very short arm length making a very big difference in arm radius so that much larger magnitude of inertial twisting moment (torsion) is made on the rotational shaft 800. Depending on the magnitude of the required total inertial twisting moment of the hollow or solid rotating shaft 800 to rotate the pre-decided number L of 3-φ electric power generators, the number of the pair of the articulated arms are calculated and the required length of the hollow or solid rotating shaft 800 is also a design parameter in addition to the weight parameter of the heavy steel sphere 88116 which is in detail the spherical ball assembly 64 in FIG. 16.

The articulate arm 8811 has a fixed arm 88111, first link 88112 and second link 88113. FIG. 32 discloses the detailed structure of the fixed arm 88111, first articulated arm 88112 and second articulated arm 88113. The fixed arm 88111 is a channel shape having two sidewalls and a bottom. The bottom of the fixed arm 88111 supports the weights of the first link 88112, the second link 88113 and the steel sphere 88116. The two sidewalls 881111 and 881112 have pivot holes 88116 and 88117. A fixed arm pivot shaft 88114 passes through the two pivot holes 88116 and 88117 for allowing angular rotation of the first link 88111. The second link 88112 has also two sidewalls 88120 and 88121. The two sidewalls 88120 and 88121 have pivot holes 88118 and 88119. A second link pivot shaft 88115 passes through the two pivot holes 88118 and 88119 for allowing angular rotation of the second link 88113. The structure of the articulate arm 8812 has the same structure as the structure of the articulate arm 8811 but is rotated 180-degree with respect to the center of rotation of the hollow or solid rotating shaft 800 and the first link and second link and steel sphere is aligned to the direction of the gravitational force. Each of the steel spheres 88116 is connected to the end of the second link 88113 and the second link 88113 is stretched forming the twisting-moment-arm of the hollow or solid rotating shaft 800. However when the fixed arm 88111 is rotated 180-degree clockwise with respect to the center of the hollow or solid rotating shaft 800 to the position of the fixed arm 88121, the gravitational force acting on the steel sphere makes the first link 88122 and the second link 88123 to be rotated by 90-degree counter-clockwise with respect to each pivot shafts of the first link 88122 and the second link 88123 and is vertically aligned as disclosed in FIG. 31.

In FIG. 31, the hollow or solid rotating shaft 800 has a limited number N (N=1, 2, . . . , limited number) of vertically perpendicular planes where each of the limited number N of vertically perpendicular plane has a pair of articulate arms 8811 and 8812 (next vertically perpendicular plane has a pair of articulate arms 8821 and 8822, then 8831 and 8832, . . . ) to satisfy a required total torque of the pre-decided number L of 3-φ electric power generators 50 driven by the hollow or solid rotating shaft 800 and the length of the hollow or solid rotating shaft 800 extends to accommodate the limited number N (N=1, 2, . . . , limited number) of units of the exemplary two articulate arms 8811 and 8812. The supporting structures withstanding the total centrifugal forces are same as the previous embodiments and bending moments of the hollow or solid rotating shaft 800 are measured by a number M of strain gauges and piezoelectric strain sensors fixed on the hollow or solid rotating shaft 800 to measure the elongations of the hollow or solid rotating shaft 800 by the centrifugal force and twisting displacements of the hollow or solid rotating shaft 800 by the torque applied to the hollow or solid rotating shaft 800. Each pair of strain gauge and piezoelectric stain sensor of the predefined number M of strain gauges and piezoelectric strain sensors are fixed along the same circumferential circle at the middle point of the rotational axis of the hollow or solid rotating shaft 800 and outsides of the predefined number M of hollow frustoconical housings 8 sensing the time histories of the elongations of the hollow or solid rotating shaft 800 by the centrifugal force creating the bending moments of the hollow or solid rotating shaft 800 around the hollow housings 8 and sensing the twisting displacements of the hollow or solid rotating shaft 800 by the torque applied to the hollow or solid rotating shaft 800. Both centers of each strain gauge and each piezoelectric strain sensor are fixed along the circumferential circle at the middle length position of the hollow or solid rotating shaft 800but the axial sensing direction of the strain gauge and circumferential sensing direction of the piezoelectric strain sensor are perpendicular. The strain gauge fixed along the circumferential circle on the outer surface of the hollow or solid rotating shaft 800 measures the elongations of the hollow or solid rotating shaft 800 by the centrifugal force and the piezoelectric strain sensor along the circumferential circle measures the twisting displacements of the hollow or solid rotating shaft 800 at the middle length position of the hollow or solid rotating shaft 800 by the twisting torque applied to the hollow or solid rotating shaft 800. The locations of both strain gauge and piezoelectric strain sensor are at any location along the circumferential circle at the middle of the hollow or solid rotating shaft 800. The strain gauge outputs and the piezoelectric strain sensor outputs are signal conditioned, amplified and compared to the allowable threshold strain value to compute the strain error to be used in the dual closed-loop feedback servo-controller in FIG. 4 or the LQG/LQR closed-loop feedback servo-controller in a textbook, authored by Katsuhiko Ogata. The measured output signals from each of the strain gauges and piezoelectric strain sensors are sampled and a data logger stores the sampled data every time interval, every second, to the SSD drive and taking the Fourier transform of the stored measurement signals from the SSD drive for each encoder and tachometer, rotary torque sensor, accelerometers, the strain gauges and piezoelectric strain sensors and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder and tachometer equal to the desired angular velocity, the measured output signals from each rotary torque sensor close to the desired torque, the measured output signals from each accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known (e.g., Katsuhiko Ogata, Bernard Friedland) and are not explained here, and the dynamic system of the GFAMIT system is different and unique from the others. The limited number M of strain gauges and piezoelectric strain sensors measure the elongations of the hollow or solid rotating shaft 800 by the centrifugal force and twisting displacements of the hollow or solid rotating shaft 800 by the torque applied to the hollow or solid rotating shaft 800.

Unlike a conventional turbine having a zero-energy state initial position without any rotational energy, the initial position of the GFAMIT turbine system has a potential energy creating an initial twisting moment rotating the hollow or solid rotating shaft 800. Therefore, a stopper or braking system is needed to keep the GFAMIT turbine system on hold when not in use. The hollow or solid rotating shaft 800 be in a stopped position applying brake force on the hollow or solid rotating shaft 800. The length of the rotating link 2 and the weight of the steel sphere 91 are design parameters.

A flywheel disk and brake system 300 in FIG. 2 is connected to one end of the hollow or solid rotating shaft 800 to stop the rotation of the hollow or solid rotating shaft 800.

The proximal end of each slant beam of the plurality of slant beams 20 having a foot 331 has a hinge to rotate and adapt and be fastened to a plurality of related body frames of an engine compartment of a vehicle and the foot 331 at the distal end of the slant beam has a plurality of slotted holes for fasteners to be inserted and fastened.

The horizontal frames 21, 22-28 and vertical frames 29 and 31 and each slant beam of the plurality of slant beams 20 having a foot 331 are fixed with the body frames of the engine compartment of a vehicle.

The resultant centrifugal force vector F induced by the variable or articulate twisting-moment-arms fixed or welded on the hollow or solid rotating shaft 1 is pointed toward the forward direction of the vehicle and the resultant centrifugal force vector F rotates the wheels of the vehicle and contributes to propel the vehicle forward.

The vehicle is an engine-equipped car, electric car, engine-equipped truck, electric truck, train, ship, submarine, aircraft, low orbit communications satellite, or winged spacecraft orbiting an Earth orbit below the geosynchronous orbit.

The 3-output power generated by the pre-decided number L of 3-φ electric power generators 8000 is directly supplied to the electric motor of the electric car or electric truck, or the 3-φ output power generated by the pre-decided number L of 3-φ electric power generators 8000 is supplied to the battery packs of the vehicle, wherein the vehicle is an engine-equipped car, electric car, engine-equipped truck, electric truck, train, ship, submarine, aircraft, low orbit communications satellite, or winged spacecraft orbiting an Earth orbit below the geosynchronous orbit.

### Tenth Embodiment (FIGS. 1-14, 29-30)

Without having the hollow circular housing 197 in FIG. 28 and after rotating the hollow or solid rotating shaft 170 by releasing the pre-selected number I pairs of braking shoes 41 in FIG. 6 and the pre-determined number j of anchor arms 57 holding the toothed flywheel 40 shown in FIG. 6, and then rotating the hollow or solid rotating shaft 170, as the angular velocity of the hollow or solid rotating shaft 170 increases, each rotating link 160 and the heavy rolling wheel 196 radially stretches due to the centrifugal forces and at a certain angular velocity, the summation of the inertial counter-twisting moments acting each rotating link 160 and the heavy rolling wheel 196 in the left half side of the hollow or solid rotating shaft 170 become the same as the summation of the inertial twisting moments acting on each rotating link 160 and the heavy rolling wheel 196 in the right half plane of the rotation without having the hollow circular housing 197, and eventually arrives at an equilibrium angular velocity in the ambient air space without the hollow circular housing 197. Therefore, shear forces on the connecting pins 1900 (for example, 7 connecting pins 1901~1907) in FIG. 28 increases due to increase of centrifugal force in accordance with increase of angular velocity of the hollow or solid rotating shaft 170. Initially, the magnitude of the centrifugal forces working on the left half plane and the magnitude of the right half plane are different due to the longer rotational arm length in the right half plane than the rotational arm lengths in the left half plane. At a certain angular velocity and without considering the total external torque on all mechanical shafts of the 3-φ electric power generators 8000, the summation of the inertial counter-twisting moments acting on the rotating links in the left half plane and resistive counter torque caused by the frictional force working on the rotating circumferential surfaces of the turbine eventually become the same as the summation of the inertial twisting moments acting on the rotating links 160 in the right half plane of the rotation. This angular velocity is the equilibrium angular velocity and the shear force on the connecting pins 1900 due to the centrifugal force passing the right half plane is constant and maximal. In other words, it is a constant angular velocity without having an external torque to rotate the hollow or solid rotating shaft 1 satisfying the rotation dynamic equation J(d²θ/dt²)+(dθ/dt)+Kₛ θ=0, wherein θ=rotation angle, J=moment of Inertia, ζ=viscosity and Kₛ=spring constant. However, in the case of an uncontrolled high rotational speed, there is a possibility of mechanical fracture of the related mechanical parts so that the rotating link 160 or the heavy rolling wheel 196 of the turbine system in FIG. 70 can fail and is accidentally disintegrated from the fastened or welded part by the induced resultant centrifugal force. When mechanical failure occurs, the induced resultant centrifugal force makes the disintegrated rotating link 160 or the heavy rolling wheel 196 radially fly and damages a part of the invented turbine system or an operator or a person passing by the invented turbine system. For the sake of preventing an accident due to structural failure of the invented system, a cylindrically hollow safety-housing which is concentrical to the centerline of the rotating shaft 170 is added outside of the trajectory of the heavy rolling wheel 196 to protect the invented turbine system.

Therefore, a cylindrically hollow safety-housing 803 in FIG. 29 has the rotational axis O₈₀₃ of a hollow cylindrical shaft 800 at the geometric center of the cylindrical hollow safety-housing 803 in FIG. 29. The hollow cylindrical shaft 800 has a limited number N (N=1, 2, . . . , limited number) of articulate arms 810. There are a number M of cylindrically hollow safety-housings 803 for the total (M×N) of articulate arms 810 to satisfy a required total torque of a pre-decided number L of 3-φ electric power generators 8000 driven by the hollow cylindrical shaft 800 and the length of the hollow cylindrical shaft 800 extends to accommodate the limited number (M×N) of articulate arms 810 (i.e., 811~818) within each circular orbit guide of a number M of cylindrically hollow safety-housings 803.

Releasing the pre-determined number j of anchor arms 57 and then making free of the pre-selected number I pairs of braking shoes 41, the hollow cylindrical shaft 800 begins to rotate due to the clockwise inertial twisting moment, e.g, Mₜₒₜₐₗ=Σ_{i=811~818}Mᵢ, wherein, i.e., M₁=(R₈₁₁)(Gm₈₁₁₄) created by the gravitational forces G acting on the steel sphere 8114 and other inertial twisting moments created by the rest seven articulate arms 812~818, are M₂=(R₈₁₂)(G), . . . , M₈=(R₈₁₈)(G m₈₁₈₄). For the exemplary fifth articulate arm 8 in the left half plane among the eight articulate arms, the magnitude of the opposing counterclockwise inertial twisting moment M₅=M₅₁+M₅₂+M₅₃=(R₈₁₅)(Gm₈₁₅₄)+(R₈₁₅₃) (G m₈₁₅₃)+(R₈₁₅₂)(G m₈₁₅₂) is much smaller than the magnitude of the clockwise inertial twisting moment M₁ in the right half plane, because of shorter arm length of the fifth articulate arm 815 than the arm length 811 at the opposite angular position of 180° in the right hand side of the y-axis. As the rotational angular velocity ω of the hollow cylindrical shaft 800 increases, the induced resultant centrifugal forces F_{c} acting on each steel sphere m_{8114~8184} increases. For example, regarding the articulate arm 818 in FIG. 29, the perpendicular component of the centrifugal force F_{c1} acting on the steel spheres m₈₁₈₄ makes clockwise rotation of the articulate linkage 8183 with respect to the pivoting shaft 8185. The cross-hatched bottom of the articulate link 8182 stops the further rotation of the articulate link 8183 to rotate with respect to each of the pivot shafts 8185 and 8186 making a radially full-stretched articulate arm 818 like the articulate arm 811. When each vertical y-axis component of the centrifugal force acting on each steel sphere of the eight steel spheres 8114~8184 become equal to the vertical gravitational force of each steel sphere, the articulate arms 811~818 are stretched in full radial length and there exists no difference in the articulate arms. At this moment, the inertial twisting moment to drive and rotate the hollow cylindrical shaft 800 is zero and the rotational velocity of the hollow or solid rotating shaft 800 is in equilibrium and results in a constant rotational velocity of the hollow cylindrical shaft 800.

The hollow cylindrical shaft 800 has a limited number N (eight in FIG. 29) of fixed arms 81110 (e.g. and i.e., 8111, 8121, . . . , 8171, 8181) on the outer surface of the hollow cylindrical shaft 800. FIG. 29 discloses the limited number N of first connecting rods 81120 (e.g. and i.e., 8112, 8122, 8132, 8142, 8152, 8162, 8172, 8182), and second connecting rods 81130 (e.g. and i.e., 8113, 8123, 8133, 8143, 8153, 8163, 8173, 8183) and the limited number N of the steel spheres 81140 (e.g. and i.e., 8114, 8124, . . . , 8184) and wherein each steel sphere is fixed to each distal end of each second connecting rod. Each proximal end of each second connecting rod rotates with respect to a pivot bolt 88115 and the axis of pivoting motion is perpendicular to the longitudinal axis of the first connecting rod and the second connecting rod connected together by the pivot bolt 88115. The distal end of each first connecting rod 8112 and the proximal end of each second connecting rod 8113 are pivoting with respect to the pivot bolt 88115 in FIG. 32 and the axis of pivoting motion is perpendicular to the longitudinal axis of the first connecting rod and the second connecting rod connected together by the pivot bolt 88114.

The distal end of each first connecting rod 8112 prohibits each second connecting rod 8113 from rotating more than 180° from the horizontal axis passing through the rotational axis of the hollow cylindrical shaft 800 after passing the 3 O'clock direction as shown in FIG. 29 and creates maximal inertial twisting moment acting on the center of the steel spheres 8114 and the gravity force acting on the second connecting rod 8113 and the first connecting rod 8112.

Additionally, the proximal end of each first connecting rod 8112 and the proximal end of each fixed arm 8111 are connected by a pivot bolt 88114 in FIG. 32. The distal end of each fixed arm 8111 prohibits each first connecting rod 8112 from rotating more than 180° from the horizontal axis passing through the rotational axis of the hollow cylindrical shaft 800 after passing the 3 O'clock direction as shown in FIG. 29 and creates maximal inertial twisting moment acting on the center of the steel spheres 8114 and the gravity forces acting on the second connecting rod 8113 and the first connecting rod 8112.

In the case of a single rotating plane having all articulate arms 810 as shown in FIG. 29, the steel sphere 81140 fixed to the distal end of each second connecting rod 8113 overlaps or entangles over the lower articulate arm 810 in the left half plane of the rotational plane.

In the case of a four rotating planes E1~E4 having all articulate arms 810 as shown in FIG. 30, the steel sphere 81140 fixed to the distal end of each second connecting rod 8113 drops along the gravitational force of the Earth without any overlapping or entangling over the previously lower articulate arm 810 in the left half plane of the rotational plane shown in FIG. 29.

The limited number N of fixed arms, for example, 8111, 8121, 8211, 8212, 8311, 8312, 8411, 8412 in FIGS. 29 and 88111, 88121, 88211, 88212, 88311, 88312, 88411, 88412 in FIG. 31, are welded along a spiral circumference on the hollow cylindrical shaft 800.

The top view FIG. 30 discloses four pairs of articulate arms at four different points E1~E4 on the longitudinal z-axis of the hollow or solid rotating shaft 800 wherein the fixed links of each pair have 180-degree phase angle on the same x-y plane to avoid the articulate arms interfering and damaging each other, instead of eight articulate arms having 45 degree-phase angle on the same x-y plane in FIG. 29. Instead of drawing each separate view on each sheet, the four cross-sectional views have overlapped in FIG. 31 for convenience to show all initial positions of the four pairs of articulate arms.

In FIG. 31, the four cross-sectional planes E1~E4 perpendicular to the sheet are projected onto a rotational plane of the four pairs of articulate arms. The articulate arms 8811 and 8812 are in the same x-y plane as shown in FIG. 30, but the articulate arms 8821 and 8831 and 8841 in FIG. 31 are in the different cross-sectional planes E2~E4 as shown in FIGS. 30 and 31. In the right half plane from the y-axis of the x-y plane, articulate arm 8811 is in full stretched motion having largest rotational radius but in the left half plane from the y-axis of the x-y plane, the articulate arm 8812 has very short arm length making a very big difference in arm radius so that much larger magnitude of inertial twisting moment (torsion) is made on the hollow rotational shaft 800. Depending on the magnitude of the required total inertial twisting moment of the hollow or solid rotating shaft 800 to rotate the pre-decided number L of 3-φ electric power generators, the required pair of the articulated arms are calculated and the required length of the hollow or solid rotating shaft 800 is also a design parameter in addition to the weight parameter of the heavy steel sphere 88116. The articulate arm 8811 has, for example, a fixed arm 88111, first link 88112 and second link 88113. FIG. 32 discloses the detailed structure of the fixed arm 88111, first articulated arm 88112 and second articulated arm 88113. The fixed arm 88111 is a channel shape having two sidewalls and a bottom. The bottom of the fixed arm 88111 supports the weights of the first link 88112, the second link 88113 and the steel sphere 88116. The two sidewalls 881111 and 881112 have pivot holes 88116 and 88117. A fixed arm pivot shaft 88114 passes through the two pivot holes 88116 and 88117 for allowing angular rotation of the first link 88111. The second link 88112 has also two sidewalls 88120 and 88121. The two sidewalls 88120 and 88121have pivot holes 88118 and 88119. A second link pivot shaft 88115 passes through the two pivot holes 88118 and 88119 for allowing angular rotation of the second link 88113. The structure of the articulate arm 8812 has the same structure as the structure of the articulate arm 8811 but is rotated 180-degree with respect to the center of rotation of the hollow or solid rotating shaft 800 and the first link and second link and steel sphere is aligned to the direction of the gravitational force. Each of the steel spheres 88116 is connected to the end of the second link 88113 and the second link 88113 is stretched forming the twisting-moment-arm of the hollow or solid rotating shaft 800. However when the fixed arm 88111 is rotated 180-degree clockwise with respect to the center of the hollow or solid rotating shaft 800 to the position of the fixed arm 88121, the gravitational force acting on the steel sphere makes the first link 88122 and the second link 88123 to be rotated by 90-degree counter-clockwise with respect to each pivot shafts of the first link 88122 and the second link 88123 and is vertically aligned as disclosed in FIG. 31.

In FIG. 31, the hollow or solid rotating shaft 800 has a limited number N (N=1, 2, . . . , limited number) of vertically perpendicular planes where each of the limited number N of vertically perpendicular plane has a pair of articulate arms 8811 and 8812 (next vertically perpendicular plane has a pair of articulate arms 8821 and 8822, then 8831 and 8832, . . . ) to satisfy a required total torque of the pre-decided number L of 3-φ electric power generators 50 driven by the hollow or solid rotating shaft 800 and the length of the hollow or solid rotating shaft 800 extends to accommodate the limited number N (N=1, 2, . . . , limited number) of units of the exemplary two articulate arms 8811 and 8812. The supporting structures withstanding the total centrifugal forces are same as the previous embodiments and bending moments of the hollow or solid rotating shaft 800 are measured by a number M of strain gauges and piezoelectric strain sensors fixed on the hollow or solid rotating shaft 800 to measure the elongations of the hollow or solid rotating shaft 800 by the centrifugal force and twisting displacements of the hollow or solid rotating shaft 800 by the torque applied to the hollow or solid rotating shaft 800. Each pair of strain gauge and piezoelectric stain sensor of the predefined number M of strain gauges and piezoelectric strain sensors are fixed along the same circumferential circle at the middle point of the rotational axis of the hollow or solid rotating shaft 800 and outsides of the predefined number M of hollow frustoconical housings 8 sensing the time histories of the elongations of the hollow or solid rotating shaft 800 by the centrifugal force creating the bending moments of the hollow or solid rotating shaft 800 around the hollow housings 8 and sensing the twisting displacements of the hollow or solid rotating shaft 800 by the torque applied to the hollow or solid rotating shaft 800. Both centers of each strain gauge and each piezoelectric strain sensor are fixed along the circumferential circle at the middle length position of the hollow or solid rotating shaft 800but the axial sensing direction of the strain gauge and circumferential sensing direction of the piezoelectric strain sensor are perpendicular. The strain gauge fixed along the circumferential circle on the outer surface of the hollow or solid rotating shaft 800 measures the elongations of the hollow or solid rotating shaft 800 by the centrifugal force and the piezoelectric strain sensor along the circumferential circle measures the twisting displacements of the hollow or solid rotating shaft 800 at the middle length position of the hollow or solid rotating shaft 800 by the twisting torque applied to the hollow or solid rotating shaft 800. The locations of both strain gauge and piezoelectric strain sensor are at any location along the circumferential circle at the middle of the hollow or solid rotating shaft 800. The strain gauge outputs and the piezoelectric strain sensor outputs are signal conditioned, amplified and compared to the allowable threshold strain value to compute the strain error to be used in the dual closed-loop feedback servo-controller in FIG. 4 or the LQG/LQR closed-loop feedback servo-controller in a textbook, authored by Katsuhiko Ogata. The measured output signals from each of the strain gauges and piezoelectric strain sensors are sampled and a data logger stores the sampled data every time interval, every second, to the SSD drive and taking the Fourier transform of the stored measurement signals from the SSD drive for each encoder and tachometer, rotary torque sensor, accelerometers, the strain gauges and piezoelectric strain sensors and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder and tachometer equal to the desired angular velocity, the measured output signals from each rotary torque sensor close to the desired torque, the measured output signals from each accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known (e.g., Katsuhiko Ogata, Bernard Friedland) and are not explained here, and the dynamic system of the GFAMIT system is different and unique from the others. The limited number M of strain gauges and piezoelectric strain sensors measure the elongations of the hollow or solid rotating shaft 800 by the centrifugal force and twisting displacements of the hollow or solid rotating shaft 800 by the torque applied to the hollow or solid rotating shaft 800.

Unlike a conventional turbine having a zero-energy state initial position without any rotational energy, the initial position of the GFAMIT turbine system has a potential energy which creates an initial twisting moment to rotate the hollow or solid rotating shaft 800. Therefore, a stopper or braking system is needed to keep the GFAMIT turbine system on hold when not in use. The hollow cylindrical shaft 800 is in a stopped position applying brake force on the hollow or solid rotating shaft 800. The length of the rotating link 81120 and 81130 and the weight of the steel spheres 81140 are design parameters.

The slant beams 20 in FIG. 5 and the plurality of feet 331 withstands the total centrifugal force.

A flywheel disk and brake system 300 in FIG. 2 is connected to one end of the hollow or solid rotating shaft 800 to stop the rotation of the hollow or solid rotating shaft 800.

The proximal end of each slant beam of the plurality of slant beams 20 having a foot 331 has a hinge to rotate and adapt and be fastened to a plurality of related body frames of an engine compartment of a vehicle and the foot 331 at the distal end of the slant beam has a plurality of slotted holes for fasteners to be inserted and fastened.

The horizontal frames 21, 22-28 and vertical frames 29 and 31 and each slant beam of the plurality of slant beams 20 having a foot 331 are fixed with the body frames of the engine compartment of a vehicle.

The resultant centrifugal force vector F induced by the variable or articulate twisting-moment-arms fixed or welded on the hollow or solid rotating shaft 1 is pointed toward the forward direction of the vehicle and the resultant centrifugal force vector F rotates the wheels of the vehicle and contributes to propel the vehicle forward.

The vehicle is an engine-equipped car, electric car, engine-equipped truck, electric truck, train, ship, submarine, aircraft, low orbit communications satellite, or winged spacecraft orbiting an Earth orbit below the geosynchronous orbit.

The 3-φ output power generated by the pre-decided number L of 3-φ electric power generators 8000 is directly supplied to the electric motor of the electric car or electric truck, or the 3-φ output power generated by the pre-decided number L of 3-φ electric power generators 8000 is supplied to the battery packs of the vehicle, wherein the vehicle is an engine-equipped car, electric car, engine-equipped truck, electric truck, train, ship, submarine, aircraft, low orbit communications satellite, or winged spacecraft orbiting an Earth orbit below the geosynchronous orbit.

### Embodiment 11 (FIGS. 1-14, 30-32)

Each hollow housing of the predefined number M of hollow housings is an elliptical hollow-orbit-guide 860 in FIG. 31 containing a rotation center of a hollow cylindrical shaft 800 eccentrically located at a left focal point A and the limited number N of articulate twisting-moment-arms are a limited number N of articulate arms 8811 wherein each articulate arm of the limited number N of articulate arms 8811 has the limited number N of fixed arms 88111 on the outer surface of the hollow cylindrical shaft 800, and the limited number N of first connecting rods 88112 and second connecting rods 88113 and the limited number N of the steel spheres 88116, wherein the hollow cylindrical shaft 800 has the limited number N of articulate arms 8811 within each of a number M of circular orbit guides 860.

Each steel sphere 88116 is fixed to each distal end of each second connecting rod 88113.

Each proximal end of each second connecting rod 88113 rotates with respect to a pivot bolt 88115 and the axis of pivoting motion is perpendicular to the longitudinal axis of the first connecting rod 88112 and the second connecting rod 88113 connected by the pivot bolt 88115, wherein the distal end of each first connecting rod 88112 and the proximal end of each second connecting rod 88113 are pivoting with respect to the pivot bolt 88115 and the axis of pivoting motion is perpendicular to the longitudinal axis of the first connecting rod and the second connecting rod connected together by the pivot bolt 88115.

The distal end of each first connecting rod 88112 prohibits each second connecting rod 88113 from rotating more than 180° from the horizontal axis passing through the rotational axis of the hollow cylindrical shaft 800 after passing the 3 O'clock direction and creates maximal inertial twisting moment acting on the center of the steel spheres 88116 and the gravity force acting on the second connecting rod 88113 and the first connecting rod 88112.

The proximal end of each first connecting rod 88112 and the proximal end of each fixed arm 88111 are connected by a pivot bolt 88114 and the distal end of each fixed arm 88111 prohibits each first connecting rod 88112 from rotating more than 180° from the horizontal axis passing through the rotational axis of the hollow cylindrical shaft 800 after passing the 3 O'clock direction and creates maximal inertial twisting moment acting on the center of the steel spheres 88118 and the gravity force acting on the second connecting rod 8113 and the first connecting rod 8112.

The limited number N/2 pairs of fixed arms 88111 and 88121 on a straight line passing through the hollow cylindrical shaft 800 and welded at opposite positions having 180° angular displacement are welded on a straight line passing through the hollow cylindrical shaft 800 and opposite positions having 180° angular displacement and each pair of fixed arms is welded along a spiral circumference on the hollow cylindrical shaft 800.

Each rotating plane of the limited N/2 rotating planes having a pair of articulate arms 8811 and 8812, the steel spheres 88116 fixed to the distal ends of each second connecting rods 88113 and 88123 drop along the gravitational force of the Earth without any overlapping or entangling over the previously lower articulate arm 8811 in the left half plane of the rotational plane.

The total inertial twisting moment of the limited N/2 pair of articulate arms 8811 and 8812 satisfy a required total torque of the pre-decided number L of 3-electric power generators 8000 driven by the hollow cylindrical shaft 800 and the length of the hollow cylindrical shaft 800 extends to accommodate the limited number N/2 pairs of the articulate arms 8811 and 8812 in each elliptical hollow-orbit-guide 860 of the number M of elliptical hollow orbit-guides 860.

The hollow cylindrical shaft 800 is in a stopped position applying brake force on the radial surface of the circular flywheel disk 40 with the pre-selected number I pairs of braking shoes 41 and placing the pre-determined number j of anchor arms 57 to locking positions.

The limited number N/2 pair of articulated arms are calculated and the required length of the hollow or solid rotating shaft 800 is also calculated in terms of the magnitude of the required total inertial twisting moment of the hollow or solid rotating shaft 800 and the required torque load to rotate the pre-decided number L of 3-φ electric power generators 8000.

The fixed arm 88111 is a channel shape having two sidewalls and a bottom and the bottom of the fixed arm 88111 supports the weights of the first link 88112, the second link 88113 and the steel sphere 88116.

The two sidewalls 881111 and 881112 have pivot holes 88116 and 88117 and a fixed arm pivot shaft 88114 passes through the two pivot holes 88116 and 88117 for allowing angular rotation of the first link 88111.

The second link 88112 has two sidewalls 88120 and 88121, and the two sidewalls 88120 and 88121 have pivot holes 88118 and 88119, and a second link pivot shaft 88115 passes through the two pivot holes 88118 and 88119 for allowing angular rotation of the second link 88113, and the structure of the articulate arm 8812 has the same structure as the structure of the articulate arm 8811 but is overturned by rotating 180-degree with respect to the rotation axis of the hollow or solid rotating shaft 800 and the first link and second link and steel sphere is aligned to the direction of the gravitational force when the hollow or solid rotating shaft 800 is stationary, and
wherein the first link and second link and steel sphere are radially stretched and aligned when the hollow or solid rotating shaft 800 rotates.

The proximal end of each slant beam of the plurality of slant beams 20 having a foot 331 has a hinge to rotate and adapt and be fastened to a plurality of related body frames of an engine compartment of a vehicle and the foot 331 at the distal end of the slant beam has a plurality of slotted holes for fasteners to be inserted and fastened.

The horizontal frames 21, 22-28 and vertical frames 29 and 31 and each slant beam of the plurality of slant beams 20 having a foot 331 are fixed with the body frames of the engine compartment of a vehicle.

The resultant centrifugal force vector F induced by the variable or articulate twisting-moment-arms fixed or welded on the hollow or solid rotating shaft 1 is pointed toward the forward direction of the vehicle and the resultant centrifugal force vector F rotates the wheels of the vehicle and contributes to propel the vehicle forward.

The vehicle is an engine-equipped car, electric car, engine-equipped truck, electric truck, train, ship, submarine, aircraft, low orbit communications satellite, or winged spacecraft orbiting an Earth orbit below the geosynchronous orbit.

The 3-φ output power generated by the pre-decided number L of 3-φ electric power generators 8000 is directly supplied to the electric motor of the electric car or electric truck, or the 3-φ output power generated by the pre-decided number L of 3-φ electric power generators 8000 is supplied to the battery packs of the vehicle, wherein the vehicle is an engine-equipped car, electric car, engine-equipped truck, electric truck, train, ship, submarine, aircraft, low orbit communications satellite, or winged spacecraft orbiting an Earth orbit below the geosynchronous orbit.

In FIG. 31, the hollow or solid rotating shaft 800 has a limited number N (N=1, 2, . . . , limited number) of vertically perpendicular planes where each of the limited number N of vertically perpendicular plane has a pair of articulate arms 8811 and 8812 (next vertically perpendicular plane has a pair of articulate arms 8821 and 8822, then 8831 and 8832, . . . ) to satisfy a required total torque of the pre-decided number L of 3-φ electric power generators 50 driven by the hollow or solid rotating shaft 800 and the length of the hollow or solid rotating shaft 800 extends to accommodate the limited number N (N=1, 2, . . . , limited number) of units of the exemplary two articulate arms 8811 and 8812. The supporting structures withstanding the total centrifugal forces are same as the previous embodiments and bending moments of the hollow or solid rotating shaft 800 are measured by a number M of strain gauges and piezoelectric strain sensors fixed on the hollow or solid rotating shaft 800 to measure the elongations of the hollow or solid rotating shaft 800 by the centrifugal force and twisting displacements of the hollow or solid rotating shaft 800 by the torque applied to the hollow or solid rotating shaft 800. Each pair of strain gauge and piezoelectric stain sensor of the predefined number M of strain gauges and piezoelectric strain sensors are fixed along the same circumferential circle at the middle point of the rotational axis of the hollow or solid rotating shaft 800 and outsides of the predefined number M of hollow frustoconical housings 8 sensing the time histories of the elongations of the hollow or solid rotating shaft 800 by the centrifugal force creating the bending moments of the hollow or solid rotating shaft 800 around the hollow housings 8 and sensing the twisting displacements of the hollow or solid rotating shaft 800 by the torque applied to the hollow or solid rotating shaft 800. Both centers of each strain gauge and each piezoelectric strain sensor are fixed along the circumferential circle at the middle length position of the hollow or solid rotating shaft 800but the axial sensing direction of the strain gauge and circumferential sensing direction of the piezoelectric strain sensor are perpendicular. The strain gauge fixed along the circumferential circle on the outer surface of the hollow or solid rotating shaft 800 measures the elongations of the hollow or solid rotating shaft 800 by the centrifugal force and the piezoelectric strain sensor along the circumferential circle measures the twisting displacements of the hollow or solid rotating shaft 800 at the middle length position of the hollow or solid rotating shaft 800 by the twisting torque applied to the hollow or solid rotating shaft 800. The locations of both strain gauge and piezoelectric strain sensor are at any location along the circumferential circle at the middle of the hollow or solid rotating shaft 800. The strain gauge outputs and the piezoelectric strain sensor outputs are signal conditioned, amplified and compared to the allowable threshold strain value to compute the strain error to be used in the dual closed-loop feedback servo-controller in FIG. 4 or the LQG/LQR closed-loop feedback servo-controller in a textbook, authored by Katsuhiko Ogata. The measured output signals from each of the strain gauges and piezoelectric strain sensors are sampled and a data logger stores the sampled data every time interval, every second, to the SSD drive and taking the Fourier transform of the stored measurement signals from the SSD drive for each encoder and tachometer, rotary torque sensor, accelerometers, the strain gauges and piezoelectric strain sensors and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder and tachometer equal to the desired angular velocity, the measured output signals from each rotary torque sensor close to the desired torque, the measured output signals from each accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known (e.g., Katsuhiko Ogata, Bernard Friedland) and are not explained here, and the dynamic system of the GFAMIT system is different and unique from the others. The limited number M of strain gauges and piezoelectric strain sensors measure the elongations of the hollow or solid rotating shaft 800 by the centrifugal force and twisting displacements of the hollow or solid rotating shaft 800 by the torque applied to the hollow or solid rotating shaft 800.

### Embodiment 12 (FIGS. 1-15, 31~32)

Each hollow housing of the predefined number M of hollow housings is an integrated semi-circular and quasi-semi-circular hollow-orbit-guide 820 consisting of a semi-circular hollow-orbit-guide 840 and a quasi-semi-circular hollow-orbit-guide 850 and the limited number N of articulate twisting-moment-arms are a limited number N of articulate arms 8811 within each of a number M of integrated semi-circular and quasi-semi-circular hollow orbit-guides 820 having a rotation axis of the hollow cylindrical shaft 800 at the middle of the diameter of the semi-circular hollow-orbit-guide 840 co-locating the origin of the X-Y Cartesian coordinate system. The geometric center of the quasi-semi-circular hollow-orbit-guide 820 is centered at the end B of the fixed arm 88111, and the hollow cylindrical shaft 800 has a limited number N of articulate arms 8811 within each of a number M of integrated semi-circular and quasi-semi-circular hollow-orbit-guide 820.

The semi-circular orbit-guide 840 has a radius R_{R} and the quasi-semi-circular hollow-orbit-guide 850 has a radius R_{L} and the rotation center of the hollow cylindrical shaft 800 is placed at the middle of the diameter of the semi-circular orbit-guide 840 and the center of the quasi-semi-circular hollow-orbit-guide 850 is located at the distal end B of the first connecting rod 88111, and the radius R_{L} is larger than the radius R_{R}, and the ends of the semi-circular hollow-orbit-guide 840 are welded together with the ends of the quasi-semi-circular hollow-orbit-guide 850 forming an integrated semi-circular and quasi-semi-circular hollow-orbit-guide 820.

Each articulate arm of the limited number N of articulate arms 8811 has the limited number N of fixed arms 88111 on the outer surface of the hollow cylindrical shaft 800, and the limited number N of first connecting rods 81120 and second connecting rods 81130 and the limited number N of the steel spheres 81140.

Each steel sphere 88116 is fixed to each distal end of each second connecting rod 88113, wherein each proximal end of each second connecting rod 88113 rotates with respect to a pivot bolt 88115 and the axis of pivoting motion is perpendicular to the longitudinal axis of the first connecting rod 88112 and the second connecting rod 88113 connected by the pivot bolt 88115.

The distal end of each first connecting rod 88112 and the proximal end of each second connecting rod 88113 are pivoting with respect to the pivot bolt 88115 and the axis of pivoting motion is perpendicular to the longitudinal axis of the first connecting rod 88112 and the second connecting rod 88113 connected together by the pivot bolt 88115.

The distal end of each first connecting rod 88112 prohibits each second connecting rod 88113 from rotating more than 180° from the horizontal axis passing through the rotational axis of the hollow cylindrical shaft 800 after passing the 3 O'clock direction and creates maximal inertial twisting moment acting on the center of the steel spheres 88116 and the gravity force acting on the second connecting rod 88113 and the first connecting rod 88112.

The proximal end of each first connecting rod 8112 and the proximal end of each fixed arm 8111 are connected by a pivot bolt 88114 and the distal end of each fixed arm 8111 prohibits each first connecting rod 8112 from rotating more than 180° from the horizontal axis passing through the rotational axis of the hollow cylindrical shaft 800 after passing the 3 O'clock direction and creates maximal inertial twisting moment acting on the center of the steel spheres 8114 and the gravity force acting on the second connecting rod 8113 and the first connecting rod 8112 and the fixed arm 8111.

The limited number N/2 pair of fixed arms 88111 and 88121 are welded on a straight line passing through the hollow cylindrical shaft 800 and welded at the opposite positions having 180° angular displacement along a spiral circumference on the hollow cylindrical shaft 800 to avoid limited number N/2 pair of fixed arms 8811 and 8812 and the steel sphere 88116 fixed to the distal end of each second connecting rod 88113 to overlap or entangle over the lower articulate arms in the left half plane of the rotational plane.

The total inertial twisting moment of the articulate arms 8811 and 8812 satisfy a required total torque of the pre-decided number L of 3-φ electric power generators 8000 driven by the hollow cylindrical shaft 800 and the length of the hollow cylindrical shaft 800 extends to accommodate the limited number N/2 pairs of the articulate arms 8811 and 8812 in each of the number M/2 pairs of integrated semi-circular and quasi-semi-circular hollow orbit-guides 820.

The hollow cylindrical shaft 800 is in a stopped position applying brake force on the radial surface of the circular flywheel disk 40 with the pre-selected number I pairs of braking shoes 41 and placing the pre-determined number j of anchor arms 57 to locking positions.

The limited number N/2 of articulated arms 8811 and 8812 are calculated and the required length of the hollow or solid rotating shaft 800 is also calculated in terms of the magnitude of the required total inertial twisting moment of the hollow or solid rotating shaft 800 and the required torque load to rotate the pre-decided number L of 3-φ electric power generators 8000.

The fixed arm 88111 is a channel shape having two sidewalls 881111 and 881112 and a bottom and the bottom of the fixed arm 88111 supports the weights of the first link 88112, the second link 88113 and the steel sphere 88116.

The two sidewalls 881111 and 881112 have pivot holes 88116 and 88117 and a fixed arm pivot shaft 88114 passes through the two pivot holes 88116 and 88117 for allowing angular rotation of the first link 88111, wherein the second link 88112 has two sidewalls 88120 and 88121, and the two sidewalls 88120 and 88121 have pivot holes 88118 and 88119.

A second link pivot shaft 88115 passes through the two pivot holes 88118 and 88119 for allowing angular rotation of the second link 88113, and the structure of the articulate arm 8812 has the same structure as the structure of the articulate arm 8811 but is overturned by rotating 180-degree with respect to the center of rotation of the hollow or solid rotating shaft 800 and the first link and second link and steel sphere are aligned to the direction of the gravitational force when the hollow or solid rotating shaft 800 is stationary, and wherein the first link 88112 and second link 88113 and steel sphere 88116 are radially stretched and aligned when the hollow or solid rotating shaft 800 rotates.

The proximal end of each slant beam of the plurality of slant beams 20 having a foot 331 has a hinge to rotate and adapt and be fastened to a plurality of related body frames of an engine compartment of a vehicle and the foot 331 at the distal end of the slant beam has a plurality of slotted holes for fasteners to be inserted and fastened.

The horizontal frames 21, 22-28 and vertical frames 29 and 31 and each slant beam of the plurality of slant beams 20 having a foot 331 are fixed with the body frames of the engine compartment of a vehicle.

The resultant centrifugal force vector F induced by the variable or articulate twisting-moment-arms fixed or welded on the hollow or solid rotating shaft 1 is pointed toward the forward direction of the vehicle and the resultant centrifugal force vector F rotates the wheels of the vehicle and contributes to propel the vehicle forward.

In FIG. 31, the hollow or solid rotating shaft 800 has a limited number N (N=1, 2, . . . , limited number) of vertically perpendicular planes where each of the limited number N of vertically perpendicular plane has a pair of articulate arms 8811 and 8812 (next vertically perpendicular plane has a pair of articulate arms 8821 and 8822, then 8831 and 8832, . . . ) to satisfy a required total torque of the pre-decided number L of 3-φ electric power generators 50 driven by the hollow or solid rotating shaft 800 and the length of the hollow or solid rotating shaft 800 extends to accommodate the limited number N (N=1, 2, . . . , limited number) of units of the exemplary two articulate arms 8811 and 8812. The supporting structures withstanding the total centrifugal forces are same as the previous embodiments and bending moments of the hollow or solid rotating shaft 800 are measured by a number M of strain gauges and piezoelectric strain sensors fixed on the hollow or solid rotating shaft 800 to measure the elongations of the hollow or solid rotating shaft 800 by the centrifugal force and twisting displacements of the hollow or solid rotating shaft 800 by the torque applied to the hollow or solid rotating shaft 800. Each pair of strain gauge and piezoelectric stain sensor of the predefined number M of strain gauges and piezoelectric strain sensors are fixed along the same circumferential circle at the middle point of the rotational axis of the hollow or solid rotating shaft 800 and outsides of the predefined number M of hollow frustoconical housings 8 sensing the time histories of the elongations of the hollow or solid rotating shaft 800 by the centrifugal force creating the bending moments of the hollow or solid rotating shaft 800 around the hollow housings 8 and sensing the twisting displacements of the hollow or solid rotating shaft 800 by the torque applied to the hollow or solid rotating shaft 800. Both centers of each strain gauge and each piezoelectric strain sensor are fixed along the circumferential circle at the middle length position of the hollow or solid rotating shaft 800but the axial sensing direction of the strain gauge and circumferential sensing direction of the piezoelectric strain sensor are perpendicular. The strain gauge fixed along the circumferential circle on the outer surface of the hollow or solid rotating shaft 800 measures the elongations of the hollow or solid rotating shaft 800 by the centrifugal force and the piezoelectric strain sensor along the circumferential circle measures the twisting displacements of the hollow or solid rotating shaft 800 at the middle length position of the hollow or solid rotating shaft 800 by the twisting torque applied to the hollow or solid rotating shaft 800. The locations of both strain gauge and piezoelectric strain sensor are at any location along the circumferential circle at the middle of the hollow or solid rotating shaft 800. The strain gauge outputs and the piezoelectric strain sensor outputs are signal conditioned, amplified and compared to the allowable threshold strain value to compute the strain error to be used in the dual closed-loop feedback servo-controller in FIG. 4 or the LQG/LQR closed-loop feedback servo-controller in a textbook, authored by Katsuhiko Ogata. The measured output signals from each of the strain gauges and piezoelectric strain sensors are sampled and a data logger stores the sampled data every time interval, every second, to the SSD drive and taking the Fourier transform of the stored measurement signals from the SSD drive for each encoder and tachometer, rotary torque sensor, accelerometers, the strain gauges and piezoelectric strain sensors and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder and tachometer equal to the desired angular velocity, the measured output signals from each rotary torque sensor close to the desired torque, the measured output signals from each accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known (e.g., Katsuhiko Ogata, Bernard Friedland) and are not explained here, and the dynamic system of the GFAMIT system is different and unique from the others. The limited number M of strain gauges and piezoelectric strain sensors measure the elongations of the hollow or solid rotating shaft 800 by the centrifugal force and twisting displacements of the hollow or solid rotating shaft 800 by the torque applied to the hollow or solid rotating shaft 800.

The vehicle is an engine-equipped car, electric car, engine-equipped truck, electric truck, train, ship, submarine, aircraft, low orbit communications satellite, or winged spacecraft orbiting an Earth orbit below the geosynchronous orbit.

The 3-φ output power generated by the pre-decided number L of 3-φ electric power generators 8000 is directly supplied to the electric motor of the electric car or electric truck, or the 3-φ output power generated by the pre-decided number L of 3-φ electric power generators 8000 is supplied to the battery packs of the vehicle, wherein the vehicle is an engine-equipped car, electric car, engine-equipped truck, electric truck, train, ship, submarine, aircraft, low orbit communications satellite, or winged spacecraft orbiting an Earth orbit below the geosynchronous orbit.

### Embodiment 13 (FIGS. 1-14, 30~32)

Each hollow housing of the predefined number M of hollow housings is an integrated semi-circular and semi-elliptical hollow-orbit-guide 890 consisting of a semi-circular hollow-orbit-guide 840 and a semi-elliptical hollow-orbit-guide 880 and the limited number N of articulate twisting-moment-arms are a limited number N of articulate arms 8811 within each of a number M of integrated semi-circular and semi-elliptical hollow-orbit-guide 890 having a rotation axis of the hollow cylindrical shaft 800 at the middle of the diameter of the semi-circular hollow-orbit-guide 840 co-locating the origin of the X-Y Cartesian coordinate system.

The elliptical hollow-orbit-guide 880 has upper focal point C and lower focal point D and the geometric center A of the semi-elliptical hollow-orbit-guide 880 is centered at the middle of the major axis of the semi-elliptical hollow-orbit-guide 880 same as the middle of the diameter of the semi-circular hollow-orbit-guide 840, and the hollow cylindrical shaft 800 has a limited number N of articulate arms 8811 within each of a number M of integrated semi-circular and semi-elliptical hollow-orbit-guide 890.

The semi-circular orbit-guide 840 has a radius R_{R} and the semi-elliptical hollow-orbit-guide 880 has a minor axis length R_{L} and the rotation center of the hollow cylindrical shaft 800 is placed at the middle of the diameter of the semi-circular orbit-guide 840 and the middle of the major axis of the semi-elliptical hollow-orbit-guide 880, and the minor axis length R_{L} is shorter than the radius R_{R}, and the ends of the semi-circular orbit-guide 840 are welded together with the ends of the semi-elliptical hollow-orbit-guide 880 forming an integrated semi-circular and the semi-elliptical hollow-orbit-guide 890.

Each articulate arm of the limited number N of articulate arms 810 has the limited number N of fixed arms 88111 on the outer surface of the hollow cylindrical shaft 800, and the limited number N of first connecting rods 88112 and second connecting rods 88113, and the limited number N of the steel spheres 88116.

Each steel sphere 88116 is fixed to each distal end of each second connecting rod 88113, and each proximal end of each second connecting rod 88113 rotates with respect to a pivot bolt 88115 and the axis of pivoting motion is perpendicular to the longitudinal axis of the first connecting rod 88112 and the second connecting rod 88113 connected by the pivot bolt 88115.

The distal end of each first connecting rod 8112 and the proximal end of each second connecting rod 8113 are pivoting with respect to the pivot bolt 88115 and the axis of pivoting motion is perpendicular to the longitudinal axis of the first connecting rod 88112 and the second connecting rod 88113 connected together by the pivot bolt 88114.

The distal end of each first connecting rod 88112 prohibits each second connecting rod 88113 from rotating more than 180° from the horizontal axis passing through the rotational axis of the hollow cylindrical shaft 800 after passing the 3 O'clock direction and creates maximal inertial twisting moment acting on the center of the steel spheres 88116 and the gravity force acting on the second connecting rod 88113 and the first connecting rod 88112.

The proximal end of each first connecting rod 88112 and the proximal end of each fixed arm 88111 are connected by a pivot bolt 88114 and the distal end of each fixed arm 8111 prohibits each first connecting rod 88112 from rotating more than 180° from the horizontal axis passing through the rotational axis of the hollow cylindrical shaft 800 after passing the 3 O'clock direction and creates maximal inertial twisting moment acting on the center of the steel spheres 88116 and the gravity force acting on the second connecting rod 88113 and the first connecting rod 88112.

The limited number N/2 pair of fixed arms 8811 and 8812 are welded on a straight line passing through the hollow cylindrical shaft 800 and welded at the opposite positions having 180° angular displacement along a spiral circumference on the hollow cylindrical shaft 800 to avoid limited number N/2 pair of fixed arms 8811 and 8812 and the steel sphere 88116 fixed to the distal end of each second connecting rod 88113 to overlap or entangle over the lower articulate arms in the left half plane of the rotational plane.

The total inertial twisting moment of the articulate arms 8811 and 8812 satisfy a required total torque of the pre-decided number L of 3-φ electric power generators 8000 driven by the hollow cylindrical shaft 800 and the length of the hollow cylindrical shaft 800 extends to accommodate the limited number N/2 pairs of the articulate arms 8811 and 8812 in each of the number M/2 pairs of integrated semi-circular and the elliptical hollow-orbit-guide 880.

The hollow cylindrical shaft 800 is in a stopped position applying brake force on the radial surface of the circular flywheel disk 40 with the pre-selected number I pairs of braking shoes 41 and placing the pre-determined number j of anchor arms 57 to locking positions.

The limited number N/2 of articulated arms 8811 and 8812 are calculated and the required length of the hollow or solid rotating shaft 800 is also calculated in terms of the magnitude of the required total inertial twisting moment of the hollow or solid rotating shaft 800 and the required torque load to rotate the pre-decided number L of 3-φ electric power generators 8000.

The fixed arm 88111 is a channel shape having two sidewalls 881111 and 881112 and a bottom and the bottom of the fixed arm 88111 supports the weights of the first link 88112, the second link 88113 and the steel sphere 88116.

The two sidewalls 881111 and 881112 have pivot holes 88116 and 88117 and a fixed arm pivot shaft 88114 passes through the two pivot holes 88116 and 88117 for allowing angular rotation of the first link 88111, wherein the second link 88112 has two sidewalls 88120 and 88121, and the two sidewalls 88120 and 88121 have pivot holes 88118 and 88119.

A second link pivot shaft 88115 passes through the two pivot holes 88118 and 88119 for allowing angular rotation of the second link 88113, and the structure of the articulate arm 8812 has the same structure as the structure of the articulate arm 8811 but is overturned by rotating 180-degree with respect to the center of rotation of the hollow or solid rotating shaft 800 and the first link 88112 and second link 88113 and steel sphere 88116 are aligned to the direction of the gravitational force when the hollow or solid rotating shaft 800 is stationary, and
wherein the first link 88112 and second link 88113 and steel sphere 88116 are radially stretched and aligned when the hollow or solid rotating shaft 800 rotates.

The proximal end of each slant beam of the plurality of slant beams 20 having a foot 331 has a hinge to rotate and adapt and be fastened to a plurality of related body frames of an engine compartment of a vehicle and the foot 331 at the distal end of the slant beam has a plurality of slotted holes for fasteners to be inserted and fastened.

The horizontal frames 21, 22-28 and vertical frames 29 and 31 and each slant beam of the plurality of slant beams 20 having a foot 331 are fixed with the body frames of the engine compartment of a vehicle.

The resultant centrifugal force vector F induced by the variable or articulate twisting-moment-arms fixed or welded on the hollow or solid rotating shaft 1 is pointed toward the forward direction of the vehicle and the resultant centrifugal force vector F rotates the wheels of the vehicle and contributes to propel the vehicle forward.

The vehicle is an engine-equipped car, electric car, engine-equipped truck, electric truck, train, ship, submarine, aircraft, low orbit communications satellite, or winged spacecraft orbiting an Earth orbit below the geosynchronous orbit.

In FIG. 31, the hollow or solid rotating shaft 800 has a limited number N (N=1, 2, . . . , limited number) of vertically perpendicular planes where each of the limited number N of vertically perpendicular plane has a pair of articulate arms 8811 and 8812 (next vertically perpendicular plane has a pair of articulate arms 8821 and 8822, then 8831 and 8832, . . . ) to satisfy a required total torque of the pre-decided number L of 3-φ electric power generators 50 driven by the hollow or solid rotating shaft 800 and the length of the hollow or solid rotating shaft 800 extends to accommodate the limited number N (N=1, 2, . . . , limited number) of units of the exemplary two articulate arms 8811 and 8812. The supporting structures withstanding the total centrifugal forces are same as the previous embodiments and bending moments of the hollow or solid rotating shaft 800 are measured by a number M of strain gauges and piezoelectric strain sensors fixed on the hollow or solid rotating shaft 800 to measure the elongations of the hollow or solid rotating shaft 800 by the centrifugal force and twisting displacements of the hollow or solid rotating shaft 800 by the torque applied to the hollow or solid rotating shaft 800. Each pair of strain gauge and piezoelectric stain sensor of the predefined number M of strain gauges and piezoelectric strain sensors are fixed along the same circumferential circle at the middle point of the rotational axis of the hollow or solid rotating shaft 800 and outsides of the predefined number M of hollow frustoconical housings 8 sensing the time histories of the elongations of the hollow or solid rotating shaft 800 by the centrifugal force creating the bending moments of the hollow or solid rotating shaft 800 around the hollow housings 8 and sensing the twisting displacements of the hollow or solid rotating shaft 800 by the torque applied to the hollow or solid rotating shaft 800. Both centers of each strain gauge and each piezoelectric strain sensor are fixed along the circumferential circle at the middle length position of the hollow or solid rotating shaft 800but the axial sensing direction of the strain gauge and circumferential sensing direction of the piezoelectric strain sensor are perpendicular. The strain gauge fixed along the circumferential circle on the outer surface of the hollow or solid rotating shaft 800 measures the elongations of the hollow or solid rotating shaft 800 by the centrifugal force and the piezoelectric strain sensor along the circumferential circle measures the twisting displacements of the hollow or solid rotating shaft 800 at the middle length position of the hollow or solid rotating shaft 800 by the twisting torque applied to the hollow or solid rotating shaft 800. The locations of both strain gauge and piezoelectric strain sensor are at any location along the circumferential circle at the middle of the hollow or solid rotating shaft 800. The strain gauge outputs and the piezoelectric strain sensor outputs are signal conditioned, amplified and compared to the allowable threshold strain value to compute the strain error to be used in the dual closed-loop feedback servo-controller in FIG. 4 or the LQG/LQR closed-loop feedback servo-controller in a textbook, authored by Katsuhiko Ogata. The measured output signals from each of the strain gauges and piezoelectric strain sensors are sampled and a data logger stores the sampled data every time interval, every second, to the SSD drive and taking the Fourier transform of the stored measurement signals from the SSD drive for each tachometer, rotary torque sensor, accelerometers, the strain gauges and piezoelectric strain sensors and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder and tachometer equal to the desired angular velocity, the measured output signals from each rotary torque sensor close to the desired torque, the measured output signals from each accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known (e.g., Katsuhiko Ogata, Bernard Friedland) and are not explained here, and the dynamic system of the GFAMIT system is different and unique from the others. The limited number M of strain gauges and piezoelectric strain sensors measure the elongations of the hollow or solid rotating shaft 800 by the centrifugal force and twisting displacements of the hollow or solid rotating shaft 800 by the torque applied to the hollow or solid rotating shaft 800.

The 3-φ output power generated by the pre-decided number L of 3-φ electric power generators 8000 is directly supplied to the electric motor of the electric car or electric truck, or the 3-φ output power generated by the pre-decided number L of 3-φ electric power generators 8000 is supplied to the battery packs of the vehicle, wherein the vehicle is an engine-equipped car, electric car, engine-equipped truck, electric truck, train, ship, submarine, aircraft, low orbit communications satellite, or winged spacecraft orbiting an Earth orbit below the geosynchronous orbit.

### Fourteenth Embodiment (FIGS. 1-14, 33~34)

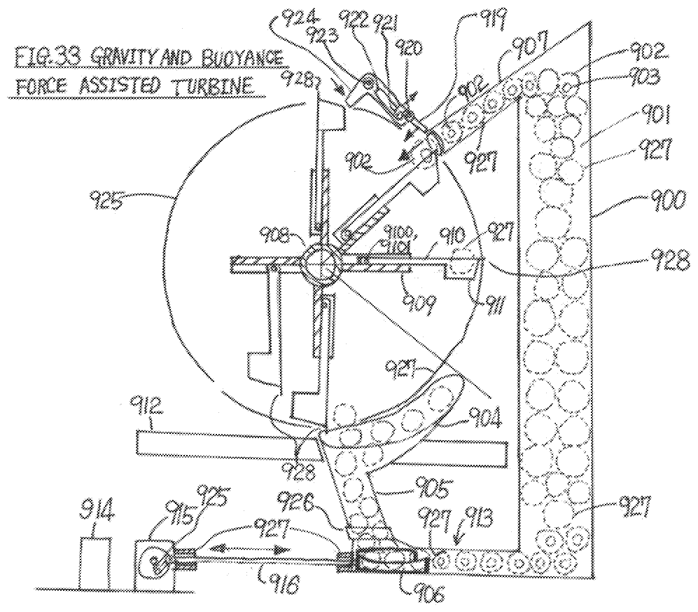

FIG. 33 discloses the ninth embodiment of a Gravity and Buoyance-Forces applied and Moment Imbalanced Turbine (GBFAMIT) driving a pre-decided number L of 3-φ electric power Generators.

A columnar liquid container 900 made of stainless steel sheet material is built by and close to and outside of a limited number N of pivoting elongated buckets 911. The columnar liquid container 900 is fixed with integrated support frames 912 of a hollow or solid rotating shaft 908. Each pivoting elongated bucket of the limited number N of pivoting elongated buckets 911 receives a flow of rubber-coated solid masses 927 consisting of an inner core mass 903, a Styrofoam surrounding mass 902, and a coated rubber layer wherein the Styrofoam surrounding mass 902 has a hollow spherical shape and the internal volume of the Styrofoam surrounding mass 902 is bigger than the total volume of the inner core mass 903. Instead of the hollow spherical shape of the Styrofoam surrounding mass 902, it can be a hollow columnal shape of a hollow square cross-sectional shape, hollow rectangular cross-sectional shape, or a closed cylindrical shape and the body of the Styrofoam surrounding mass 902 contains the inner core mass 903 and the body of the Styrofoam surrounding mass 902 has an empty space filled with ambient air or hydrogen or a vacuum space, and the outside of the Styrofoam surrounding mass 902 is coated with the coated rubber layer made of a rubber material wherein the inner core mass 903 is a spherical steel body.

a flow path of the rubber-coated solid masses 927 has a closed loop flow consisting of an upward flow and a downward flow, wherein the upward flow of the rubber-coated solid masses 927 is opposite to the gravitational force acting on each rubber-coated solid mass 927 inside the columnar liquid container 900 and the downward flow of the rubber-coated solid masses 927 is along the gravitational force inside the limited number N of pivoting elongated buckets 911.

The columnar liquid container 900 is filled with a buoyance liquid 901. The larger the density of the buoyance liquid 901 is, the larger the buoyance force is, e.g., a salt water of maximal concentration (26.3% salt concentration) of salt in the fresh water has stronger buoyance force than the buoyance of the fresh water and in this design is preferred to the fresh water.

The magnitude of buoyance force of each rubber-coated solid masse 927 is larger than the weight of the core mass 903 plus the weight of the surrounding mass 902 and the weight of the coated rubber. The density of the surrounding mass 902 is much lighter than the density of the core mass and the density of the coated rubber. In addition, the inner empty volume of the surrounding mass 902 outside of the inner core mass 903 is a design parameter to satisfy the buoyance force requirement in the buoyance liquid 901 wherein the density of the buoyance liquid 901 available or considered or selected is also a design parameter.

The magnitude of the buoyance force is 2~5 times bigger than the weight of the rubber-coated solid masses 927 so that when columnar water tank 900 is filled with the buoyance liquid 901 to the top liquid level 918 of the rubber-coated solid masses 927, the rubber-coated solid mass 927 overcomes the gravitational force and quickly floats up above the top liquid level 918.

The cross-sectional shape of a horizontal channel 913 matches with the cross-sectional outer contour of the rubber-coated solid mass 927 and makes a relatively tight seal preventing the leakage of the buoyance liquid 901 from the columnar liquid container 900.

The top end of the columnar liquid container 900 matches with the entrance shape of a dispensing channel 907 and there exists a very tiny gap between the exit muzzle of the dispensing channel 907 and the end tip of the pivoting elongated buckets 911 preventing the rubber-coated solid masses 927 from falling out of the pivoting elongated buckets 911.

A cylindrically hollow or solid rotating shaft 908 has the limited number N of fixed arms 909 and each fixed arm of the limited number N of fixed arms 909 has a channel shaped cross-sectional surface having two vertical walls between a bottom wall to form a channel shape and the proximal end of each fixed arm of the limited number N of fixed arms 909 is welded on and along a circular circumference on the outer surface of the cylindrically hollow shaft 908. The two vertical walls of each fixed arm of the limited number N of fixed arms 909 have a pair of pivot shaft holes 9101.

Each pivoting arm of the limited number N of pivoting arms 910 has a pivot shaft 9100 and a pivot shaft hole 9101 at the proximal end of each pivoting arm 910 and each pivoting elongated buckets 911 is fixed at the distal end of each pivoting arm 910. The pivot shaft 9100 passes through the pair of pivot shaft holes 9101 on the two vertical walls of each fixed arm of the limited number N of fixed arms 909 and the pivot shaft hole 9101 at the proximal end of each pivoting arm 910. The bottom wall of each fixed arm of the limited number N of fixed arms 909 prevents each pivoting arm 910 from rotating more than 180° from the axis passing through the rotational center of the cylindrically hollow or solid rotating shaft 908 and supports each pivoting arm 910 horizontally stretched and increases the rotational arm of each pivoting elongated buckets 911.

The cylindrically hollow or solid rotating shaft 908 has a predefined number M (M=1, 2, . . . , a predefined number, e.g., M=1) of vertically perpendicular planes where each vertically perpendicular plane of the limited number M of vertically perpendicular plane has the limited number N of fixed arms 909 and pivoting arms 910 to satisfy a required total torque for rotation of the pre-decided number L of 3-φelectric power generators 8000 driven by the cylindrically hollow or solid rotating shaft 908 and the length of the hollow or solid rotating shaft 908 extends to accommodate the total number M×N of articulate arms.

The pivoting elongated buckets 911 is tapered for easy discharge of the rubber-coated solid masses 927 into a mouth-elongated funnel 904 and easy receiving of the rubber-coated solid masses 927 dropping out of the muzzle of the dispensing channel 907.

A protruded end tip 928 of each pivoting elongated buckets 911 pushes down the left end of an L-shaped link 924 and makes counterclockwise pivotal rotation with respect to a L-shaped link shaft 923. The lower end of the L-shaped link 924 has an elongated slot 922 wherein the elongated slot 922 contains a perpendicular link pin 921 fixed at the upper end of a straight link 919 and the straight link 919 makes clockwise pivoting with respect to a straight link pivot shaft 920 and the lower distal end of the straight link 919 holds and blocks the rubber-coated solid mass 927 dropping out of the muzzle of the dispensing channel 907 when the L-shaped link 924 is not pushed by the protrude end tip 928. When the upper distal end of the L-shaped link 924 is pushed by the protruded end tip 928 of each pivoting elongated buckets 911, the straight link 919 opens to release the rubber-coated solid mass 927 out of the muzzle of the dispensing channel 907. The vertical component of the weight of the rubber-coated solid mass 927 dropped out of the muzzle of the dispensing channel 907 into the pivoting elongated buckets 911 makes a rotation force rotating each pivoting elongated buckets 911 with respect to the rotation axis of the hollow or solid rotating shaft 908. Close to the 6 O'clock position of each pivoting elongated buckets 911, the rubber-coated solid masses 927 drops out of each pivoting elongated buckets 911 and falls into the mouth-elongated funnel 904 after creating the inertial twisting moments of the pivoting elongated buckets 911 with respect to the rotational axis of the cylindrically hollow or solid rotating shaft 908.

The mouth-elongated funnel 904 collects the rubber-coated solid mass 927 falling out of the pivoting elongated buckets 911. The horizontal channel 913 and the bottom end of a funnel pipe 905 of the mouth-elongated funnel 904 are connected by a connection tube 926 and fastening screws (not shown). The bottom end of the cylindrical channel 913 has an open pan 906 to receive and push the rubber-coated solid mass 927 into the cylindrical channel 913 preventing leakage of the buoyance liquid 901. The closed end of the open pan 906 is connected to a reciprocating rod 916 sliding inside a pair of sliding sleeves 927. The reciprocating rod 916 is connected and reciprocated by a crank arm 925 of a starter turbine 915 in FIG. 33 for rotating the GFAMIT without attaching the pre-decided number L of 3-φ electric power generators 8000 to the fixed number K driving wheels 7000 wherein the starter turbine 915 comprises a circular orbit-guide 374 in FIG. 23 having a circular orbit-groove 370 and a hollow or solid rotating shaft 360 wherein the rotational center C of the hollow or solid rotating shaft 360 is eccentrically located at, one quarter (¼) of the radius of the circular orbit-guide 8 from the center O of the circular orbit-guide 8 and the hollow or solid rotating shaft 360 has a limited number N (N=1, 2, 3, . . . , a limited number, eight cylindrically hollow arms 361, . . . , 368 as shown in FIG. 23) of fixed cylindrical arms 3600 in FIG. 23. Each of the limited number N of fixed cylindrical arms 3600 contains each of the limited number of inner telescoping cylinders 372 doing a linear telescoping motion inside each of the limited number N of fixed cylindrical arms 3600 resulting in variable twisting-moment-arms and variable rotational moment of inertia to rotate the hollow or solid rotating shaft 360. Each proximal end of the limited number of inner telescoping cylinders 372 has a stopper stud 385 keeping each proximal end of the limited number of inner telescoping cylinders 37 within the limited number N of fixed cylindrical arms 3600 in the case of full stretched states at the 3 O'clock position and the stopper stud 385 doing sliding motion inside the elongated slot 371 formed on the hollow twisting-moment-arms 3600.

Each distal end of the limited number of inner telescoping cylinders 372 has a rubber coated steel sphere among a limited number N of rubber coated steel spheres 373 (collectively nominal, in detail, 3731~3738 in FIG. 23).

Each arm length of the limited number N of fixed cylindrical arms 3600 is a design parameter, a fraction (one half) of the radius of the circular orbit-guide 374 so that the ratio of the twisting-moment-arm of the center of the steel sphere 3731 on the positive x-axis divided the twisting-moment-arm of the center of the steel sphere 3735 on the negative x-axis in FIG. 23, is (5/4)/(3/4)=5/3=(1+2/3), that is, the twist moment of the steel sphere 3731 on the positive x-axis is 1.667 times bigger than the twist moment of the steel sphere 3735 on the negative x-axis. Because the twist moment of the steel sphere 3731 on the positive x-axis is (1+2/3) times is bigger than the twist moment of the steel sphere 3735 on the negative x-axis, the total summation of the twist moments of the steel spheres 3731~3738 initiates the rotational motions of the steel spheres when the pre-selected number I pairs of braking shoes 41 and the pre-determined number j of anchor arms 57 are simultaneously released by the computer 1000.

The limited number N of cylindrically hollow arms 3600 are welded on the hollow or solid rotating shaft 360 and an elongated slot 371 or a plurality of elongated slots 371 is formed on each fixed cylindrical of the limited number N of cylindrically hollow arms 3600 for the stopper stud to be restricted within the elongated slot 371 and slide within the elongated slot 371 and simultaneously reduce the viscous resistance force of the telescoping motions of the inner telescoping cylinders 372 within the limited number N of cylindrically hollow arms 3600 and the end of each fixed cylindrical arm makes a circular trajectory 384, wherein the limited number N of cylindrically hollow arms 3600 are welded along a circular circumference on the hollow or solid rotating shaft 360 making the circular trajectory 384 or along a spiral circumference on the hollow or solid rotating shaft 360 and the limited number N of cylindrically hollow arms 3600 making the limited number N of circular trajectories 384.

Each fixed cylindrical of the limited number N of cylindrically hollow arms 3600 contains one of the limited number N of compression springs 1001. Each spring force of the limited number N of compression spring is 2~3 times bigger than the viscous resistance force between the outer surface of the telescoping arms 372 and the inner surface of the limited number N of cylindrically hollow arms 3600 and is a design parameter to be chosen. The length of the compression spring 1001 partially or fully fills the empty space of each cylindrically hollow arm of the limited number N of cylindrically hollow arms 3600 when each inner telescoping cylinder 372 of the Inner telescoping cylinders 372 is inserted into each cylindrically hollow arm of the limited number N of cylindrically hollow arms 3600 to help the inner telescoping cylinders 372 radially stretched within the end of each cylindrically hollow arm 3600 but limited inside the circular orbit-guide 8 by the spring force.

A 120° circular orbit-guide reinforcement 375 further supports the circular orbit-guide 374 against the summation of the centrifugal forces induced by the rubber coated steel spheres 373.

The centrifugal force is proportional to the arm length and the squared angular velocity ω and creates bending of the hollow cylindrical shaft 908 of the GBFAMIT system. The horizontal components of the centrifugal forces act toward the horizontal axis X of the X-Y plane. To limit the bending and tortional tearing of the hollow cylindrical shaft 908, a pair of strain gauge and piezoelectric sensor among a predefined number M of strain gauges and piezoelectric strain sensors are fixed along the same circumferential circle at the middle point of the rotational axis of the hollow cylindrical shaft 908 and outsides of the predefined number M of hollow frustoconical housings 8 sensing the time histories of the elongations of the hollow cylindrical shaft 908 by the centrifugal force creating the bending moments of the hollow cylindrical shaft 908 around the hollow housings 8 and sensing the twisting displacements of the hollow cylindrical shaft 908 by the torque applied to the hollow cylindrical shaft 908. Both centers of each strain gauge and each piezoelectric strain sensor are fixed along the circumferential circle at the middle length position of the hollow cylindrical shaft 908but the axial sensing direction of the strain gauge and circumferential sensing direction of the piezoelectric strain sensor are perpendicular. The strain gauge fixed along the circumferential circle on the outer surface of the hollow cylindrical shaft 908 measures the elongations of the hollow cylindrical shaft 908 by the centrifugal force and the piezoelectric strain sensor along the circumferential circle measures the twisting displacements of the hollow cylindrical shaft 908 at the middle length position of the hollow cylindrical shaft 908 by the twisting torque applied to the hollow cylindrical shaft 908. The locations of both strain gauge and piezoelectric strain sensor are at any location along the circumferential circle at the middle of the rotating shaft 1. Both the measured elongations values and twisting displacements fluctuate with respect to time due to the rotational motion of the hollow cylindrical shaft 908. The measured output signals from the strain gauges and piezoelectric strain sensors_are sampled and the sampled strain gauge and piezoelectric strain sensor output data fluctuates very much being contaminated by noises so that it requires a Chebyshev filter Type I or Type II having at least 8^{th} order, Butterworth filter, elliptic filter, or Savitzky-Golay filter to display and read a smoothed data by reducing or washing out the contaminating high frequency noises in the sampled data set and reading the smoothed and most probable data without the noises. A data logger stores the sampled data every time interval, the time interval equivalent to twice the rotational speed {1/(2w)}, to the SSD drive.

Taking the Fourier transform of the stored measurement signals from the SSD drive for each encoder and tachometer, rotary torque sensor, accelerometers, the strain gauges and piezoelectric strain sensors and after identifying the types of stochastic processes, a preferred control system (e.g., a Kalman filter with stochastic low frequency input noise and high frequency sensor noise, a linear quadratic Gaussian and linear quadratic optimal regulator (LQG/LQR) type closed-loop feedback servo-controller with Gaussian noises and output feedback or full state feedback, time-domain state-pace feedback control system without considering measurement noises, or a frequency-domain classical dual closed-loop tachometer-output-feedback servo-controller in FIG. 4 without considering measurement noises) controls the rotational speed of the hollow or solid rotating shaft 1 keeping the measured output signals from each encoder equal to the desired angular velocity, tachometer equal to the desired angular velocity, rotary torque sensor close to the desired torque, accelerometers less than the vibration limit, the strain gauges keeping the strain less than an allowable elongations threshold strain value and piezoelectric strain sensors keeping the twisting displacement less than the allowable twisting displacements threshold strain value. The theories for various control systems were mathematically well-proved and well-known (e.g., Katsuhiko Ogata, Bernard Friedland) and are not explained here, and the dynamic system of the GFAMIT system is different and unique from the others.

Unlike a conventional turbine having a zero-energy state initial position without any rotational energy, the initial position of the GFAMIT turbine system has a potential energy creating an initial twisting moment which rotates the hollow cylindrical shaft 908. Therefore, a stopper or braking system is needed to keep the GFAMIT turbine system on hold when not in use. The hollow cylindrical shaft 908 must be in a stopped position applying brake force on the hollow cylindrical shaft 908.

The starter turbine does not need a pair of steel plates 378, a circular and elliptical cam-follower groove 382 and a pair of horizontal supporting bars 376 and a pair of vertical supporting bars 377.

The reciprocating rod 916 reciprocates by a crank 925 driven by the starter turbine.

A flywheel disk and brake system 300 is connected to one end of the hollow or solid rotating shaft 908 to stop and hold the rotation of the hollow or solid rotating shaft 908.

The proximal end of each slant beam of the plurality of slant beams 20 having a foot 331 has a hinge to rotate and adapt and be fastened to a plurality of related body frames of an engine compartment of a vehicle and the foot 331 at the distal end of the slant beam has a plurality of slotted holes for fasteners to be inserted and fastened.

The horizontal frames 21, 22-28 and vertical frames 29 and 31 and each slant beam of the plurality of slant beams 20 having a foot 331 are fixed with the body frames of the engine compartment of a vehicle.

The resultant centrifugal force vector F induced by the variable or articulate twisting-moment-arms fixed or welded on the hollow or solid rotating shaft 1 is pointed toward the forward direction of the vehicle and the resultant centrifugal force vector F rotates the wheels of the vehicle and contributes to propel the vehicle forward.

The vehicle is an engine-equipped car, electric car, engine-equipped truck, electric truck, train, ship, submarine, aircraft, low orbit communications satellite, or winged spacecraft orbiting an Earth orbit below the geosynchronous orbit.

The 3-φ output power generated by the pre-decided number L of 3-φ electric power generators 8000 is directly supplied to the electric motor of the electric car or electric truck, or the 3-φ output power generated by the pre-decided number L of 3-φ electric power generators 8000 is supplied to the battery packs of the vehicle, wherein the vehicle is an engine-equipped car, electric car, engine-equipped truck, electric truck, train, ship, submarine, aircraft, low orbit communications satellite, or winged spacecraft orbiting an Earth orbit below the geosynchronous orbit. The supporting structures withstanding the total centrifugal forces are the same as the previous embodiments.

### First Method

A method of outputting electric power from a set of 3-φ electric power generators (SEPG) radially mounted inside a concentric generator-mounting-block simultaneously driven by a gravity-force applied and moment imbalanced turbine (GFAMIT) has the following steps.

Provide a rotating shaft comprising a plurality of variable or articulate twisting-moment-arms welded or fixed on the surface of the rotating shaft and a heavy mass is connected to each distal end of the plurality of variable or articulate twisting-moment-arms wherein the rotational radius of the heavy mass from the rotation axis of the rotating shaft to the radial end of the heavy mass connected to the variable or articulate twisting-moment-arm changes in the left and right half planes of rotation with respect to rotation-angle of the rotating shaft.

Insert a tubularly curved housing or orbit-guide along and around the rotating shaft wherein the rotating shaft is eccentrically centered at a rotation axis inside the tubularly curved housing or orbit-guide and the tubularly curved housing or orbit-guide urges the rotational radius of the heavy mass from the rotation axis of the rotating shaft to the radial end of the heavy mass connected to the variable or articulate twisting-moment-arm.

Provide an external supporting structure on the outer surface of the tubularly curved housing or orbit-guide along the direction of a resultant centrifugal force induced by rotating the plurality of variable or articulate twisting-moment-arms wherein the external supporting structure creates the reaction force against the resultant centrifugal force to withstand and cancel the resultant centrifugal force.

Direct the resultant centrifugal force vector F induced by the variable or articulate twisting-moment-arms fixed or welded on the hollow or solid rotating shaft 1 to be pointed toward the forward direction of the vehicle and the resultant centrifugal force vector F contributes to rotate the wheels of the vehicle and contributes to propel the vehicle toward the forward direction.

Provide a hinge to the proximal end of each slant beam of the plurality of slant beams 20 having a foot 331 to be rotated, adapted and fastened to a vertical wall of a building structure or a plurality of body frames of an engine compartment of a vehicle and the foot 331 at the distal end of the slant beam having a plurality of slotted holes for fasteners to be inserted and fastened.

### Second Method

A method of generating electric power from a set of 3-φ electric power generators (SEPG) radially mounted inside a concentric generator-mounting-block simultaneously driven by a gravity-force applied and moment imbalanced turbine (GFAMIT) has the following steps.

Provide a rotating shaft comprising a plurality of variable or articulate twisting-moment-arms welded or fixed on the surface of the rotating shaft and a heavy mass is connected to each distal end of the plurality of variable or articulate twisting-moment-arms wherein the rotational radius of the heavy mass from the rotation axis of the rotating shaft to the radial end of the heavy mass connected to the variable or articulate twisting-moment-arm changes in the left and right half planes of rotation with respect to rotation-angle of the rotating shaft.

Insert a tubularly curved housing or orbit-guide along and around the rotating shaft wherein the rotating shaft is eccentrically centered at a rotation axis inside the tubularly curved housing or orbit-guide, and the tubularly curved housing or orbit-guide prohibits the rotational radius of the heavy mass from the rotation axis of the rotating shaft to the radial end of the heavy mass connected to the variable or articulate twisting-moment-arm from being fully stretched in the left half plane of rotation and the plurality of variable or articulate twisting-moment-arms are fully stretched in the right half plane of rotation.

Provide an external supporting structure on the outer surface of the tubularly curved housing or orbit-guide along the direction of a resultant centrifugal force induced by rotating the plurality of variable or articulate twisting-moment-arms wherein the external supporting structure creates the reaction force against the resultant centrifugal force to withstand and cancel the resultant centrifugal force.

Create a closed flow path of solid masses having an upward flow path against the gravity force and a downward flow path along the gravity force without applying any external power or action energy to the solid masses.

Numerous modifications may be made to the present disclosures within the concepts and scopes of the gravity-force applied and moment imbalanced turbine (GFAMIT) and the gravity and buoyance-force applied and moment imbalanced turbine (GBFAMIT) driving the pre-decided number L of 3-φ electric power generators disclosed in the prior paragraphs and disclosed drawings. The expected numerous changes, modifications and alternatives in dimension, strength of materials, shapes, availability and longevity of parts are apparent to those who are skilled in the disclosed art. The disclosed invention is intended to embrace all such changes, modifications and alternatives that fall within the concepts and spirits and broad scopes of the appended claims.

1. A distributed network of a generator-turbine apparatus having a set of 3-φ electric power generators (SEPG) radially mounted inside an electric generator mounting block and simultaneously driven by a gravity-force applied and moment imbalanced turbine (GFAMIT), comprising:
a plurality of electric generator mounting block 9210 having a concentrical inner-cylindrical-support 8100 having a pre-decided number L of pivoting electric generator holder 8585 holding and supporting a pre-decided number L of 3-φ electric power generators 8000, a concentrical middle-cylindrical-support 8200 having a pre-fixed number i of command following motors driving a cross-sectionally-circular shaft 8570 creating axially telescoping motion of a telescoping square-structural tubing 8580 linearly sliding within a cross-sectionally square-tubular-pipe 8510 and moving the pre-decided number L of pivoting electric generator holder 8585, a concentrical outer-cylindrical-support 8300 for the pre-fixed number i of command following motors to be fixed inside the concentrical outer-cylindrical-support 8300;
a photovoltaic (PV) panel 88091 or a capacitor bank 88092 providing a DC reactive excitation current to the stator excitation windings of each 3-φ electric power generator 8000 for inducing a current in the rotor electromagnet windings;
a fixed number K (K=1, 2, . . . , a fixed number) of the driving wheels 7000 rotating each pulley 8040 of the pre-decided number L of 3-φ electric power generators 8000;
a gearbox device 600 having a gearbox driving shaft 501 and the fixed number K of driving wheel driven-shafts 7001;
a torque measurement and transmission device 500 having a rotary torque sensor 505 measuring the torque of the torque coupling device shaft 401;
a torque coupling device 400 connecting a pair of mating mechanical shafts having a pair of mating male and female coupling ends 4001;
a flywheel and brake block 300 doing the braking action much faster than the frequency of manual braking actions, controlled by a computer 1000 having multicores;
a predefined number M of hollow housings 8 containing a hollow or solid rotating shaft 1 wherein the hollow or solid rotating shaft 1 comprises a limited number N of variable or articulate or elastic twisting-moment-arms and a rubber coated spherical steel sphere connected to the distal ends of each variable or articulate or elastic twisting-moment-arm, and the hollow or solid rotating shaft 1 is eccentrically located within each hollow housing 8;
a centrifugal force supporting structure 200 for withstanding the induced resultant centrifugal force F;
a starter turbine 36000 for rotating the GFAMIT without attaching the pre-decided number L of 3-φ electric power generators 8000 to the fixed number K of driving wheels 7000, and the hollow or solid rotating shaft 360 of the starter turbine 36000 is coaxially connected to the hollow or solid rotating shaft 1;
a 120° circular orbit-guide reinforcement 375 further supports a circular orbit-guide 374 against the summation of the centrifugal forces induced by the rubber coated steel spheres 373 and the limited number N of variable or articulate or elastic twisting-moment-arms;
the computer 1000 controlled by a server of a LAN or WAN computer network with an Internet connection, and the computer 1000 executing the general purpose computer operating system (OS) programs and hardware specific FPGA, VHDL, or Verilog program controlling the C3I (command control communications and information) functions of the pre-decided number L of 3-φ electric power generators (SEPG) 8000 radially mounted inside each electric generator mounting block 9210 and having multi-level artificial intelligence (AI) and controlling the optimal rotational speed of the turbine; and
wherein all zero-degree single-phase stator output terminals, all 120-degree single-phase stator output terminals and all 240-degree single-phase stator output terminals of the pre-decided number L of 3-φ electric power generators 8000 are respectively summed to a first common joint bus of a first electric power interconnection and summing bus 8805 (1), a second electric power interconnection and summing bus 8805 (2) and a third electric power interconnection and summing bus 8805 (3) respectively for summing all electric current having same degree phase angle and a first single-phase (1-φ)-to-single-phase (1-φ) cycloconverter bank and phase-locked loop 8806 (1), a second single-phase (1-φ)-to-single-phase (1-φ) cycloconverter bank and phase-locked loop 8806 (2) and a third single-phase (1-φ)-to-single-phase (1-φ) cycloconverter bank and phase-locked loop 8806 (3) are respectively connected to each output bus terminal of the first electric power interconnection and summing bus 8805 (1), the second electric power interconnection and summing bus 8805 (2) and the third electric power interconnection and summing bus 8805 (3) for converting the high order frequencies created by mixing all electric currents from the pre-decided number L of 3-φ electric power generators 8000 to the 50 or 60 Hz electric current within an allowable convergence frequency error and tuning all initial phase angles within an allowable phase angle error and a 3-φ step-up transformer 880700 converting the voltage from 12 Vac to a desired high AC voltage;
the initial position of the variable or articulate or elastic twisting-moment-arms of the GFAMIT turbine system has a potential energy creating an initial twisting moment rotating both the hollow or solid rotating shaft 360 of the starter turbine 36000 and the hollow or solid rotating shaft 1, and wherein the flywheel and brake block 300 keeps the GFAMIT turbine system on hold when not in use.

2. The distributed network of a generator-turbine apparatus having a set of 3-φ electric power generators (SEPG) radially mounted inside an electric generator mounting block and simultaneously driven by a gravity-force applied and moment imbalanced turbine (GFAMIT) of claim 1, further comprising:
wherein each of the pre-decided number L of pivoting electric generator holder 8585 has first generator mounting hole 85890, second generator mounting hole 85900, and third generator mounting hole 85910 to hold and support the pre-decided number L of 3-φ electric power generators 8000,
the concentrical middle-cylindrical-support 8200 has a pre-decided number L of cross-sectionally square-tubular-pipes 8510 and a pre-fixed number i (i=1, 2, 3, . . . , a pre-fixed number) of square holes 8530 wherein each square hole 8530 contains each cross-sectionally square-tubular-pipe 8510 to support the pre-decided number L of pivoting electric generator holder 8585 and the computer 1000 controlls the pre-fixed number i of command following motors driving the cross-sectionally-circular shaft 8570 creating axially telescoping motion of the telescoping square-structural tubing 8580 linearly sliding within each cross-sectionally square-tubular-pipe 8510;
the extra-DC current from the PV panel is supplied to the output terminal of the electric power interconnection and summing bus 8805 (4), or is supplied to charge a battery bank 8809;
wherein each driving wheel has a metal wheel body 702 covered with a rubber rim 701 for having friction between the outer surface of the rubber rim 701 and the outer surface of each pulley 8040 of the pre-decided number L of 3-φ (phase) electric power generators;
wherein the driving shaft 501 of the gearbox device 600 simultaneously rotates the fixed number K of driving wheel driven-shafts 7001 which in turn rotating each of the fixed number K of driving wheel 7000;
the flywheel and brake block 300 comprising a flywheel and brake shaft 301, the hollow or solid rotating shaft 1, and a toothed flywheel 40, a pre-selected number I pairs of braking shoes 41 and a pre-determined number j of anchor arms 57 and further comprising the pre-selected number I pairs of levers 43 pivoting-ly braking and releasing the pre-selected number I pairs of braking shoes 41 by a pre-selected number I of LVDT (Linear Variable Displacement Transducer) 44 mounted on a pre-selected number I pairs of steel arms 45 connected between the ends of the pre-selected number I pairs of levers 43 to do the braking action much faster than the frequency of manual braking actions, wherein the simultaneous scissors motions of the pre-selected number I pairs of braking shoes 41 and the pre-determined number j of anchor arms 57 are controlled by the computer 1000 having multicores;
wherein a pair of inner layer bearings 18 and 19 and a pair of outer layer bearings 16 and 17 are installed at both ends of the hollow or solid rotating shaft 1, and wherein the pair of inner layer bearings 18 and 19 on both journals of the hollow or solid rotating shaft 1 are a pair of sliding ring-bearings 18 and 19,
wherein the direct radial length of each limited number N of variable or articulate or elastic twisting-moment-arm from the origin of the rotation axis of the hollow or solid rotating shaft to the distal end of the limited number N of variable or articulate or elastic twisting-moment-arms is variable with respect to rotation angle;
wherein the starter turbine 36000 comprises an integrated semi-circular and elliptical hollow-orbit-guide 890 or a circular orbit-guide 374,
wherein the integrated semi-circular and elliptical hollow-orbit-guide 890 consists of a semi-circular hollow-orbit-guide 840 and a semi-elliptical hollow-orbit-guide 880 and welded together wherein the rotational center of a hollow cylindrical shaft 800 is located at the middle point between the two focal points C and D of the semi-elliptical hollow-orbit-guide 880 simultaneously coinciding with the middle of the vertical diameter of the semi-circular hollow-orbit-guide 840 wherein a circular orbit-groove 370 is also formed on the inner surface of the semi-circular hollow-orbit-guide 840 helping orbital motions of the rubber coated steel sphere 373 and a semi-elliptical orbit-groove 380 is formed on the inner surface of the semi-elliptical hollow-orbit-guide 880 and the rotation arm of the rubber coated steel sphere 373 is longer than the rotation arm of the driving wheels 7000,
wherein the hollow cylindrical shaft 800 has a limited number N (N=1, 2, 3, . . . , a limited number) of fixed cylindrical arms 3600, and each fixed cylindrical arm contains each of the limited number N of inner telescoping cylinders 372 doing a linear telescoping motion inside each of the limited number N of fixed cylindrical arms 3600 resulting in variable twisting-moment-arms,
wherein a circular and elliptical cam-follower groove 382 is formed inside the pair of steel plates 378, wherein the circular and elliptical cam-follower groove 382 consists of a circular cam-follower groove 384 in the right half plane and an elliptical cam-follower groove 383 in the left half plane, and the total summation of the twist moments of the steel spheres 3731~3738 initiates the rotational motions of the steel spheres when the pre-selected number I pairs of braking shoes 41 and the pre-determined number j of anchor arms 57 are simultaneously released by the computer 1000; and
wherein the multi-level artificial intelligence (AI) has both a local level artificial intelligence (AI) and a local level database on the computer 1000 wherein the local level AI makes periodic query to the local level database to get the system parametric values and generated electric output power as an input value set to input nodes of a local level backpropagation model having a plurality of layers of nodes to compute the optimal rotational speed of the hollow or solid rotating shaft 1 and the optimal number of three-phase electric generators to be driven by the driving wheel 7000 and the driving wheel 7000 is rotated by the hollow or solid rotating shaft 1 and then the local level AI trains the local level backpropagation model to minimize the mechanical vibrations and noises and the local level AI collects and stores the owner information of the generator-turbine apparatus and electric power consumption for each hour by the owner's home to the local level database, wherein the dynamic motion and sensor measurement data in the local database is also used by a computer-level AI having a computer level backpropagation model, the computer-level AI is supervised by a distributed electric generator network (DEGN)-level AI controlling a limited number of computer level Als and has a DEGN-level backpropagation model and a DEGN database, and the DEGN-level AI is supervised by a public power utility (PPU)-level AI and has a PPU-level backpropagation model; and
wherein the optimal rotational speed of the turbine is used as a reference input command for a closed-loop feedback servo-controller of the hollow or solid rotating shaft 1.

3. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 2, further comprising:
wherein the concentrical inner-cylindrical-support 8100 further comprises that the circular female threads 8582 is mated with male threads 8571 partially formed on cross-sectionally-circular shaft 8570 directly connected with the mechanical output shaft of the pre-fixed number i of command following motors selected from the group consisting of DC-servo motors 8590 and stepper motors 8591 and each command following motor of the pre-fixed number i of command following motors receives a command following signal from a vector output of the computer 1000, and rotates the cross-sectionally-circular shaft 8570 wherein the pair of accepting channel flanges 85820 accept the pivoting electric generator holder 8585 having pivot arms 8586, and the distal end of the pivoting electric generator holder 8585 has generator mounting holes;
wherein the concentrical middle-cylindrical-support 8200 has the pre-fixed number i of square holes 8540 and each square hole 8540 containing the distal end of the cross-sectionally square-tubular-pipe 8510 and the cross-sectionally square-tubular-pipe 8510 fixedly supports the command following motor;
wherein the concentrical outer-cylindrical-support 8300 has the same pre-fixed number i of steel fastener brackets to fixedly mount the pre-fixed number i of command following motors;
wherein both ends of the hollow or solid rotating shaft 1 are closed, one end has a tachometer measuring the rotational speed of the hollow or solid rotating shaft 1, and each hollow or solid rotating shaft 1 has the limited number N of welded arms for connecting and supporting the limited number N of variable or articulate or elastic twisting-moment-arms and the limited number N of welded arms radially extend from the hollow or solid rotating shaft 1 and the hollow or solid rotating shaft has totally (M×N) number of the welded arms installed on the hollow rotating arm 1 and makes clockwise rotation vector along the negative axis Z holding the hollow rotating arm 1 with the right hand and aligning the thumb along the rotational axis of the hollow or solid rotating shaft 1;
a plurality of ball bearings 1188 each assembled into both end holes of each sidewall of the predefined number M of hollow housings 8 for the predefined number M of hollow housings 8 to be stationary without any rotational motion when the hollow or solid rotating shaft 1 rotates inside each hollow housing 8; and
the computer 1000 controls the pre-selected number I of LVDTs of the flywheel and brake block 300 to brake, stop and hold or release the hollow or solid rotating shaft 1.

4. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising:
wherein each hollow housing of the predefined number M of hollow housings is a hollow frustoconical housing 8 and the limited number N of variable or articulate or elastic twisting-moment-arms are the limited number N of articulate twisting-moment-arms having a limited number N of rotating links 2, wherein each hollow frustoconical housing 8 contains the hollow or solid rotating shaft 1 and a limited number N of the welded arms 13,
wherein each welded arm 13 has a welded arm bearing 30 at the distal end of each welded arm 13 for reducing the friction, each rotating link 2 rotates with respect to the rotation vector along the negative Y-axis perpendicular to the welded arm 13 and direction of the resultant centrifugal force F, and the direct radial distance to the distal end of each rotating link 2 is variable with respect to the rotation angle of the hollow or solid rotating shaft 1.

5. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising
wherein each hollow housing of the predefined number M of hollow housings is
a composite hollow housing 80000 composed of a semi-circular cylindrical housing 80001 and a semi-elliptical housing 80002 and the limited number N of variable or articulate or elastic twisting-moment-arms are the limited number N of articulate twisting-moment-arms having a limited number N of rotating links 2 and the hollow or solid rotating shaft 1 is at the center of the diameter of the semi-circular cylindrical housing 80001 and the limited number N of the welded arms 13 are welded on the hollow or solid rotating shaft 1 and both left and right ends of each composite hollow housing 80000 have ball bearings 1188 to be stationary without any rotational motion when the hollow or solid rotating shaft 1 rotates inside each of the composite hollow housing 80000;
wherein each welded arm 13 of the limited number N of welded arms 13 has a welded arm bearing 30 at the distal end of each welded arm 13,
wherein the rotating link 2 begins to be folded entering the semi-elliptical housing 80002 after 180° rotation within the semi-circular cylindrical housing 80001.

6. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising:
wherein each hollow housing of the predefined number M of hollow housings is an elliptical orbit-guide 100 containing a hollow cylindrical shaft 611 and the limited number N of variable or articulate or elastic twisting-moment-arms are the limited number N of articulate twisting-moment-arms having the limited number N of fixed cylindrical arms 63 containing inner telescoping cylinders 67;
a rectangular steel plate 31 having a shaft hole 59 for the hollow cylindrical shaft 611 to rotate with an angular velocity ω inside the shaft hole 59;
an outer elliptic orbit-guide 33 and an inner elliptic orbit-guide 35 are made of a vertically z-cross-sectional angle beam;
an elliptical cam-groove 34 having a gap d and an inner groove width D is formed between the outer elliptic orbit-guide 33 and the inner elliptic orbit-guide 35;
wherein the center of rotation of the hollow cylindrical shaft 611 is to be located between the focal point (−f) of the elliptical cam-groove 34 and the focal point (−F) of the elliptical orbit-guide 100.

7. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising:
wherein each hollow housing of the predefined number M of hollow housings is an elliptical orbit-guide 100 containing a hollow cylindrical shaft 611 placed at the left focal point of the elliptical orbit-guide 100 and the limited number N of variable or articulate or elastic twisting-moment-arms are the limited number N (N=1, 2, 3, . . . , a limited number) of articulate twisting-moment-arms having the limited number N of fixed cylindrical arms 63 containing the limited number N of inner telescoping cylinders 67,
wherein the elliptical orbit-guide 100 is made of a pair of elliptical hollow rings 100 and the pair of elliptical hollow rings 100 have a clearance g between each of the pair of elliptical hollow rings 100;
a rectangular steel plate 31 has a shaft hole 59 for a hollow cylindrical shaft 611 to rotate with an angular velocity ω inside the shaft hole 59;
wherein the center of rotation of the hollow cylindrical shaft 611 is to be located between the focal point (−f) of the elliptical cam-groove 34 and the focal point (−F) of the elliptical orbit-guide 100.

8. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising:
wherein each hollow housing of the predefined number M of hollow housings is a circular orbit-guide 374 having a circular orbit-groove 370, and the limited number N of variable or articulate or elastic twisting-moment-arms are the limited number N of articulate twisting-moment-arms rotating a hollow or solid rotating shaft 360 having a limited number N (N=1, 2, 3, . . . , a limited number) of fixed cylindrical arms 3600 containing the limited number N of inner telescoping cylinders 372,
wherein the hollow or solid rotating shaft 360 passes through a through hole 369 formed on a pair of steel plates 378 and the limited number N of cylindrically hollow arms 3600 are welded on the hollow or solid rotating shaft 360 and an elongated slot 371 is formed on each fixed cylindrical of the limited number N of cylindrically hollow arms 3600 and the end of each fixed cylindrical arm makes a circular trajectory 384, wherein the limited number N of cylindrically hollow arms 3600 are welded along a circular circumference on the hollow or solid rotating shaft 360 or along a spiral circumference on the hollow or solid rotating shaft 360
a circular and elliptical cam-follower groove 382 is formed inside the pair of steel plates 378 and wherein the circular and elliptical cam-follower groove 370 consists of a circular cam-follower groove 384 in the right half plane and an elliptical cam-follower groove 383 in the left half plane and contains a cam follower 37; and
wherein each rubber coated steel sphere 373 is connected to the inner telescoping cylinder 372 with the channel cage 74.

9. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising:
wherein each hollow housing of the predefined number M of hollow housings is an elliptical housing 97 and the limited number N of variable or articulate or elastic twisting-moment-arms are the limited number N of articulate twisting-moment-arms having the limited number N of fixed connecting rods 720 and a limited number N (N=1, 2, . . . , a limited number) of rhombus linkage arm units 60 wherein the elliptical housing 97 contains the limited number N of rhombus linkage arm units 60 around a hollow or solid rotating shaft 70 wherein the hollow or solid rotating shaft 70 is positioned on the left focal point of the elliptical housing 97,
a steel roller 96 connected to the distal end of the limited number N of rhombus linkage arm units 60 and having rubber coating 95 on the steel roller 96 and orbiting the inner surface of the elliptical housing 97;
wherein the limited number of the rhombus linkage arms 60 is determined by the required total external torque to rotate the pre-decided number L of 3-φ electric power generators 8000.

10. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising:
wherein each hollow housing of the predefined number M of hollow housings is a circular orbit-guide 197 and the limited number N of variable or articulate or elastic twisting-moment-arms are the limited number N of articulate twisting-moment-arms having the limited number N of connecting rods 1720 and a limited number N (N=1, 2, . . . , a limited number) of rhombus linkage arms assembly 160 wherein the circular orbit-guide 197 is one of the predefined number M of circular orbit guides 197;
the limited number N of rhombus linkage arms assembly 160 is connected to and around a hollow or solid rotating shaft 170 wherein the longitudinal axis 1700 of rotation of the hollow or solid rotating shaft 170 is positioned on an eccentric rotation point of the circular orbit-guide 197 on the left x-axis from the origin of the x-y Cartesian coordinates and R is the radius of the circular orbit-guide 197.

11. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising:
wherein each hollow housing of the predefined number M of hollow housings is a circular orbit-guide 197 and the limited number N of variable or articulate or elastic twisting-moment-arms are the limited number N of articulate twisting-moment-arms having the limited number N of connecting rods 1720 and a limited number N (N=1, 2, . . . , a limited number) of rhombus linkage arms assembly 160;
a limited number N of rhombus linkage arms assembly 160 around a hollow or solid rotating shaft 170 wherein the longitudinal axis 1700 of rotation of the hollow or solid rotating shaft 170 is positioned on an eccentric rotation point of the circular orbit-guide 197 on the left x-axis from the origin of the x-y Cartesian coordinates and R is the radius of the circular orbit-guide 197;
each fixed connecting rod 720 has a partial rhombus linkage arm support 72101 and a pair of rhombus linkage arm sliding rings 72102.

12. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising:
wherein each hollow housing of the predefined number M of hollow housings is selected from the group consisting of an elliptical housing 97, a circular housing 197 having an eccentric rotation center of the hollow or solid rotating shaft 70, a composite hollow-orbit-guide 820 consisting of a semi-circular hollow-orbit-guide 840 and a quasi-semi-circular hollow-orbit-guide 850, and an integrated semi-circular and elliptical hollow-orbit-guide 890 consisting of a semi-circular hollow-orbit-guide 840 and a semi-elliptical hollow-orbit-guide 880, and the limited number N of variable or articulate or elastic twisting-moment-arms are the limited number N of articulate twisting-moment-arms having the limited number N of connecting rods 1720 and a limited number N of elastic or flexible arm assemblies 704;
wherein each elastic or flexible arm assembly 704 comprises a number k of tension springs 707 partially contained inside the number k of spring support cylinders 706, the proximal ends of the number k of parallel tension springs 707 are fixed or welded on the left steel plates first and then the number k of spring support cylinders 706 are inserted around the number k of tension springs 707, and are pushed to the surface of the left steel plate 705, and then the bottom of the spring support cylinders 706 and the left steel plate 705 are welded together.

13. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising:
wherein each hollow housing of the predefined number M of hollow housings is a circular orbit guide 801 and the limited number N of variable or articulate or elastic twisting-moment-arms are the limited number N of articulate twisting-moment-arms having a limited number N of articulate arms 810 wherein the limited number N of articulate arms 810 further comprise the limited number N of fixed arms 81110, the limited number N of first connecting rods 81120 and the limited number N of second connecting rods 81130, wherein the rotation center O₈₀₃ of a hollow cylindrical shaft 800 is eccentrically located from the geometric center O₈₀₁ of the circular orbit guide 801 toward the rotation center O₈₀₃ within the circular orbit guide 801,
wherein the distal end of each first connecting rod 8112 prohibits each second connecting rod 8113 from rotating more than 180° from the horizontal axis passing through the rotational axis of the hollow cylindrical shaft 800 after passing the 3 O'clock direction and the gravity acting on the centers of the steel spheres 8114, the second connecting rod 8113 and the first connecting rod 8112 creates maximal inertial twisting moment acting with respect to the center of the hollow cylindrical shaft 800;
wherein the fixed arm 81110 is a channel shape having two sidewalls 811101 and 811102 and a bottom 811103 and the bottom of the fixed arm 81110 supports the weights of the first link 81120, the second link 81130 and the steel sphere 8114;
wherein the two sidewalls 811101 and 811102 have pivot holes 811104 and a fixed arm pivot shaft 811105 passes through the two pivot holes 811104 for allowing angular rotation of the first link 81120;
wherein the second link 81130 has two sidewalls 811201 and 811202, and the two sidewalls 811201 and 811202 have pivot holes 811204.

14. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising:
wherein each hollow housing of the predefined number M of hollow housings is a circular orbit guide 803 and the limited number N of variable or articulate or elastic twisting-moment-arms are the limited number N of articulate twisting-moment-arms having a limited number N of articulate arms 8811 wherein the limited number N of articulate arms 8811 further comprise the limited number N of fixed arms 81110, the limited number N of first connecting rods 81120 and the limited number N of second connecting rods 81130, wherein the rotation center A of a hollow cylindrical shaft 800 is located at the geometric center O₈₀₃ of the circular orbit guide 803,
wherein each steel sphere 81140 is fixed to each distal end of each second connecting rod 81130,
wherein the distal end of each first connecting rod 8112 prohibits each second connecting rod 8113 from rotating more than 180° from the horizontal axis passing through the rotational axis of the hollow cylindrical shaft 800 after passing the 3 O'clock direction and the gravity acting on the centers of the steel spheres 8114, the second connecting rod 8113 and the first connecting rod 8112 create maximal inertial twisting moment acting with respect to the center of the hollow cylindrical shaft 800;
wherein the fixed arm 81110 is a channel shape having two sidewalls 811101 and 811102 and a bottom 811103 and the bottom of the fixed arm 81110 supports the weights of the first link 81120, the second link 81130 and the steel sphere 81140;
wherein the two sidewalls 811101 and 811102 have pivot holes 811104 and a fixed arm pivot shaft 811105 passes through the two pivot holes 811104 for allowing angular rotation of the first link 81120;
wherein the second link 81130 has two sidewalls 811201 and 811202, and the two sidewalls 811201 and 811202 have pivot holes 811204;
wherein a second link pivot shaft 811205 passes through the two pivot holes 811204 for allowing angular rotation of the second link 81130.

15. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising:
wherein each hollow housing of the predefined number M of hollow housings is an elliptical hollow-orbit-guide 860 containing a rotation center of a hollow cylindrical shaft 800 eccentrically located at a left focal point A and the limited number N of variable or articulate or elastic twisting-moment-arms are the limited number N of articulate twisting-moment-arms having a limited number N of articulate arms 8811 wherein each articulate arm of the limited number N of articulate arms 8811 has the limited number N of fixed arms 88111 on the outer surface of the hollow cylindrical shaft 800, and the limited number N of first connecting rods 88112 and second connecting rods 88113 and the limited number N of the steel spheres 88116, wherein the hollow cylindrical shaft 800 has the limited number N of articulate arms 8811 within each of a number M of circular orbit guides 860,
wherein each steel sphere 88116 is fixed to each distal end of each second connecting rod 88113,
wherein the distal end of each first connecting rod 88112 prohibits each second connecting rod 88113 from rotating more than 180° from the horizontal axis passing through the rotational axis of the hollow cylindrical shaft 800 after passing the 3 O'clock direction and creates maximal inertial twisting moment acting on the center of the steel spheres 88116 and the gravity force acting on the second connecting rod 88113 and the first connecting rod 88112;
wherein each rotating plane of the limited N/2 rotating planes having a pair of articulate arms 8811 and 8812, the steel spheres 88116 fixed to the distal ends of each second connecting rods 88113 and 88123 drop along the gravitational force of the Earth without any overlapping or entangling over the previously lower articulate arm 8811 in the left half plane of the rotational plane;
wherein the fixed arm 88111 is a channel shape having two sidewalls and a bottom and the bottom of the fixed arm 88111 supports the weights of the first link 88112, the second link 88113 and the steel sphere 88116;
wherein the two sidewalls 881111 and 881112 have pivot holes 88116 and 88117 and a fixed arm pivot shaft 88114 passes through the two pivot holes 88116 and 88117 for allowing angular rotation of the first link 88111.

16. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising:
wherein each hollow housing of the predefined number M of hollow housings is an integrated semi-circular and quasi-semi-circular hollow-orbit-guide 820 consisting of a semi-circular hollow-orbit-guide 840 and a quasi-semi-circular hollow-orbit-guide 850 and the limited number N of variable or articulate or elastic twisting-moment-arms are the limited number N of articulate twisting-moment-arms having a limited number N of articulate arms 8811 within each of a number M of integrated semi-circular and quasi-semi-circular hollow orbit-guides 820 having a rotation axis of the hollow cylindrical shaft 800 at the middle of the diameter of the semi-circular hollow-orbit-guide 840 co-locating the origin of the X-Y Cartesian coordinate system;
wherein the geometric center of the quasi-semi-circular hollow-orbit-guide 820 is centered at the end B of the fixed arm 88111, and the hollow cylindrical shaft 800 has a limited number N of articulate arms 8811 within each of a number M of integrated semi-circular and quasi-semi-circular hollow-orbit-guide 820;
wherein the semi-circular orbit-guide 840 has a radius R_{R} and the quasi-semi-circular hollow-orbit-guide 850 has a radius R_{L} and the rotation center of the hollow cylindrical shaft 800 is placed at the middle of the diameter of the semi-circular orbit-guide 840 and the center of the quasi-semi-circular hollow-orbit-guide 850 is located at the distal end B of the first connecting rod 88111, and the radius R_{L} is larger than the radius R_{R}, and the ends of the semi-circular hollow-orbit-guide 840 are welded together with the ends of the quasi-semi-circular hollow-orbit-guide 850 forming an integrated semi-circular and quasi-semi-circular hollow-orbit-guide 820;
wherein each articulate arm of the limited number N of articulate arms 8811 has the limited number N of fixed arms 88111 on the outer surface of the hollow cylindrical shaft 800, and the limited number N of first connecting rods 88112 and second connecting rods 88113 and the limited number N of the steel spheres 88116;
wherein the fixed arm 88111 is a channel shape having two sidewalls 881111 and 881112 and a bottom and the bottom of the fixed arm 88111 supports the weights of the first link 88112, the second link 88113 and the steel sphere 88116;
wherein the two sidewalls 881111 and 881112 have pivot holes 88116 and 88117 and a fixed arm pivot shaft 88114 passes through the two pivot holes 88116 and 88117 for allowing angular rotation of the first link 88111, wherein the second link 88112 has two sidewalls 88120 and 88121, and the two sidewalls 88120 and 88121 have pivot holes 88118 and 88119.

17. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising:
wherein each hollow housing of the predefined number M of hollow housings is an integrated semi-circular and semi-elliptical hollow-orbit-guide 890 consisting of a semi-circular hollow-orbit-guide 840 and a semi-elliptical hollow-orbit-guide 880 and the limited number N of variable or articulate or elastic twisting-moment-arms are the limited number N of articulate twisting-moment-arms having a limited number N of articulate arms 8811 within each of a number M of integrated semi-circular and semi-elliptical hollow-orbit-guide 890 having a rotation axis of the hollow cylindrical shaft 800 at the middle of the diameter of the semi-circular hollow-orbit-guide 840 co-locating the origin of the X-Y Cartesian coordinate system;
wherein the elliptical hollow-orbit-guide 880 has upper focal point C and lower focal point D and the geometric center A of the semi-elliptical hollow-orbit-guide 880 is centered at the middle of the major axis of the semi-elliptical hollow-orbit-guide 880 same as the middle of the diameter of the semi-circular hollow-orbit-guide 840, and the hollow cylindrical shaft 800 has a limited number N of articulate arms 8811 within each of a number M of integrated semi-circular and semi-elliptical hollow-orbit-guide 890;
wherein the semi-circular orbit-guide 840 has a radius R_{R} and the semi-elliptical hollow-orbit-guide 880 has a minor axis length R_{L} and the rotation center of the hollow cylindrical shaft 800 is placed at the middle of the diameter of the semi-circular orbit-guide 840 and the middle of the major axis of the semi-elliptical hollow-orbit-guide 880, and the minor axis length R_{L} is shorter than the radius R_{R}, and the ends of the semi-circular orbit-guide 840 are welded together with the ends of the semi-elliptical hollow-orbit-guide 880 forming an integrated semi-circular and the semi-elliptical hollow-orbit-guide 890;
wherein each articulate arm of the limited number N of articulate arms 810 has the limited number N of fixed arms 88111 on the outer surface of the hollow cylindrical shaft 800, and the limited number N of first connecting rods 88112 and second connecting rods 88113, and the limited number N of the steel spheres 88116;
wherein the fixed arm 88111 is a channel shape having two sidewalls 881111 and 881112 and a bottom and the bottom of the fixed arm 88111 supports the weights of the first link 88112, the second link 88113 and the steel sphere 88116;
wherein the two sidewalls 881111 and 881112 have pivot holes 88116 and 88117 and a fixed arm pivot shaft 88114 passes through the two pivot holes 88116 and 88117 for allowing angular rotation of the first link 88111, wherein the second link 88112 has two sidewalls 88120 and 88121, and the two sidewalls 88120 and 88121 have pivot holes 88118 and 88119.

18. The distributed network of the generator-turbine apparatus having a set of 3-φ electric power generators (SEPG) radially mounted inside an electric generator mounting block and simultaneously driven by a gravity-force applied and moment imbalanced turbine (GFAMIT) of claim 3, further comprising:
a columnar liquid container 900 made of stainless-steel sheet material and the columnar liquid container 900 is stood by and close to and outside of the trajectory of the distal ends of a limited number N of pivoting elongated buckets 911, and the columnar liquid container 900 is fixed with integrated support frames 912 of a hollow or solid rotating shaft 908;
wherein each pivoting elongated bucket of the limited number N of pivoting elongated buckets 911 receives a flow of rubber-coated solid masses 927 consisting of an inner core mass 903, a Styrofoam surrounding mass 902, an empty space, and a coated rubber layer;
wherein the body of the Styrofoam surrounding mass 902 contains the inner core mass 903 and the body of the Styrofoam surrounding mass 902 has an empty space filled with ambient air or hydrogen or a vacuum space, and the outside of the Styrofoam surrounding mass 902 is coated with the coated rubber layer made of a rubber material;
a flow path of the rubber-coated solid masses 927 wherein the flow path has a closed loop flow comprising an upward flow and a downward flow, wherein the upward flow of the rubber-coated solid masses 927 is opposite to the gravitational force acting on each rubber coated solid mass 927 inside the columnar liquid container 900 and the downward flow of the rubber-coated solid masses 927 is along the gravitational force inside the limited number N of pivoting elongated buckets 911;
a buoyance liquid 901 filling the columnar liquid container 900, wherein the larger the density of the buoyance liquid 901 is, the larger the buoyance force is, wherein the buoyance liquid 901 is a salt water of maximal concentration (26.3% salt concentration) of salt in the fresh water;
wherein the cross-sectional shape of a horizontal channel 913 matches with the cross-sectional outer contour of the rubber-coated solid mass 927 and makes a tight seal preventing the leakage of the buoyance liquid 901 from the columnar liquid container 900;
a cylindrically hollow or solid rotating shaft 908 wherein the cylindrically hollow or solid rotating shaft 908 has the limited number N of fixed arms 909 and each fixed arm of the limited number N of fixed arms 909 has a channel shaped cross-sectional surface having two vertical walls between a bottom wall and is welded on and along a circular circumference on the surface of the cylindrically hollow shaft 908 and the two vertical walls of each fixed arm of the limited number N of fixed arms 909 have a pair of pivot shaft holes 9101;
wherein the bottom wall of each fixed arm of the limited number N of fixed arms 909 prevents each pivoting arm 910 from rotating more than 180° from the axis passing through the rotational center of the cylindrically hollow or solid rotating shaft 908 and supports each pivoting arm 910 horizontally stretched and increases the rotational arm of each pivoting elongated buckets 911.

19. A method of generating electric power from a set of 3-φ electric power generators (SEPG) radially mounted inside a concentric generator-mounting-block simultaneously driven by a gravity-force applied and moment imbalanced turbine (GFAMIT), comprising:
providing a rotating shaft comprising a plurality of variable or articulate or elastic twisting-moment-arms welded or fixed on the surface of the rotating shaft and a heavy mass is connected to each distal end of the plurality of variable or articulate or elastic twisting-moment-arms wherein the rotational radius of the heavy mass from the rotation axis of the rotating shaft to the radial end of the heavy mass connected to the variable or articulate or elastic twisting-moment-arm changes in the left and right half planes of rotation with respect to rotation-angle of the rotating shaft;
inserting a tubularly curved housing or orbit-guide along and around the rotating shaft wherein the rotating shaft is eccentrically centered at a rotation axis inside the tubularly curved housing or orbit-guide and the tubularly curved housing or orbit-guide urges the rotational radius of the heavy mass from the rotation axis of the rotating shaft to the radial end of the heavy mass connected to the variable or articulate or elastic twisting-moment-arm; and
providing an external supporting structure on the outer surface of the tubularly curved housing or orbit-guide along the direction of a resultant centrifugal force induced by rotating the plurality of variable or articulate or elastic twisting-moment-arms wherein the external supporting structure creates the reaction force against the resultant centrifugal force to withstand and cancel the resultant centrifugal force;
directing the resultant centrifugal force vector F induced by the variable or articulate or elastic twisting-moment-arms fixed or welded on the hollow or solid rotating shaft 1 to be pointed toward the forward direction of the vehicle and the resultant centrifugal force vector F contributes to rotate the wheels of the vehicle and contributes to propel the vehicle toward the forward direction; and
providing a hinge to the proximal end of each slant beam of the plurality of slant beams 20 having a foot 331 to be rotated, adapted and fastened to a vertical wall of a building structure or a plurality of body frames of an engine compartment of a vehicle and the foot 331 at the distal end of the slant beam having a plurality of slotted holes for fasteners to be inserted and fastened.

20. A method of generating electric power from a set of 3-φ electric power generators (SEPG) radially mounted inside a concentric generator-mounting-block simultaneously driven by a gravity-force applied and moment imbalanced turbine (GFAMIT), comprising:
providing a rotating shaft comprising a plurality of variable or articulate or elastic twisting-moment-arms welded or fixed on the surface of the rotating shaft and a heavy mass being connected to each distal end of the plurality of variable or articulate or elastic twisting-moment-arms wherein the rotational radius of the heavy mass from the rotation axis of the rotating shaft to the radial end of the heavy mass connected to the variable or articulate or elastic twisting-moment-arm changes in the left and right half planes of rotation with respect to rotation-angle of the rotating shaft;
inserting a tubularly curved housing or orbit-guide along and around the rotating shaft wherein the rotating shaft is eccentrically centered at a rotation axis inside the tubularly curved housing or orbit-guide, and the tubularly curved housing or orbit-guide prohibits the rotational radius of the heavy mass from the rotation axis of the rotating shaft to the radial end of the heavy mass connected to the variable or articulate or elastic twisting-moment-arm from being fully stretched in the left half plane of rotation and the plurality of variable or articulate or elastic twisting-moment-arms are fully stretched in the right half plane of rotation;
providing an external supporting structure on the outer surface of the tubularly curved housing or orbit-guide along the direction of a resultant centrifugal force induced by rotating the plurality of variable or articulate or elastic twisting-moment-arms wherein the external supporting structure creates the reaction force against the resultant centrifugal force to withstand and cancel the resultant centrifugal force; and
creating a closed flow path of solid masses having an upward flow path against the gravity force and a downward flow path along the gravity force without applying any external power or action energy to the solid masses.
